(19) United States
(12) Patent Application Publication
(10) Pub. No.: US 2025/0230274 A1
(43) Pub. Date: Jul. 17, 2025

(54) POLYCAPROLACTONE POLYOLS, POLYURETHANE DISPERSIONS, AND METHODS OF MAKING AND USING THE SAME

(71) Applicant: INGEVITY UK LTD, Cheshire (GB)

(72) Inventors: Anthony Maher, Cheshire (GB); Amanda Tosh, Cheshire (GB); Charles Elwood Jones, JR., Cheshire (GB)

(21) Appl. No.: 19/013,274

(22) Filed: Jan. 8, 2025

Related U.S. Application Data
(60) Provisional application No. 63/619,888, filed on Jan. 11, 2024.

(51) Int. Cl. C08G 63/08; C08G 18/08; C08G 18/12; C08G 18/30; C08G 63/78; C08J 5/18; C08K 5/00; C08K 5/17; C09D 5/02; C09D 7/63; C09D 175/12

(52) U.S. Cl. CPC C08G 63/08; C08G 18/0866; C08G 18/12; C08G 18/30; C08G 63/78; C08J 5/18; C09D 5/022; C09D 7/63; C09D 175/12; C08J 2375/12; C08K 5/005; C08K 5/17

(57) ABSTRACT

Caprolactone polyols and prepolymer compositions, polyurethane dispersions, or waterborne polyurethanes including the same are described herein. The caprolactone polyol is made by a process including admixing caprolactone monomers and pentaspiroglycol (PSG) to form an initiator-caprolactone mixture or reaction mixture, adding one or more catalyst to the initiator-caprolactone mixture to form a reaction mixture, and polymerizing, such as ring opening polymerization, the caprolactone monomers in the reaction mixture, thereby forming the caprolactone polyol. The films or coatings comprising or produced from the prepolymer compositions, polyurethane dispersions, or waterborne polyurethanes described herein have improved mechanical properties and chemical resistance, as compared to standard, commercially available polyols. Methods of making and using the caprolactone polyol and the prepolymer compositions, polyurethane dispersions, or waterborne polyurethanes, as well as films or coating comprising or prepared from the same, are also described herein.

### CROSS-REFERENCE TO RELATED APPLICATIONS

The present application claims priority to, and the benefit of, U.S. Provisional Application No. 63/619,888, filed 11 Jan. 2024 and titled POLYCAPROLACTONE POLYOLS, POLYURETHANE DISPERSIONS, AND METHODS OF MAKING AND USING THE SAME, which is incorporated by reference herein in its entirety for all purposes.

### BACKGROUND OF THE INVENTION

### Field of the Discovery

The present disclosure relates to caprolactone polyols, compositions including caprolactone polyols of the present disclosure, such as prepolymer compositions, polyurethane dispersions, or waterborne polyurethanes, and methods for preparing and using the caprolactone polyols and compositions comprising the same.

### Background Information

A polyurethane material is formed by reacting a hydroxyl containing moiety (polyol) and an isocyanate functional material. The structure of the polyurethane is segmented and can be described in terms of a hard domain/segment that contains the isocyanate molecule and optionally a low molecular weight chain extender (e.g., a diol, diamine, or a combination thereof), and a soft domain/segment that contains the polyol-often a polyether, polyester, or a caprolactone-based polyol. Polyurethane water-based dispersion have gained relevance as a versatile and environmentally friendly alternative to the solvent-borne systems historically used in polyurethane production in order to reduce volatile organic compounds emissions.

The water compatibility of waterborne polyurethane (WBPU) and waterborne polyurethane-urea (WBPUU) systems can be achieved through the addition of an internal emulsifier. Waterborne polyurethane (WBPU) and waterborne polyurethane-urea (WBPUU) systems can produce films with properties similar to conventional polyurethanes (e.g., chemical resistance, high flexibility, adhesion to many polymers and surfaces, etc. However, waterborne polyurethane (WBPU) and waterborne polyurethane-urea (WBPUU) systems are known to have poor mechanical properties, chemical resistance (e.g., water, solvent, etc.), and poor heating resistance, relative to conventional polyurethane systems.

Thus, there remains a need in the art for alternatives to polyester polyols and current caprolactone polyols that provide water compatibility of waterborne polyurethane (WBPU) systems with enhanced mechanical properties, while providing acceptable chemical resistance. The present disclose describes novel caprolactone polyols that surprisingly and unexpectedly provides polyurethane dispersions or waterborne polyurethanes that form films or coatings with improved mechanical properties and chemical resistance, as compared to comparative commercial polyols. The present disclosure further provides prepolymer compositions, polyurethane dispersions, or waterborne polyurethanes comprising the caprolactone polyols of the present disclosure, as well as methods of making the caprolactone polyols of the present disclosure and the polyurethane compositions or adhesives of the present disclosure.

### SUMMARY

Presently described are pentaspiroglycol (PSG) initiated polyols, curable compositions including pentaspiroglycol (PSG) initiated polyols, compositions comprising the same (e.g., prepolymer compositions, polyurethane dispersions, or waterborne polyurethanes), and methods of their preparation and uses thereof.

Thus, in an aspect, the present disclosure relates to a caprolactone polyol made by a process comprising: admixing caprolactone monomers and pentaspiroglycol (PSG) to form an initiator-caprolactone mixture or reaction mixture; adding one or more (e.g., 1, 2, 3, 4, 5, or more) catalyst (e.g., a tin-based catalyst (e.g., at least one of a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

Another aspect of the present disclosure relates to a method of making the caprolactone polyol of the present disclosure. The method comprises admixing caprolactone monomers and pentaspiroglycol (PSG) to form an initiator-caprolactone mixture or reaction mixture; adding one or more (e.g., 1, 2, 3, 4, 5, or more) catalyst (e.g., at least one of a tin-based catalyst (e.g., a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

In any aspect or embodiment described herein, the process further comprises at least one of (i) sparing the initiator-caprolactone mixture prior to adding the one or more catalyst (e.g., sparging the initiator-caprolactone mixture with nitrogen); (ii) incubating the initiator-caprolactone mixture prior to adding the one or more catalyst (e.g., incubating for about 0.5 hours to about 1.5 hours, about 0.75 hours to about 1.25 hours, or about 1 hour, such as while sparking the initiator-caprolactone mixture), (iii) heating the initiator-caprolactone mixture to about 70° C. to about 100° C. (e.g., about 75° C. to about 95° C.), (iv) removing excess water from the initiator-caprolactone mixture, or (v) a combination thereof.

In any aspect or embodiment described herein, polymerizing comprises at least one of (i) performing with refluxing, (ii) performing at about 150° C. to about 190° C. (e.g., about 150° C. to about 180° C.), (iii) performing until the caprolactone monomer concentration is below 0.5%; (iv) performing for about 4 to about 6 hours, or (v) a combination thereof.

In any aspect or embodiment described herein, the process further comprises at least one of (i) adding one or more (e.g., 1, 2, 3, 4, 5, or more) acid scavengers (e.g., adding one or more acid scavenger after polymerizing, adding a sufficient amount of one or more acid scavenger to result in the caprolactone polyol having an acid number of <0.10 or <0.05 mgKOH/g, and/or the one or more acid scavenger includes or is at least one of monomeric carbodiimide, polymeric carbodiimide, or a combination thereof); (ii) adding additional catalyst (e.g., at least one of a tin-based catalyst (e.g., a stannous octoate catalyst, such as DABCO® T-9), a zinc-based catalyst, a zirconium-based catalyst, a titanium-based catalyst, or a combination thereof) to the reaction mixture (e.g., adding additional catalyst while heating the reaction mixture, such as to about 150° C. to about 190° C., such as about 150° C. to about 160° C.), thereby forming the caprolactone polyol; or (iii) a combination thereof.

In any aspect or embodiment described herein, the initiator-caprolactone mixture further comprises one or more (e.g., 1, 2, 3, 4, 5, or more) antioxidant and/or one or more (e.g., 1, 2, 3, 4, 5, or more) stabilizer (e.g., at least one of a phenolic antioxidant and/or stabilizer, a sterically hindered phenolic antioxidant and/or stabilizer, pentaerythritol tetrakis(3-(3,5-di-tert-butyl-4-hydroxyphenyl)propionate) (IRGANOX® 1010), a phosphite antioxidant and/or stabilizer, bis(2,4-di-tert-butylphenol)pentaerythritol diphosphate (e.g., IRGAFOS® 126), an antihydrolysis agent (STABAXOL® I), carbodiimide (e.g., monomeric carbodiimide), or a combination thereof).

In any aspect or embodiment described herein, at least one of: (i) the caprolactone monomers is present in an amount of about 65 wt % to about 95 wt % (e.g., about 65 wt % to about 90 wt %, or about 65 wt % to about 85 wt %) of the initiator-caprolactone mixture; (ii) the pentaspiroglycol (PSG) is present in an amount of about 5 wt % to about 35 wt % (e.g., about 10 wt % to about 35 wt %, or about 15 wt % to about 35 wt %) of the initiator-caprolactone mixture; (iii) the caprolactone monomers is present in an amount of about 65 wt % to about 95 wt % (e.g., about 65 wt % to about 90 wt %, or about 65 wt % to about 85 wt %) of the reaction mixture; (iv) the pentaspiroglycol (PSG) is present in an amount of about 5 wt % to about 35 wt % (e.g., about 10 wt % to about 35 wt %, or about 15 wt % to about 35 wt %) of the reaction mixture; (v) the one or more catalyst is present in an amount of about 0.001 wt % to about 5 wt % (e.g., about 0.001 wt % to about 5 wt %, about 0.001 wt % to about 4 wt %, about 0.001 wt % to about 3 wt %, about 0.001 wt % to about 2 wt %, about 0.001 wt % to about 1 wt %, about 0.001 wt % to about 0.5 wt %, about 0.001 wt % to about 0.25 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.1 wt % to about 0.25 wt %, about 0.2 wt % to about 5 wt %, about 0.2 wt % to about 4 wt %, about 0.2 wt % to about 3 wt %, about 0.2 wt % to about 2 wt %, about 0.2 wt % to about 1 wt %, about 0.2 wt % to about 0.5 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 0.75 wt % to about 5 wt %, about 0.75 wt % to about 4 wt %, about 0.75 wt % to about 3 wt %, about 0.75 wt % to about 2 wt %, about 0.75 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 2 wt % to about 5 wt %, about 2 wt % to about 4 wt %, about 2 wt % to about 3 wt %, about 3 wt % to about 5 wt %, about 3 wt % to about 4 wt %, or about 4 wt % to about 5 wt %,) of the reaction mixture; (vi) the one or more antioxidants or stabilizer is present in an amount of up to about 2 wt % (e.g., up to about 1.5 wt %, up to about 1 wt %, up to about 0.5 wt %, up to about 0.25 wt %, about 0.1 wt % to about 2 wt %, about 0.1 wt % to about 1.5 wt %, about 0.1 wt % to about 1 wt %, about 0.1 wt % to about 0.75 wt %, about 0.1 wt % to about 0.5 wt %, or about 0.1 wt % to about 0.25 wt %) of the reaction mixture; or (vii) a combination thereof.

In any aspect or embodiment described herein, at least one of: (i) the molecular weight of the caprolactone polyol is about 1,000 g/mol (MW) to about 4500 MW (e.g., about 1,000 MW to about 4,000 MW, about 1,000 MW to about 3,000 MW, about 1,000 MW to about 2,100 MW, or about 1,000 MW to about 2,000 MW); (ii) the caprolactone polyol comprises less than about 5% (e.g., less than about 4%, less than about 3%, less than about 2%, less than about 1%, less than about 0.5%, less than about 0.5%, less than about 0.25%, less than about 0.1%) caprolactone monomer; (iii) the caprolactone polyol has an acid number of <0.4 KOH/g, (e.g., <0.3 KOH/g, <0.3 mgKOH/g, <0.2 KOH/g, <0.1 KOH/g, <0.75 KOH/g, <0.05 mgKOH/g); (iv) the one or more catalysts is one or more catalyst for ring-opening polymerization (e.g., at least one of zinc lactate, zinc oxide, zinc powder, diethyl zinc, tin lactate, tin oxide, tin dioxide, stannous oxide, stannous lactate, stannous octoate, stannous chloride, tin powder, propanoic acid or tetrabutyl titanate, or a combination thereof); or (v) a combination thereof.

A further aspect of the present disclosure relates to a prepolymer composition, polyurethane dispersion, or waterborne polyurethane, comprising one or more (e.g., 1, 2, 3, 4, 5, or more) caprolactone polyol of the present disclosure.

Another aspect of the present disclosure relates to a prepolymer composition, polyurethane dispersion, or waterborne polyurethane, made by a process comprising reacting (i) the one or more caprolactone polyol of the present disclosure, (ii) optionally one or more (e.g., 1, 2, 3, 4, 5, or more) additional polyol (e.g. trimethylolpropane (TMP)), (iii) one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), and (iv) one or more (e.g., 1, 2, 3, 4, 5, or more) catalyst (e.g., at least one of a bismuth catalyst (e.g., organobismuth in a carboxylic acid), dibutyltin dilaurate, dibutyltin dioctanoate, or a combination thereof), thereby forming a polyurethane material (e.g., a prepolymer composition).

An additional aspect of the present disclosure relates to a method of making the prepolymer composition, polyurethane dispersion, or waterborne polyurethane, of any one of claims 8-22, the method comprising reacting one or more (e.g., 1, 2, 3, 4, 5, or more) caprolactone polyol, optionally one or more (e.g., 1, 2, 3, 4, 5, or more) additional polyol (e.g. trimethylolpropane (TMP)), one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), and one or more (e.g., 1, 2, 3, 4, 5, or more) catalyst (e.g., at least one of a bismuth catalyst (e.g., organobismuth in a carboxylic acid), dibutyltin dilaurate, dibutyltin dioctanoate, or a combination thereof), thereby forming a polyurethane material (e.g., a prepolymer composition).

In any aspect or embodiment described herein, at least one of: (i) the process further comprises heating the one or more caprolactone polyol, optionally the one or more additional polyol, and the one or more isocyanate prior to reacting (e.g., prior to adding the one or more catalyst and/or heating to a temperature of about 65° C. to about 100° C., about 70° C. to about 90° C., about 70° C. to about 80° C., or about 75° C.); (ii) reacting is performed for about 1.0 hour to about 2.0 hours (e.g., about 1.0 hour to about 1.75 hours, about 1.0 hour to about 1.5 hours, about 1 hour to about 1.25 hours, about 1.25 s hour to about 1.75 hours, about 1.25 hours to about 1.5 hours, about 1.5 hours to about 1.75 hours, or about 1.5 hours); (iii) the process further comprises sparging the caprolactone polyol prior to reacting (e.g., sparging with nitrogen and/or sparging for about 0.5 hours to about 1.5 hours, about 0.75 hours to about 1.25 hours, or about 1 hour); or (iv) a combination thereof.

In any aspect or embodiment described herein, the process further comprises adding to, and/or mixing with, the polyurethane material: (i) optionally, one or more (e.g., 1, 2, 3, 4, 5, or more) cosolvent (e.g., an aprotic solvent, such as at least one of a dipolar aprotic solvent (e.g., 1-butylpyrrolidine-2-one), aprotic propylene oxide solvent (e.g., dipropylene glycol dimethyl ether), or a combination thereof); and (ii) one or more (e.g., 1, 2, 3, 4, 5, or more) internal emulsifier (e.g., at least one of dimethylol propionic acid (DMPA), dimethylethanolamine (DMEA), or a combination thereof), thereby forming a polyurethane material (e.g., a prepolymer composition).

In any aspect or embodiment described herein, the process further comprises at least one of: (i) adding the one or more internal emulsifier after the cosolvent; (ii) adjusting the temperature of (a) the polyurethane material, or (b) the polyurethane material and the cosolvent mixture, (e.g., prior to adding the one or more internal emulsifier) to about 85° C. to about 105° C. (e.g., about 90° C. to about 100° C.); (iii) incubating or mixing the one or more internal emulsifier with (a) the polyurethane material, or (b) the polyurethane material and the cosolvent mixture, for about 45 minutes to about 180 minutes (e.g., about 60 minutes to about 120 minutes); (iv) incubating or mixing the one or more internal emulsifier with (a) the polyurethane material, or (b) the polyurethane material and the cosolvent mixture, at a temperature of about 85° C. to about 105° C. (e.g., about 90° C. to about 100° C.); or (v) a combination thereof.

In any aspect or embodiment described herein, the process further comprises: (i) adding, combining and/or mixing one or more (e.g., 1, 2, 3, 4, 5, or more) counterion or neutralizer (e.g., an amine, such as at least one of triethylamine (TEA), dimethylethanolamine (DMEA), or a combination thereof) with the polyurethane material (e.g., prepolymer composition) to produce a counterion-polyurethane materials mixture; and (ii) adding, combining, and/or mixing water (e.g., water sufficient for the mixture to have a total solids content of about 30% to about 50% or about 45%), and optionally one or more (e.g., 1, 2, 3, 4, 5, or more) defoamer (e.g., at least one of 2-methyl-3-isothiazolone, decamethylcyclopentasiloxane, octamethylcyclotetrasiloxane, or a combination thereof), optionally one or more (e.g., 1, 2, 3, 4, 5, or more) chain extender (e.g., at least one of water, hydrazine, hydrazine hydrate, adipic dihydrazide, aminoethyl ethanolamine (AEEA), ethylene diamine (EDA), or a combination thereof), or optionally a combination thereof (e.g., one or more (e.g., 1, 2, 3, 4, 5, or more) defoamer and one or more (e.g., 1, 2, 3, 4, 5, or more) chain extender), with the counterion-polyurethane materials mixture to produce a dispersion (e.g., a polyurethane dispersion or waterborne polyurethane).

In any aspect or embodiment described herein, at least one of: (i) adding, combining, and/or mixing the one or more counterion or neutralizer with the polyurethane material (e.g., prepolymer composition) is at a temperature of about 75° C. to about 95° C. (e.g., about 75° C. to about 90° C. or about 80° C. to about 85° C.); (ii) adding, combining, and/or mixing the water, and optionally the one or more defoamer, optionally the one or more chain extender, or a combination thereof (e.g., the one or more defoamer and the one or more chain extender), with the counterion-polyurethane materials mixture is at a temperature of about 20° C. to about 35° C. (e.g., about 23° C. to about 30° C. or about 25° C. to about 28° C.); or (iii) a combination thereof.

In any aspect or embodiment described herein, the process further comprises reacting the dispersion with one or more (e.g., 1, 2, 3, 4, 5, or more) chain extender (e.g., at least one of water, inorganic or organic polyamine having an average of about 2 or more primary and/or secondary amine groups, or a combination thereof).

In any aspect or embodiment described herein, at least one of: (i) reacting the dispersion with the one or more chain extender includes slowly adding the one or more chain extender to the dispersion; (ii) the one or more chain extender is a composition comprising formalin and one or more (e.g., 1, 2, 3, 4, 5, or more) chain extender (e.g., at least one of water, hydrazine, hydrazine hydrate, adipic dihydrazide, aminoethyl ethanolamine (AEEA), ethylene diamine (EDA), or a combination thereof); or (iii) a combination thereof.

In any aspect or embodiment described herein, at least one of: (i) the one or more additional polyol includes or is a low-molecular-weight polyol having a number average molecular weight of 400 or less; (ii) the one or more additional polyol has three or more hydroxyl groups; (iii) the one or more internal emulsifier includes or is at least one of one or more (e.g., 1, 2, 3, 4, 5, or more) nonionic emulsifier, one or more (e.g., 1, 2, 3, 4, 5, or more) cationic emulsifier (e.g., a tertiary amine, such as dimethylethanolamine (DMEA)), one or more (e.g., 1, 2, 3, 4, 5, or more) anionic emulsifier (e.g., at least one of carboxylic acid, sulfonated acid, or a combination thereof, such as dimethylol propionic acid (DMPA)), or a combination thereof; (iv) the one or more isocyanate includes or is at least one of monomeric, oligomeric, polymeric, or a mixture thereof; (v) the one or more isocyanate includes or is at least one of an aliphatic polyisocyanate, mono-cyclic polyisocyanate, aromatic polyisocyanates, aromatic/aliphatic polyisocyanate (e.g., tetramethylxylylene diisocyanate (TMXDI)), or a combination thereof; (vi) the one or more catalyst includes or is at least one of one or more (e.g., 1, 2, 3, 4, 5, or more) urethane catalyst (e.g., one or more (e.g., 1, 2, 3, 4, 5, or more) tertiary amine compound, one or more (e.g., 1, 2, 3, 4, 5, or more) amine with isocyanate reactive group(s), one or more (e.g., 1, 2, 3, 4, 5, or more) organometallic compound, or a combination thereof); (vii) the one or more cosolvent includes or is one or more (e.g., 1, 2, 3, 4, 5, or more) aprotic solvent; (viii) the one or more counterion or neutralizer includes or is one or more (e.g., 1, 2, 3, 4, 5, or more) amine; (ix) the one or more defoamer includes or is water-based defoamer (e.g., at least one of 2-methyl-3-isothiazolone, decamethylcyclopentasiloxane, octamethylcyclotetrasiloxane, or a combination thereof); (x) the one or more chain extender has a molecular weight from about 60 to about 600; (xi) the one or more chain extender includes or is at least one of one or more (e.g., 1, 2, 3, 4, 5, or more) diol chain extender, one or more (e.g., 1, 2, 3, 4, 5, or more) diamine chain extender, or a combination thereof; or (xii) a combination thereof.

In any aspect or embodiment described herein, at least one of: (i) the one or more additional polyol includes or is at least one of: one or more (e.g., 1, 2, 3, 4, 5, or more) trihydric alcohol (e.g., low-molecular-weight triol); one or more (e.g., 1, 2, 3, 4, 5, or more) tetrahydric alcohol (e.g., low-molecular-weight tetrol); one or more (e.g., 1, 2, 3, 4, 5, or more) pentahydric alcohol (e.g., low-molecular-weight pentol); one or more (e.g., 1, 2, 3, 4, 5, or more) hexahydric alcohol (e.g., a low-molecular-weight hexol); one or more (e.g., 1, 2, 3, 4, 5, or more) heptahydric alcohol (e.g., low-molecular-weight heptol); one or more (e.g., 1, 2, 3, 4, 5, or more) octahydric alcohol (e.g., low-molecular-weight octahydric alcohol); one or more (e.g., 1, 2, 3, 4, 5, or more) polyalkylene oxide having three or more hydroxyl groups (e.g., low-molecular weight polyalkylene oxide having three or more hydroxyl groups); or a combination thereof; (ii) the one or more internal emulsifier includes or is carboxylated diol (e.g., dimethylolpropionic acid (DMPA)); (iii) the one or more isocyanate includes or is at least one of diphenylmethane diisocyanate, isophorone diisocyanate, bimethylene diisocyanate, trimethylene diisocyanate, tetramethylene diisocyanate, pentamethylene diisocyanate, hexamethylene diisocyanate, heptamethylene diisocyanate, toluene diisocyanate, naphthylene diisocyanate, cyclohexylmethane diisocyanate, dicyclohexylmethane diisocyanate, or a mixture thereof; (iv) the one or more catalyst includes or is at least one of an organometallic compound, a organobismuth catalyst, or a combination thereof; (v) the one or more cosolvent includes or is at least one of a dipolar aprotic solvent, an aprotic propylene oxide solvent, or a combination thereof; (vi) the one or more counterion or neutralizer includes or is triethylamine (TEA); (vii) the one or more defoamer includes or is water-based defoamer (e.g., at least one of 2-methyl-3-isothiazolone, decamethylcyclopentasiloxane, octamethylcyclotetrasiloxane, or a combination thereof); (viii) the one or more chain extender includes or is a diol chain extender that includes or is an aliphatic diol or an aromatic diol; (ix) the one or more diol chain extender includes or is at least one of an alkylene oxide or glycol, ethylene glycol, propanediol, butanediol, pentadiol, hexanediol, heptadiol, dihydroxybenzene, di(hydroxyethyl)-hydroxyquinone, di(hydroxymethyl)-hydroxyquinone, di-(hydroxyethyl)-bisphenol A, or a mixture thereof; (x) the one or more diamine chain extender includes or is diaminodiphenylmethane, dichloro-diaminodiphenylmethane, diaminobenzene, dimethoxy-diamino biphenyl, dimethyl-diamino biphenyl, diamino biphenyl, dichloro-diamino biphenyl, or a mixture thereof; or (xi) a combination thereof.

In any aspect or embodiment described herein, at least one of: (i) the one or more additional polyol includes or is at least one of glycerin; 2-methyl-2-hydroxymethyl-1,3-propanediol; 2,4-dihydroxy-3-hydroxymethylpentane; 1,2,6-hexanetriol; trimethylolpropane; 2,2-bis(hydroxymethyl)-3-butanol; tetramethylolmethane (pentaerythritol); diglycerol; xylitol; sorbitol; mannitol; iditol; dulcitol; altritol; inositol; dipentaerythritol; perseitol; sucrose; polyethylenepolyol, polypropylenepolyol, polyethylenepolypropylenepolyol (such as a random copolymer or a block copolymer); or a combination thereof; (ii) the one or more isocyanate includes or is at least one of 1,3-trimethylene diisocyanate; 2,3-trimethylene diisocyanate; 1,2-trimethylene diisocyanate; 2,2-trimethylene diisocyanate; 1,4-tetramethylene diisocyanate; 1,3-tetramethylene diisocyanate; 1,2-tetramethylene diisocyanate; 2,3-tetramethylene diisocyanate; 1,1-tetramethylene diisocyanate; 2,2-tetramethylene diisocyanate; 1,5-pentamethylene diisocyanate; 1,4-pentamethylene diisocyanate; 1,3-pentamethylene diisocyanate; 1,2-pentamethylene diisocyanate; 2,3-pentamethylene diisocyanate; 2,4-pentamethylene diisocyanate; 3,4-pentamethylene diisocyanate; 3,5-pentamethylene diisocyanate; 1,1-pentamethylene diisocyanate; 2,2-pentamethylene diisocyanate; 3,3-pentamethylene diisocyanate; 1,6-hexamethylene diisocyanate; 1,5-hexamethylene diisocyanate; 1,4-hexamethylene diisocyanate; 1,3-hexamethylene diisocyanate; 1,2-hexamethylene diisocyanate; 2,3-hexamethylene diisocyanate; 2,4-hexamethylene diisocyanate; 2,5-hexamethylene diisocyanate; 3,4-hexamethylene diisocyanate; 3,5-hexamethylene diisocyanate; 4,5-hexamethylene diisocyanate; 1,1-hexamethylene diisocyanate; 2,2-hexamethylene diisocyanate; 3,3-hexamethylene diisocyanate; 1,7-heptamethylene diisocyanate; 1,6-heptamethylene diisocyanate; 1,5-heptamethylene diisocyanate; 1,4-heptamethylene diisocyanate; 1,3-heptamethylene diisocyanate; 1,2-heptamethylene diisocyanate; 2,3-heptamethylene diisocyanate; 2,4-heptamethylene diisocyanate; 2,5-heptamethylene diisocyanate; 2,6-heptamethylene diisocyanate; 3,3-heptamethylene diisocyanate; 3,4-heptamethylene diisocyanate; 1,1-heptamethylene diisocyanate; 2,2-heptamethylene diisocyanate; 3,3-heptamethylene diisocyanate; 4,4-heptamethylene diisocyanate; toluene-2,4-diisocyanate; toluene-2,6-diisocyanate; 1,2-naphthylene diisocyanate; 1,3-naphthylene diisocyanate; 1,4-naphthylene diisocyanate; 1,5-naphthylene diisocyanate; 1,6-naphthylene diisocyanate; 1,7-naphthylene diisocyanate; 1,8-naphthylene diisocyanate; 1,4-cyclohexylmethane diisocyanate; 2,4-cyclohexylmethane diisocyanate; 3,4-cyclohexylmethane diisocyanate; 4,4-cyclohexylmethane diisocyanate; 4,4′-dicyclohexylmethane diisocyanate; 1,4-dicyclohexylmethane diisocyanate; or a mixture thereof; (iii) the one or more isocyanate includes or is at least one of 2,2′-diphenylmethane diisocyanate; 2,4′-diphenylmethane diisocyanate; 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“H12 MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; cyclobutane-1,3-diisocyanate; 1,2-cyclohexane diisocyanate; 1,3-cyclohexane diisocyanate; 1,4-cyclohexane diisocyanate; 2,4-methylcyclohexane diisocyanate; 2,6-methylcyclohexane diisocyanate; 4,4′-dicyclohexyldiisocyanate; 2,4′-dicyclohexyldiisocyanate; 1,3,5-cyclohexane triisocyanate; a isocyanate-methylcyclohexane isocyanate; a isocyanatoethylcyclohexane isocyanate; a bis(isocyanatomethyl)-cyclohexane diisocyanate; 4,4′-bis(isocyanatomethyl) dicyclohexane; 2,4′-bis(isocyanatomethyl) dicyclohexane; 2,4-hexahydrotoluenediisocyanate; 2,6-hexahydrotoluenediisocyanate; 1,2-phenylene diisocyanate; 1,3-phenylene diisocyanate; 1,4-phenylene diisocyanate; triphenyl methane-4,4′,4″-triisocyanate; naphthylene-1,5-diisocyanate; 2,4′-biphenyl diisocyanate; 4,4′-biphenyl diisocyanate; 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof; (iv) the one or more catalyst includes or is at least one of: (a) one or more (e.g., 1, 2, 3, 4, 5, or more) tertiary amine catalyst (e.g., a tertiary amine catalyst that is present in an amount of about 0.02 wt % to about 5 wt % of the reaction mixture) comprising at least one of triethylenediamine, N-methylmorpholine, N, N-dimethylcyclohexylamine, pentamethyldiethylenetriamine, tetramethylethylenediamine, bis (dimethylaminoethyl) ether, 1-methyl-4-dimethylaminoethyl-piperazine, 3-methoxy-N-dimethylpropylamine, N-ethylmorpholine; dimethylethanolamine, N-cocomorpholine, N, N-dimethyl-N′, N′-dimethyl isopropylpropylenediamine, N, N-diethyl-3-diethyl amino-propylamine, dimethylbenzylamine, or a mixture thereof; (b) one or more (e.g., 1, 2, 3, 4, 5, or more) organometallic catalyst (e.g., a organometallic catalyst that is present in an amount of about 0.001 to 1 wt % of the reaction mixture) comprising at least one of organobismuth, organo mercury, organolead, organoferric, organotin catalysts, or a combination thereof (preferably organotin catalysts); (c) one or more (e.g., 1, 2, 3, 4, 5, or more) tin catalysts comprising at least one of stannous chloride, tin salts of carboxylic acids (e.g., dibutyltin dilaurate), stannous octoate, or a combination thereof; (d) one or more (e.g., 1, 2, 3, 4, 5, or more) catalyst for the trimerization of polyisocyanates comprising an alkali metal alkoxide; or (e) a combination thereof; (v) the one or more cosolvent includes or is dipropylene glycol diether; (vi) the one or more counterion or neutralizer includes or is triethyl amine (TEA); (vii) the one or more chain extender includes or is one or more (e.g., 1, 2, 3, 4, 5, or more) diol chain extender that includes or is at least one of 1,3-propanediol; 1,2-propanediol; 1,1-propanediol; 2,2-propanediol; 1,4-butanediol; 1,3-butanediol; 1,2-butanediol; 2,3-butanediol; 1,1-butanediol; 2,2-butanediol; 1,5-pentadiol; 1,4-pentadiol; 1,3-pentadiol; 1,2-pentadiol; 2,3-pentadiol; 2,4-pentadiol; 3,4-pentadiol; 3,5-hexanediol; 1,1-pentadiol; 2,2-pentadiol; 3,3-pentadiol; 1,6-hexanediol; 1,5-hexanediol; 1,4-hexanediol; 1,3-hexanediol; 1,2-hexanediol; 2,3-hexanediol; 2,4-hexanediol; 2,5-hexanediol; 3,4-hexanediol; 3,5-hexanediol; 4,5-hexanediol; 1,1-hexanediol; 2,2-hexanediol; 3,3-hexanediol; 1,7-heptadiol; 1,6-heptadiol; 1,5-heptadiol; 1,4-heptadiol; 1,3-heptadiol; 1,2-heptadiol; 2,3-heptadiol; 2,4-heptadiol; 2,5-heptadiol; 2, 6-heptadiol; 3,3-heptadiol; 3,4-heptadiol; 1,1-heptadiol; 2,2-heptadiol; 3,3-heptadiol; 4,4-heptadiol; 1,2-dihydroxybenzene; 1,3-dihydroxybenzene; 1,4-dihydroxybenzene; 1,4-di-(betahydroxyethyl)-hydroxyquinone; 2,5-di-(hydroxyethyl)-hydroxyquinone; 2,3-di-(hydroxyethyl)-hydroxyquinone; 3,5-di-(hydroxyethyl)-hydroxyquinone; 2,5-di-(hydroxyethyl)-hydroxyquinone; 2,3-di-(hydroxymethyl)-hydroxyquinone; 3,5-di-(hydroxymethyl)-hydroxyquinone; 1,4-di-(betahydroxyethyl)-bisphenol A; 1,3-di-(betahydroxyethyl)-bisphenol A; 1,2-di-(betahydroxyethyl)-bisphenol A; 1,5-di-(betahydroxyethyl)-bisphenol A; 2,3-di-(betahydroxyethyl)-bisphenol A; 2,4-di-(betahydroxyethyl)-bisphenol A; 2,5-di-(betahydroxyethyl)-bisphenol A; 2,6-di-(betahydroxyethyl)-bisphenol A; 3,4-di-(betahydroxyethyl)-bisphenol A; 3,5-di-(betahydroxyethyl)-bisphenol A; or a mixture thereof; (vii) the one or more chain extender includes or is one or more (e.g., 1, 2, 3, 4, 5, or more) diamine chain extender that includes or is at least one of 2,2′-diaminodiphenylmethane; 2,3′-diaminodiphenylmethane; 2,4′-diaminodiphenylmethane; 2,5′-diaminodiphenylmethane; 2,6′-diaminodiphenylmethane; 3,4′-diaminodiphenylmethane; 3,5′-diaminodiphenylmethane; 3,6′-diaminodiphenylmethane; 4,4′-diaminodiphenylmethane; 4,5′-diaminodiphenylmethane; 4,6′-diaminodiphenylmethane; 5,6′-diaminodiphenylmethane; 2,2′-dichloro-3,3′-diaminodiphenylmethane; 2,2′-dichloro-4,4′-diaminodiphenylmethane; 5,5′-dichloro-3,3′-diaminodiphenylmethane; 2,2′-dichloro-6,6′-diaminodiphenylmethane; 2,2′-dichloro-3,4′-diaminodiphenylmethane; 2,2′-dichloro-3,5′-diaminodiphenylmethane; 2,2′-dichloro-3,6′-diaminodiphenylmethane; 2,2′-dichloro-4,5′-diaminodiphenylmethane; 2,2′-dichloro-4,6′-diaminodiphenylmethane; 2,2′-dichloro-5,6′-diaminodiphenylmethane; 3,3′-dichloro-2,2′-diaminodiphenylmethane; 3,3′-dichloro-4,4′-diaminodiphenylmethane; 3,3′-dichloro-5,5′-diaminodiphenylmethane; 3,3′-dichloro-6,6′-diaminodiphenylmethane; 3,3′-dichloro-2,5′-diaminodiphenylmethane; 3,3′-dichloro-4,5′-diaminodiphenylmethane; 3,3′-dichloro-6,5′-diaminodiphenylmethane; 3,3′-dichloro-4,2′-diaminodiphenylmethane; 3,3′-dichloro-4,6′-diaminodiphenylmethane; 4,4′-dichloro-2,2′-diaminodiphenylmethane; 4,4′-dichloro-3,3′-diaminodiphenylmethane; 4,4′-dichloro-5,5′-diaminodiphenylmethane; 4,4′-dichloro-6,6′-diaminodiphenylmethane; 4,4′-dichloro-2,3′-diaminodiphenylmethane; 4,4′-dichloro-2,5′-diaminodiphenylmethane; 4,4′-dichloro-2,6′-diaminodiphenylmethane; 4,4′-dichloro-3,5′-diaminodiphenylmethane; 4,4′-dichloro-3,6′-diaminodiphenylmethane; 4,4′-dichloro-5,6′-diaminodiphenylmethane; 5,5′-dichloro-2,2′-diaminodiphenylmethane; 5,5′-dichloro-3,3′-diaminodiphenylmethane; 5,5′-dichloro-4,4′-diaminodiphenylmethane; 5,5′-dichloro-6,6′-diaminodiphenylmethane; 5,5′-dichloro-2,3′-diaminodiphenylmethane; 5,5′-dichloro-2,4′-diaminodiphenylmethane; 5,5′-dichloro-2,6′-diaminodiphenylmethane; 5,5′-dichloro-3,4′-diaminodiphenylmethane; 5,5′-dichloro-3,6′-diaminodiphenylmethane; 5,5′-dichloro-4,6′-diaminodiphenylmethane; 6,6′-dichloro-2,2′-diaminodiphenylmethane; 6,6′-dichloro-3,3′-diaminodiphenylmethane; 6,6′-dichloro-4,4′-diaminodiphenylmethane; 6,6′-dichloro-5,5′-diaminodiphenylmethane; 6,6′-dichloro-2,3′-diaminodiphenylmethane; 6,6′-dichloro-2,4′-diaminodiphenylmethane; 6,6′-dichloro-2,5′-diaminodiphenylmethane; 6,6′-dichloro-3,4′-diaminodiphenylmethane; 6,6′-dichloro-3,5′-diaminodiphenylmethane; 6,6′-dichloro-4,5′-diaminodiphenylmethane; 1,4-diaminobenzene; 1,2-diaminobenzene; 1,3-diaminobenzene; 2,2′-dimethoxy-3,3′-diamino biphenyl; 2,2′-dimethoxy-4,4′-diamino biphenyl; 5,5′-dimethoxy-3,3′-diamino biphenyl; 2,2′-dimethoxy-6,6′-diamino biphenyl; 2,2′-dimethoxy-3,4′-diamino biphenyl; 2,2′-dimethoxy-3,5′-diamino biphenyl; 2,2′-dimethoxy-3,6′-diamino biphenyl; 2,2′-dimethoxy-4,5′-diamino biphenyl; 2,2′-dimethoxy-4,6′-diamino biphenyl; 2,2′-dimethoxy-5,6′-diamino biphenyl; 3,3′-dimethoxy-2,2′-diamino biphenyl; 3,3′-dimethoxy-4,4-diamino biphenyl; 3,3′-dimethoxy-5,5′-diamino biphenyl; 3,3′-dimethoxy-6,6′-diamino biphenyl; 3,3′-dimethoxy-2,5′-diamino biphenyl; 3,3′-dimethoxy-4,5′-diamino biphenyl; 3,3′-dimethoxy-6,5′-diamino biphenyl; 3,3′-dimethoxy-4,2′-diamino biphenyl; 3,3′-dimethoxy-4,6′-diamino biphenyl; 4,4′-dimethoxy-2,2′-diamino biphenyl; 4,4′-dimethoxy-3,3′-diamino biphenyl; 4,4′-dimethoxy-5,5′-diamino biphenyl; 4,4′-dimethoxy-6,6′-diamino biphenyl; 4,4′-dimethoxy-2,3′-diamino biphenyl; 4,4′-dimethoxy-2,5′-diamino biphenyl; 4,4′-dimethoxy-2,6′-diamino biphenyl; 4,4′-dimethoxy-3,5′-diamino biphenyl; 4,4′-dimethoxy-3,6′-diamino biphenyl; 4,4′-dimethoxy-5,6′-diamino biphenyl; 5,5′-dimethoxy-2,2′-diamino biphenyl; 5,5′-dimethoxy-3,3′-diamino biphenyl; 5,5′-dimethoxy-4,4′-diamino biphenyl; 5,5′-dimethoxy-6,6′-diamino biphenyl; 5,5′-dimethoxy-2,3′-diamino biphenyl; 5,5′-dimethoxy-2,4′-diamino biphenyl; 5,5′-dimethoxy-2,6′-diamino biphenyl; 5,5′-dimethoxy-3,4′-diamino biphenyl; 5,5′-dimethoxy-3,6′-diamino biphenyl; 5,5′-dimethoxy-4,6′-diamino biphenyl; 6,6′-dimethoxy-2,2′-diamino biphenyl; 6,6′-dimethoxy-3,3′-diamino biphenyl; 6,6′-dimethoxy-4,4′-diamino biphenyl; 6,6′-dimethoxy-5,5′-diamino biphenyl; 6,6′-dimethoxy-2,3′-diamino biphenyl; 6,6′-dimethoxy-2,4′-diamino biphenyl; 6,6′-dimethoxy-2,5′-diamino biphenyl; 6,6′-dimethoxy-3,4′-diamino biphenyl; 6,6′-dimethoxy-3,5′-diamino biphenyl; 6,6′-dimethoxy-4,5′-diamino biphenyl; 2,2′-dimethyl-3,3′-diamino biphenyl; 2,2′-dimethyl-4,4′-diamino biphenyl; 5,5′-dimethyl-3,3′-diamino biphenyl; 2,2′-dimethyl-6,6′-diamino biphenyl; 2,2′-dimethyl-3,4′-diamino biphenyl; 2,2′-dimethyl-3,5′-diamino biphenyl; 2,2′-dimethyl-3,6′-diamino biphenyl; 2,2′-dimethyl-4,5′-diamino biphenyl; 2,2′-dimethyl-4,6′-diamino biphenyl; 2,2′-dimethyl-5,6′-diamino biphenyl; 3,3′-dimethyl-2,2′-diamino biphenyl; 3,3′-dimethyl-4,4-diamino biphenyl; 3,3′-dimethyl-5,5′-diamino biphenyl; 3,3′-dimethyl-6,6′-diamino biphenyl; 3,3′-dimethyl-2,5′-diamino biphenyl; 3,3′-dimethyl-4,5′-diamino biphenyl; 3,3′-dimethyl-6,5′-diamino biphenyl; 3,3′-dimethyl-4,2′-diamino biphenyl; 3,3′-dimethyl-4,6′-diamino biphenyl; 4,4′-dimethyl-2,2′-diamino biphenyl; 4,4′-dimethyl-3,3′-diamino biphenyl; 4,4′-dimethyl-5,5′-diamino biphenyl; 4,4′-dimethyl-6,6′-diamino biphenyl; 4,4′-dimethyl-2,3′-diamino biphenyl; 4,4′-dimethyl-2,5′-diamino biphenyl; 4,4′-dimethyl-2,6′-diamino biphenyl; 4,4′-dimethyl-3,5′-diamino biphenyl; 4,4′-dimethyl-3,6′-diamino biphenyl; 4,4′-dimethyl-5,6′-diamino biphenyl; 5,5′-dimethyl-2,2′-diamino biphenyl; 5,5′-dimethyl-3,3′-diamino biphenyl; 5,5′-dimethyl-4,4′-diamino biphenyl; 5,5′-dimethyl-6,6′-diamino biphenyl; 5,5′-dimethyl-2,3′-diamino biphenyl; 5,5′-dimethyl-2,4′-diamino biphenyl; 5,5′-dimethyl-2,6′-diamino biphenyl; 5,5′-dimethyl-3,4′-diamino biphenyl; 5,5′-dimethyl-3,6′-diamino biphenyl; 5,5′-dimethyl-4,6′-diamino biphenyl; 6,6′-dimethyl-2,2′-diamino biphenyl; 6,6′-dimethyl-3,3′-diamino biphenyl; 6,6′-dimethyl-4,4′-diamino biphenyl; 6,6′-dimethyl-5,5′-diamino biphenyl; 6,6′-dimethyl-2,3′-diamino biphenyl; 6,6′-dimethyl-2,4′-diamino biphenyl; 6,6′-dimethyl-2,5′-diamino biphenyl; 6,6′-dimethyl-3,4′-diamino biphenyl; 6,6′-dimethyl-3,5′-diamino biphenyl; 6,6′-dimethyl-4,5′-diamino biphenyl; 2,2′-diamino biphenyl; 2,3′-diamino biphenyl; 2,4′-diamino biphenyl; 2,5′-diamino biphenyl; 2,6′-diamino biphenyl; 3,4′-diamino biphenyl; 3,5′-diamino biphenyl; 3,6′-diamino biphenyl; 4,4′-diamino biphenyl; 4,5′-diamino biphenyl; 4,6′-diamino biphenyl; 5,6′-diamino biphenyl; 2,2′-dichloro-3,3′-diamino biphenyl; 2,2′-dichloro-4,4′-diamino biphenyl; 5,5′-dichloro-3,3′-diamino biphenyl; 2,2′-dichloro-6,6′-diamino biphenyl; 2,2′-dichloro-3,4′-diamino biphenyl; 2,2′-dichloro-3,5′-diamino biphenyl; 2,2′-dichloro-3,6′-diamino biphenyl; 2,2′-dichloro-4,5′-diamino biphenyl; 2,2′-dichloro-4,6′-diamino biphenyl; 2,2′-dichloro-5,6′-diamino biphenyl; 3,3′-dichloro-2,2′-diamino biphenyl; 3,3′-dichloro-4,4′-diamino biphenyl; 3,3′-dichloro-5,5′-diamino biphenyl; 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl; 4,4′-dichloro-2,2′-diamino biphenyl; 4,4′-dichloro-3,3′-diamino biphenyl; 4,4′-dichloro-5,5′-diamino biphenyl; 4,4′-dichloro-6,6′-diamino biphenyl; 4,4′-dichloro-2,3′-diamino biphenyl; 4,4′-dichloro-2,5′-diamino biphenyl; 4,4′-dichloro-2,6′-diamino biphenyl; 4,4′-dichloro-3,5′-diamino biphenyl; 4,4′-dichloro-3,6′-diamino biphenyl; 4,4′-dichloro-5,6′-diamino biphenyl; 5,5′-dichloro-2,2′-diamino biphenyl; 5,5′-dichloro-3,3′-diamino biphenyl; 5,5′-dichloro-4,4′-diamino biphenyl; 5,5′-dichloro-6,6′-diamino biphenyl; 5,5′-dichloro-2,3′-diamino biphenyl; 5,5′-dichloro-2,4′-diamino biphenyl; 5,5′-dichloro-2,6′-diamino biphenyl; 5,5′-dichloro-3,4′-diamino biphenyl; 5,5′-dichloro-3,6′-diamino biphenyl; 5,5′-dichloro-4,6′-diamino biphenyl; 6,6′-dichloro-2,2′-diamino biphenyl; 6,6′-dichloro-3,3′-diamino biphenyl; 6,6′-dichloro-4,4′-diamino biphenyl; 6,6′-dichloro-5,5′-diamino biphenyl; 6,6′-dichloro-2,3′-diamino biphenyl; 6,6′-dichloro-2,4′-diamino biphenyl; 6,6′-dichloro-2,5′-diamino biphenyl; 6,6′-dichloro-3,4′-diamino biphenyl; 6,6′-dichloro-3,5′-diamino biphenyl; 6,6′-dichloro-4,5′-diamino biphenyl; or a mixture thereof; or (viii) a combination thereof.

In any aspect or embodiment described herein, at least one of: (i) the one or more additional polyol includes or is at least one of N-butanol; ethylene glycol; 1,2-propanediol; 1,3-butanediol; 1,4-butanediol; 2,3-butanediol; 1,5-pentanediol; 1,6-hexanediol; neopentyl glycol; 1,4-dihydroxycyclohexane; 1,4-dimethylolcyclohexane; 1,8-octanediol; 1,10-decanediol; 1,12-dodecanediol; 1,4-cyclohexanediol; 1,4-cyclohexanedimethanol; N-substituted ethanolamine; glycerol; trimethylolpropane; trimethylolethane; pentaerythritol; or a combination thereof; (ii) the one or more isocyanate is at least one of 4,4′-diphenylmethane diisocyanate, isophorone diisocyanate, 1,6-hexamethylene diisocyanate, toluene-2,4-diisocyanate, 1,5-naphthylene diisocyanate, 4,4′-dicyclohexylmethane diisocyanate, or a mixture thereof; (iii) the one or more chain extender includes or is at least one of diethylene triamine (DETA), ethylene diamine (EDA), meta-xylylenediamine (MXDA), aminoethyl ethanolamine (AEEA), 2-methyl pentane diamine, propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, hydrazine, substituted hydrazine, hydrazine reaction products, or a combination thereof; or (iv) a combination thereof.

In any aspect or embodiment described herein, at least one of: (i) the one or more additional polyol includes or is at least one of trimethylolpropane (TMP), glycerin, or a mixture thereof; (ii) the one or more isocyanate includes or is at least one of 4,4′-diisocyanate dicyclohexylmethane, isophorone diisocyanate, or a combination thereof; (iii) the one or more catalyst includes or is an organobismuth in at least one of a carboxylic acid, dibutyltin dilaurate, dibutyltin dioctanoate, or a combination thereof; (iv) the one or more cosolvent includes or is at least one of 1-butylpyrrolidin-2-one, dipropylene glycol dimethyl ether, or a combination thereof; (v) the one or more internal emulsifier includes or is at least one of dimethylol propionic acid (DMPA), dimethylethanolamine (DMEA), or a combination thereof); (vi) the one or more counterion or neutralizer includes or is at least one of triethylamine (TEA), dimethylethanolamine (DMEA), or a combination thereof; (vii) water sufficient for the mixture to have a total solids content of about 30% to about 50% (e.g., about 45%); (viii) the one or more defoamer includes or is at least one of 2-methyl-3-isothiazolone, decamethylcyclopentasiloxane, octamethylcyclotetrasiloxane, or a combination thereof; (ix) the one or more chain extender includes or is at least one of water, hydrazine, hydrazine hydrate, adipic dihydrazide, aminoethyl ethanolamine (AEEA), ethylene diamine (EDA), or a combination thereof; or (x) a combination thereof.

In any aspect or embodiment described herein, at least one of: (i) a viscosity of less than or equal to about 50 centipoise (cps) (e.g., less than or equal to about 30 cps); (ii) a total solids content of less than or equal to 40% (e.g., less than or equal to about 35%); (iii) a softening point of about 140° C. to about 210° C. (e.g., about 170° C. to about 210° C. or about 180° C. to about 210° C.); (iv) a tensile strength of about 4000 pounds per square inch (psi) to about 6500 psi (e.g., about 4500 psi to about 6000 psi or about 5000 psi to about 5500 psi); (v) an elongation percent of about 10% to about 40% (e.g., about 10% to about 35% or about 10% to about 30%); or (vi) a combination thereof.

An further aspect of the present disclosure relates to a film or coating comprising, or produced from, the polyurethane dispersion or waterborne polyurethane, of the present disclosure, or a polyurethane dispersion or waterborne polyurethane, produced by the method of the present disclosure.

Another aspect of the present disclosure relates to an article comprising the film or coating of the present disclosure.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### DETAILED DESCRIPTION

The present disclosure will now be described more fully hereinafter, but not all embodiments of the disclosure are shown. While the disclosure has been described with reference to exemplary embodiments, it will be understood by those skilled in the art that various changes can be made and equivalents can be substituted for elements thereof without departing from the scope of the disclosure. In addition, many modifications can be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges can independently be included in the smaller ranges is also encompassed within the invention, subject to any specifically excluded limit in the stated range. Where the stated range includes one or both of the limits, ranges excluding either/or both of those included limits are also included in the present disclosure.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

Surprisingly and unexpectedly, the inventors found that the caprolactone polyols of the present disclosure relates to polyurethane dispersions or waterborne polyurethanes that producing films and/or coatings that have improved mechanical properties and chemical resistance, as compared to standard, commercially available polyols. In any aspect or embodiment described herein, the caprolactone polyol is made by a process comprising: admixing caprolactone monomers and pentaspiroglycol (PSG) to form an initiator-caprolactone mixture or reaction mixture; adding one or more (e.g., 1, 2, 3, 4, 5, or more) catalyst (e.g., at least one of a tin-based catalyst (e.g., a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

### Caprolactone Polyols of the Disclosure and Methods of Making the Same

An aspect of the present disclosure relates to a caprolactone polyol made by a process comprising: admixing caprolactone monomers and pentaspiroglycol (PSG) to form an initiator-caprolactone mixture or reaction mixture; adding one or more (e.g., 1, 2, 3, 4, 5, or more) catalyst (e.g., at least one of a tin-based catalyst (e.g., a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

Another aspect of the present disclosure relates to a method of making the caprolactone polyol of the present disclosure. The method comprises, consisting essentially or, or consisting of, admixing caprolactone monomers and pentaspiroglycol (PSG) to form an initiator-caprolactone mixture or reaction mixture; adding one or more (e.g., 1, 2, 3, 4, 5, or more) catalyst (e.g., at least one of a tin-based catalyst (e.g., a stannous octoate catalyst, such as DABCO® T-9), a zinc-based catalyst, a zirconium-based catalyst, a titanium-based catalyst, or a combination thereof) to the initiator-caprolactone mixture to form a reaction mixture; and polymerizing (e.g., ring opening polymerization) the caprolactone monomers in the reaction mixture, thereby forming the caprolactone polyol.

In any aspect or embodiment described herein, the process further comprises at least one of: (i) sparing the initiator-caprolactone mixture prior to adding the one or more catalyst (e.g., sparging the initiator-caprolactone mixture with nitrogen); (ii) incubating the initiator-caprolactone mixture prior to adding the one or more catalyst (e.g., incubating for about 0.5 hours to about 1.5 hours, about 0.75 hours to about 1.25 hours, or about 1 hour, such as while sparking the initiator-caprolactone mixture), (iii) heating the initiator-caprolactone mixture to about 70° C. to about 100° C. (e.g., about 75° C. to about 95° C.), (iv) removing excess water from the initiator-caprolactone mixture, or (v) a combination thereof.

In any aspect or embodiment described herein, polymerizing was performed (i) with refluxing, (ii) at about 150° C. to about 190° C. (e.g., about 150° C. to about 180° C.), (iii) until the caprolactone monomer concentration is below 0.5%; (iv) for about 4 to about 6 hours, or (v) a combination thereof.

In any aspect or embodiment described herein, the process further comprises at least one of: (i) adding one or more (e.g., 1, 2, 3, 4, 5, or more) acid scavengers (e.g., adding one or more acid scavenger after polymerizing, adding a sufficient amount of one or more acid scavenger to result in the caprolactone polyol having an acid number of <0.10 or <0.05 mgKOH/g, and/or the one or more acid scavenger includes or is at least one of monomeric carbodiimide, polymeric carbodiimide, or a combination thereof); (ii) adding additional catalyst (e.g., a tin-based catalyst (e.g., a stannous octoate catalyst, such as DABCO® T-9), a zinc-based catalyst, a zirconium-based catalyst, a titanium-based catalyst, or a combination thereof) to the reaction mixture (e.g., adding additional catalyst while heating the reaction mixture, such as to about 150° C. to about 190° C., such as about 150° C. to about 160° C.), thereby forming the caprolactone polyol; or (iii) a combination thereof. For example, in any aspect or embodiment described herein, the one or more acid scavenger includes or is at least one of monomeric carbodiimide (e.g., at least one of STABAXOL® I (LANXESS, Cologne, Germany), Stabilizer 7000A (bis(2,6-diisopropylphenyl) carbodiimide, or a combination thereof), polymeric carbodiimide (e.g., at least one of LUBIO® AS 15 (Schäfer-Additivsysteme GmbH, Rhein Germany), LUBIO® AS 11 (Schäfer-Additivsysteme GmbH, Rhein Germany), LUBIO® Hydrostab 2 (Schäfer-Additivsysteme GmbH, Rhein Germany), LUBIO® Hydrostab 3 (Schäfer-Additivsysteme GmbH, Rhein Germany), LUBIO® Hydrostab 4 (Schäfer-Additivsysteme GmbH, Rhein Germany), LUBIO® Hydrostab 5 (Schäfer-Additivsysteme GmbH, Rhein Germany), LUBIO® Hydrostab 6 (Schäfer-Additivsysteme GmbH, Rhein Germany), STABAXOL® P200 (LANXESS, Cologne, Germany), or a combination thereof), or a combination thereof.

In any aspect or embodiment described herein, the initiator-caprolactone mixture further comprises one or more (e.g., 1, 2, 3, 4, 5, or more) antioxidant and/or one or more (e.g., 1, 2, 3, 4, 5, or more) stabilizer (e.g., at least one of a phenolic antioxidant and/or stabilizer, a sterically hindered phenolic antioxidant and/or stabilizer, pentaerythritol tetrakis(3-(3,5-di-tert-butyl-4-hydroxyphenyl)propionate) (IRGANOX® 1010), a phosphite antioxidant and/or stabilizer, bis(2,4-di-tert-butylphenol)pentaerythritol diphosphate (e.g., IRGAFOS® 126), an antihydrolysis agent (STABAXOL® I), carbodiimide (e.g., monomeric carbodiimide), or a combination thereof).

In any aspect or embodiment described herein, at least one of: (i) the caprolactone monomers is present in an amount of about 65 wt % to about 95 wt % (e.g., about 65 wt % to about 90 wt %, or about 65 wt % to about 85 wt %) of the initiator-caprolactone mixture; (ii) the pentaspiroglycol (PSG) is present in an amount of about 5 wt % to about 35 wt % (e.g., about 10 wt % to about 35 wt %, or about 15 wt % to about 35 wt %) of the initiator-caprolactone mixture; (iii) the caprolactone monomers is present in an amount of about 65 wt % to about 95 wt % (e.g., about 65 wt % to about 90 wt %, or about 65 wt % to about 85 wt %) of the reaction mixture; (iv) the pentaspiroglycol (PSG) is present in an amount of about 5 wt % to about 35 wt % (e.g., about 10 wt % to about 35 wt %, or about 15 wt % to about 35 wt %) of the reaction mixture; (v) the one or more catalyst is present in an amount of about 0.001 wt % to about 5 wt % (e.g., about 0.001 wt % to about 5 wt %, about 0.001 wt % to about 4 wt %, about 0.001 wt % to about 3 wt %, about 0.001 wt % to about 2 wt %, about 0.001 wt % to about 1 wt %, about 0.001 wt % to about 0.5 wt %, about 0.001 wt % to about 0.25 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.1 wt % to about 0.25 wt %, about 0.2 wt % to about 5 wt %, about 0.2 wt % to about 4 wt %, about 0.2 wt % to about 3 wt %, about 0.2 wt % to about 2 wt %, about 0.2 wt % to about 1 wt %, about 0.2 wt % to about 0.5 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 0.75 wt % to about 5 wt %, about 0.75 wt % to about 4 wt %, about 0.75 wt % to about 3 wt %, about 0.75 wt % to about 2 wt %, about 0.75 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 2 wt % to about 5 wt %, about 2 wt % to about 4 wt %, about 2 wt % to about 3 wt %, about 3 wt % to about 5 wt %, about 3 wt % to about 4 wt %, or about 4 wt % to about 5 wt %) of the reaction mixture; (vi) the one or more antioxidants or stabilizer is present in an amount of up to about 2 wt % (e.g., up to about 1.5 wt %, up to about 1 wt %, up to about 0.5 wt %, up to about 0.25 wt %, about 0.1 wt % to about 2 wt %, about 0.1 wt % to about 1.5 wt %, about 0.1 wt % to about 1 wt %, about 0.1 wt % to about 0.75 wt %, about 0.1 wt % to about 0.5 wt %, or about 0.1 wt % to about 0.25 wt %) of the reaction mixture; or (vii) a combination thereof.

In any aspect or embodiment described herein, at least one of: (i) the molecular weight of the caprolactone polyol is about 1,000 g/mol (MW) to about 4500 MW (e.g., about 1,000 MW to about 4,000 MW, about 1,000 MW to about 3,000 MW, about 1,000 MW to about 2,100 MW, or about 1,000 MW to about 2,000 MW); (ii) the caprolactone polyol comprises less than about 5% (e.g., less than about 4%, less than about 3%, less than about 2%, less than about 1%, less than about 0.5%, less than about 0.5%, less than about 0.25%, less than about 0.1%) caprolactone monomer; (iii) the caprolactone polyol has an acid number of <0.4 KOH/g, (e.g., <0.3 KOH/g, <0.3 mgKOH/g, <0.2 KOH/g, <0.1 KOH/g, <0.75 KOH/g, <0.05 mgKOH/g); (iv) the one or more catalysts is one or more catalyst for ring-opening polymerization (e.g., at least one of zinc lactate, zinc oxide, zinc powder, diethyl zinc, tin lactate, tin oxide, tin dioxide, stannous oxide, stannous lactate, stannous octoate, stannous chloride, tin powder, propanoic acid or tetrabutyl titanate, or a combination thereof); or (v) a combination thereof.

As used herein, the term “caprolactone” is intended to encompass unsubstituted caprolactone and substituted caprolactone. The term “ε-caprolactone” is intended to encompass unsubstituted ε-caprolactone and substituted ε-caprolactone. Unsubstituted ε-caprolactone is particularly preferred.

In any aspect or embodiment described herein, polymerization may include the polymerization of caprolactone, particularly ε-caprolactone, with a mixture of different caprolactones, for example, substituted and unsubstituted caprolactones or a mixture of caprolactones having different substituents.

In any aspect or embodiment described herein, substituted ε-caprolactone monomers that may be used in the production of the caprolactone polyols include at least one of C₁₋₁₂ alkyl substituted ε-caprolactone, C₁₋₁₂ alkenyl substituted ε-caprolactone, C₁₋₁₂ alkynyl substituted ε-caprolactone, C₁₋₁₈ cycloalkyl substituted ε-caprolactone, C₁₋₁₂ alkoxy substituted ε-caprolactone, C₁₋₁₈ aryl substituted ε-caprolactone, C₁₋₁₈ alkaryl substituted ε-caprolactone, C₁₋₁₈ aralkyl substituted-caprolactone, C₁₋₁₈ aryloxy substituted ε-caprolactone, and mixtures thereof.

In any aspect or embodiment described herein, substituted ε-caprolactone monomers that may be used in the production of the auxiliary caprolactone polyols include mono-, di- or tri-substituted monomers. In any aspect or embodiment described herein, exemplary substituted ε-caprolactone monomers include at least one of monomethyl ε-caprolactone, monoethyl ε-caprolactone, monopropyl ε-caprolactone, monomethoxy ε-caprolactone, monoethoxy ε-caprolactone, monopropoxy ε-caprolactone, monobenzyl ε-caprolactone, monophenyl ε-caprolactone, dimethyl ε-caprolactone, diethyl ε-caprolactone, dipropyl ε-caprolactone, dimethoxy 8-caprolactone, diethoxy ε-caprolactone, dipropoxy ε-caprolactone, dibenzyl ε-caprolactone, diphenyl-caprolactone, and mixtures thereof.

### Prepolymer Composition, Polyurethane Dispersion, or Waterborne Polyurethane of the Disclosure and Methods of Making the Same

A further aspect of the present disclosure relates to a prepolymer composition, polyurethane dispersion, or waterborne polyurethane, comprising one or more (e.g., 1, 2, 3, 4, 5, or more) caprolactone polyol of the present disclosure.

Another aspect of the present disclosure relates to a prepolymer composition, polyurethane dispersion, or waterborne polyurethane, made by a process comprising reacting (i) the one or more caprolactone polyol of the present disclosure, (ii) optionally one or more (e.g., 1, 2, 3, 4, 5, or more) additional polyol (e.g. trimethylolpropane (TMP)), (iii) one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), and (iv) one or more (e.g., 1, 2, 3, 4, 5, or more) catalyst (e.g., at least one of a bismuth catalyst (e.g., organobismuth in a carboxylic acid), dibutyltin dilaurate, dibutyltin dioctanoate, or a combination thereof), thereby forming a polyurethane material (e.g., a prepolymer composition).

An additional aspect of the present disclosure relates to a method of making the prepolymer composition, polyurethane dispersion, or waterborne polyurethane, of any one of claims 8-22, the method comprising reacting one or more (e.g., 1, 2, 3, 4, 5, or more) caprolactone polyol, optionally one or more (e.g., 1, 2, 3, 4, 5, or more) additional polyol (e.g. trimethylolpropane (TMP)), one or more (e.g., 1, 2, 3, 4, 5, or more) isocyanate comprising two or more isocyanate groups (e.g., diisocyanate or polyisocyanate, such as at least one of 4,4′-diisocyanate dicyclohexylmethane, isophorone diisocyanate, or a combination thereof), and one or more (e.g., 1, 2, 3, 4, 5, or more) catalyst (e.g., at least one of a bismuth catalyst (e.g., organobismuth in a carboxylic acid), dibutyltin dilaurate, dibutyltin dioctanoate, or a combination thereof), thereby forming a polyurethane material (e.g., a prepolymer composition).

In any aspect or embodiment described herein, at least one of: (i) the process further comprises heating the one or more caprolactone polyol, optionally the one or more additional polyol, and the one or more isocyanate prior to reacting (e.g., prior to adding the one or more catalyst and/or heating to a temperature of about 65° C. to about 100° C., about 70° C. to about 90° C., about 70° C. to about 80° C., or about 75° C.); (ii) reacting is performed for about 1.0 hour to about 2.0 hours (e.g., about 1.0 hour to about 1.75 hours, about 1.0 hour to about 1.5 hours, about 1 hour to about 1.25 hours, about 1.25 s hour to about 1.75 hours, about 1.25 hours to about 1.5 hours, about 1.5 hours to about 1.75 hours, or about 1.5 hours); (iii) the process further comprises sparging the caprolactone polyol prior to reacting (e.g., sparging with nitrogen and/or sparging for about 0.5 hours to about 1.5 hours, about 0.75 hours to about 1.25 hours, or about 1 hour); or (iv) a combination thereof.

In any aspect or embodiment described herein, the process further comprises adding to, and/or mixing with, the polyurethane material: (i) optionally, one or more (e.g., 1, 2, 3, 4, 5, or more) cosolvent (e.g., an aprotic solvent, such as at least one of a dipolar aprotic solvent (e.g., 1-butylpyrrolidin-2-one), aprotic propylene oxide solvent (e.g., dipropylene glycol dimethyl ether), or a combination thereof); and (ii) one or more (e.g., 1, 2, 3, 4, 5, or more) internal emulsifier (e.g., at least one of dimethylol propionic acid (DMPA), dimethylethanolamine (DMEA), or a combination thereof), thereby forming a polyurethane material (e.g., a prepolymer composition).

In any aspect or embodiment described herein, the process further comprises at least one of: (i) adding the one or more internal emulsifier after the cosolvent; (ii) adjusting the temperature of (a) the polyurethane material, or (b) the polyurethane material and the cosolvent mixture, (e.g., prior to adding the one or more internal emulsifier) to about 85° C. to about 105° C. (e.g., about 90° C. to about 100° C.); (iii) incubating or mixing the one or more internal emulsifier with (a) the polyurethane material, or (b) the polyurethane material and the cosolvent mixture, for about 45 minutes to about 180 minutes (e.g., about 60 minutes to about 120 minutes); (iv) incubating or mixing the one or more internal emulsifier with (a) the polyurethane material, or (b) the polyurethane material and the cosolvent mixture, at a temperature of about 85° C. to about 105° C. (e.g., about 90° C. to about 100° C.); or (v) a combination thereof.

In any aspect or embodiment described herein, the process further comprises: (i) adding, combining and/or mixing one or more (e.g., 1, 2, 3, 4, 5, or more) counterion or neutralizer (e.g., an amine, such as at least one of triethylamine (TEA), dimethylethanolamine (DMEA), or a combination thereof) with the polyurethane material (e.g., prepolymer composition) to produce a counterion-polyurethane materials mixture; and (ii) adding, combining, and/or mixing water (e.g., water sufficient for the mixture to have a total solids content of about 30% to about 50%, about 30% to about 45%, about 30% to about 40%, about 35% to about 50%, about 35% to about 45%, about 40% to about 50%, about 24.5% to about 47.5%, or about 45%), and optionally one or more (e.g., 1, 2, 3, 4, 5, or more) defoamer (e.g., at least one of 2-methyl-3-isothiazolone, decamethylcyclopentasiloxane, octamethylcyclotetrasiloxane, or a combination thereof), optionally one or more (e.g., 1, 2, 3, 4, 5, or more) chain extender (e.g., at least one of water, hydrazine, hydrazine hydrate, adipic dihydrazide, aminoethyl ethanolamine (AEEA), ethylene diamine (EDA), or a combination thereof), or a combination thereof (e.g., one or more defoamer and one or more chain extender), with the counterion-polyurethane materials mixture to produce a dispersion (e.g., a polyurethane dispersion or waterborne polyurethane).

In any aspect or embodiment described herein, at least one of: (i) adding, combining, and/or mixing the one or more counterion or neutralizer with the polyurethane material (e.g., prepolymer composition) is at a temperature of about 75° C. to about 95° C. (e.g., about 75° C. to about 90° C. or about 80° C. to about 85° C.); (ii) adding, combining, and/or mixing the water, and optionally the one or more defoamer, optionally the one or more chain extender, or a combination thereof, with the counterion-polyurethane materials mixture is at a temperature of about 20° C. to about 35° C. (e.g., about 23° C. to about 30° C. or about 25° C. to about 28° C.); or (iii) a combination thereof.

In any aspect or embodiment described herein, the process further comprises reacting the dispersion with one or more (e.g., 1, 2, 3, 4, 5, or more) chain extender (e.g., at least one of water, inorganic or organic polyamine having an average of about 2 or more primary and/or secondary amine groups, or a combination thereof).

In any aspect or embodiment described herein, at least one of: (i) reacting the dispersion with the one or more chain extender includes slowly adding the one or more chain extender to the dispersion; (ii) the one or more chain extender is a composition comprising formalin and one or more (e.g., 1, 2, 3, 4, 5, or more) chain extender (e.g., at least one of water, hydrazine, hydrazine hydrate, adipic dihydrazide, aminoethyl ethanolamine (AEEA), ethylene diamine (EDA), or a combination thereof); or (iii) a combination thereof.

In any aspect or embodiment described herein, at least one of: (i) the one or more additional polyol includes or is a low-molecular-weight polyol having a number average molecular weight of 400 or less; (ii) the one or more additional polyol has three or more hydroxyl groups; (iii) the one or more internal emulsifier includes or is at least one of one or more (e.g., 1, 2, 3, 4, 5, or more) nonionic emulsifier, one or more (e.g., 1, 2, 3, 4, 5, or more) cationic emulsifier (e.g., a tertiary amine, such as dimethylethanolamine (DMEA)), one or more (e.g., 1, 2, 3, 4, 5, or more) anionic emulsifier (e.g., at least one of carboxylic acid, sulfonated acid, or a combination thereof, such as dimethylol propionic acid (DMPA)), or a combination thereof; (iv) the one or more isocyanate includes or is at least one of monomeric, oligomeric, polymeric, or a mixture thereof; (v) the one or more isocyanate includes or is at least one of an aliphatic polyisocyanate, mono-cyclic polyisocyanate, aromatic polyisocyanates, aromatic/aliphatic polyisocyanate (e.g., tetramethylxylylene diisocyanate (TMXDI)), or a combination thereof; (vi) the one or more catalyst includes or is one or more (e.g., 1, 2, 3, 4, 5, or more) urethane catalyst (e.g., at least one of one or more (e.g., 1, 2, 3, 4, 5, or more) tertiary amine compound, one or more (e.g., 1, 2, 3, 4, 5, or more) amine with isocyanate reactive group(s), one or more (e.g., 1, 2, 3, 4, 5, or more) organometallic compound, or a combination thereof); (vii) the one or more cosolvent includes or is one or more (e.g., 1, 2, 3, 4, 5, or more) aprotic solvent; (viii) the one or more counterion or neutralizer includes or is one or more (e.g., 1, 2, 3, 4, 5, or more) amine; (ix) the one or more defoamer includes or is water-based defoamer (e.g., at least one of 2-methyl-3-isothiazolone, decamethylcyclopentasiloxane, octamethylcyclotetrasiloxane, or a combination thereof); (x) the one or more chain extender has a molecular weight from about 60 to about 600; (xi) the one or more chain extender includes or is at least one of one or more (e.g., 1, 2, 3, 4, 5, or more) diol chain extender, one or more (e.g., 1, 2, 3, 4, 5, or more) diamine chain extender, or a combination thereof; or (xii) a combination thereof.

In any aspect or embodiment described herein, at least one of: (i) the one or more additional polyol includes or is at least one of: one or more (e.g., 1, 2, 3, 4, 5, or more) trihydric alcohol (e.g., low-molecular-weight triol); one or more (e.g., 1, 2, 3, 4, 5, or more) tetrahydric alcohol (e.g., low-molecular-weight tetrol); one or more (e.g., 1, 2, 3, 4, 5, or more) pentahydric alcohol (e.g., low-molecular-weight pentol); one or more (e.g., 1, 2, 3, 4, 5, or more) hexahydric alcohol (e.g., a low-molecular-weight hexol); one or more (e.g., 1, 2, 3, 4, 5, or more) heptahydric alcohol (e.g., low-molecular-weight heptol); one or more (e.g., 1, 2, 3, 4, 5, or more) octahydric alcohol (e.g., low-molecular-weight octahydric alcohol); one or more (e.g., 1, 2, 3, 4, 5, or more) polyalkylene oxide having three or more hydroxyl groups (e.g., low-molecular weight polyalkylene oxide having three or more hydroxyl groups), or a combination thereof); or a combination thereof; (ii) the one or more internal emulsifier includes or is carboxylated diol (e.g., dimethylolpropionic acid (DMPA)); (iii) the one or more isocyanate includes or is at least one of diphenylmethane diisocyanate, isophorone diisocyanate, bimethylene diisocyanate, trimethylene diisocyanate, tetramethylene diisocyanate, pentamethylene diisocyanate, hexamethylene diisocyanate, heptamethylene diisocyanate, toluene diisocyanate, naphthylene diisocyanate, cyclohexylmethane diisocyanate, dicyclohexylmethane diisocyanate, or a mixture thereof; (iv) the one or more catalyst includes or is at least one of an organometallic compound, a organobismuth catalyst, or a combination thereof; (v) the one or more cosolvent includes or is at least one of a dipolar aprotic solvent, an aprotic propylene oxide solvent, or a combination thereof; (vi) the one or more counterion or neutralizer includes or is triethylamine (TEA); (vii) the one or more defoamer includes or is water-based defoamer (e.g., at least one of 2-methyl-3-isothiazolone, decamethylcyclopentasiloxane, octamethylcyclotetrasiloxane, or a combination thereof); (viii) the one or more chain extender includes or is a diol chain extender that includes or is an aliphatic diol or an aromatic diol; (ix) the one or more diol chain extender includes or is at least one of an alkylene oxide or glycol, ethylene glycol, propanediol, butanediol, pentadiol, hexanediol, heptadiol, dihydroxybenzene, di(hydroxyethyl)-hydroxyquinone, di(hydroxymethyl)-hydroxyquinone, di-(hydroxyethyl)-bisphenol A, or a mixture thereof; (x) the one or more diamine chain extender includes or is at least one of diaminodiphenylmethane, dichloro-diaminodiphenylmethane, diaminobenzene, dimethoxy-diamino biphenyl, dimethyl-diamino biphenyl, diamino biphenyl, dichloro-diamino biphenyl, or a mixture thereof; or (xi) a combination thereof.

In any aspect or embodiment described herein, at least one of: (i) the one or more additional polyol includes or is at least one of glycerin; 2-methyl-2-hydroxymethyl-1,3-propanediol; 2,4-dihydroxy-3-hydroxymethylpentane; 1,2,6-hexanetriol; trimethylolpropane; 2,2-bis(hydroxymethyl)-3-butanol; tetramethylolmethane (pentaerythritol); diglycerol; xylitol; sorbitol; mannitol; iditol; dulcitol; altritol; inositol; dipentaerythritol; perseitol; sucrose; polyethylenepolyol, polypropylenepolyol, polyethylenepolypropylenepolyol (such as a random copolymer or a block copolymer); or a combination thereof; (ii) the one or more isocyanate includes or is at least one of 1,3-trimethylene diisocyanate; 2,3-trimethylene diisocyanate; 1,2-trimethylene diisocyanate; 2,2-trimethylene diisocyanate; 1,4-tetramethylene diisocyanate; 1,3-tetramethylene diisocyanate; 1,2-tetramethylene diisocyanate; 2,3-tetramethylene diisocyanate; 1,1-tetramethylene diisocyanate; 2,2-tetramethylene diisocyanate; 1,5-pentamethylene diisocyanate; 1,4-pentamethylene diisocyanate; 1,3-pentamethylene diisocyanate; 1,2-pentamethylene diisocyanate; 2,3-pentamethylene diisocyanate; 2,4-pentamethylene diisocyanate; 3,4-pentamethylene diisocyanate; 3,5-pentamethylene diisocyanate; 1,1-pentamethylene diisocyanate; 2,2-pentamethylene diisocyanate; 3,3-pentamethylene diisocyanate; 1,6-hexamethylene diisocyanate; 1,5-hexamethylene diisocyanate; 1,4-hexamethylene diisocyanate; 1,3-hexamethylene diisocyanate; 1,2-hexamethylene diisocyanate; 2,3-hexamethylene diisocyanate; 2,4-hexamethylene diisocyanate; 2,5-hexamethylene diisocyanate; 3,4-hexamethylene diisocyanate; 3,5-hexamethylene diisocyanate; 4,5-hexamethylene diisocyanate; 1,1-hexamethylene diisocyanate; 2,2-hexamethylene diisocyanate; 3,3-hexamethylene diisocyanate; 1,7-heptamethylene diisocyanate; 1,6-heptamethylene diisocyanate; 1,5-heptamethylene diisocyanate; 1,4-heptamethylene diisocyanate; 1,3-heptamethylene diisocyanate; 1,2-heptamethylene diisocyanate; 2,3-heptamethylene diisocyanate; 2,4-heptamethylene diisocyanate; 2,5-heptamethylene diisocyanate; 2,6-heptamethylene diisocyanate; 3,3-heptamethylene diisocyanate; 3,4-heptamethylene diisocyanate; 1,1-heptamethylene diisocyanate; 2,2-heptamethylene diisocyanate; 3,3-heptamethylene diisocyanate; 4,4-heptamethylene diisocyanate; toluene-2,4-diisocyanate; toluene-2,6-diisocyanate; 1,2-naphthylene diisocyanate; 1,3-naphthylene diisocyanate; 1,4-naphthylene diisocyanate; 1,5-naphthylene diisocyanate; 1,6-naphthylene diisocyanate; 1,7-naphthylene diisocyanate; 1,8-naphthylene diisocyanate; 1,4-cyclohexylmethane diisocyanate; 2,4-cyclohexylmethane diisocyanate; 3,4-cyclohexylmethane diisocyanate; 4,4-cyclohexylmethane diisocyanate; 4,4′-dicyclohexylmethane diisocyanate; 1,4-dicyclohexylmethane diisocyanate; or a mixture thereof; (iii) the one or more isocyanate includes or is at least one of 2,2′-diphenylmethane diisocyanate; 2,4′-diphenylmethane diisocyanate; 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“H12 MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; 30cyclobutene-1,3-diisocyanate; 1,2-cyclohexane diisocyanate; 1,3-cyclohexane diisocyanate; 1,4-cyclohexane diisocyanate; 2,4-methylcyclohexane diisocyanate; 2,6-methylcyclohexane diisocyanate; 4,4′-dicyclohexyldiisocyanate; 2,4′-dicyclohexyldiisocyanate; 1,3,5-cyclohexane triisocyanate; a isocyanate-methylcyclohexane isocyanate; a isocyanatoethylcyclohexane isocyanate; a bis(isocyanatomethyl)-cyclohexane diisocyanate; 4,4′-bis(isocyanatomethyl) dicyclohexane; 2,4′-bis(isocyanatomethyl) dicyclohexane; 2,4-hexahydrotoluenediisocyanate; 2,6-hexahydrotoluenediisocyanate; 1,2-phenylene diisocyanate; 1,3-phenylene diisocyanate; 1,4-phenylene diisocyanate; triphenyl methane-4,4′,4″-triisocyanate; naphthylene-1,5-diisocyanate; 2,4′-biphenyl diisocyanate; 4,4′-biphenyl diisocyanate; 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof; (iv) the one or more catalyst includes or is at least one of: (a) one or more (e.g., 1, 2, 3, 4, 5, or more) tertiary amine catalyst (e.g., a tertiary amine catalyst that is present in an amount of about 0.02 wt % to about 5 wt % of the reaction mixture) comprising at least one of triethylenediamine, N-methylmorpholine, N, N-dimethylcyclohexylamine, pentamethyldiethylenetriamine, tetramethylethylenediamine, bis (dimethylaminoethyl) ether, 1-methyl-4-dimethylaminoethyl-piperazine, 3-methoxy-N-dimethylpropylamine, N-ethylmorpholine; dimethylethanolamine, N-cocomorpholine, N, N-dimethyl-N′, N′-dimethyl isopropylpropylenediamine, N, N-diethyl-3-diethyl amino-propylamine, dimethylbenzylamine, or a mixture thereof; (b) one or more (e.g., 1, 2, 3, 4, 5, or more) organometallic catalyst (e.g., a organometallic catalyst that is present in an amount of about 0.001 to 1 wt % of the reaction mixture) comprising at least one of organobismuth, organo mercury, organolead, organoferric, organotin catalysts, or a combination thereof (preferably organotin catalysts); (c) one or more (e.g., 1, 2, 3, 4, 5, or more) tin catalysts comprising at least one of stannous chloride, tin salts of carboxylic acids (e.g., dibutyltin dilaurate), stannous octoate, or a combination thereof; (d) one or more (e.g., 1, 2, 3, 4, 5, or more) catalyst for the trimerization of polyisocyanates comprising an alkali metal alkoxide; or (e) a combination thereof; (v) the one or more cosolvent includes or is dipropylene glycol diether; (vi) the one or more counterion or neutralizer includes or is triethyl amine (TEA); (vii) the one or more chain extender includes or is one or more (e.g., 1, 2, 3, 4, 5, or more) diol chain extender that includes or is at least one of 1,3-propanediol; 1,2-propanediol; 1,1-propanediol; 2,2-propanediol; 1,4-butanediol; 1,3-butanediol; 1,2-butanediol; 2,3-butanediol; 1,1-butanediol; 2,2-butanediol; 1,5-pentadiol; 1,4-pentadiol; 1,3-pentadiol; 1,2-pentadiol; 2,3-pentadiol; 2,4-pentadiol; 3,4-pentadiol; 3,5-hexanediol; 1,1-pentadiol; 2,2-pentadiol; 3,3-pentadiol; 1,6-hexanediol; 1,5-hexanediol; 1,4-hexanediol; 1,3-hexanediol; 1,2-hexanediol; 2,3-hexanediol; 2,4-hexanediol; 2,5-hexanediol; 3,4-hexanediol; 3,5-hexanediol; 4,5-hexanediol; 1,1-hexanediol; 2,2-hexanediol; 3,3-hexanediol; 1,7-heptadiol; 1,6-heptadiol; 1,5-heptadiol; 1,4-heptadiol; 1,3-heptadiol; 1,2-heptadiol; 2,3-heptadiol; 2,4-heptadiol; 2,5-heptadiol; 2, 6-heptadiol; 3,3-heptadiol; 3,4-heptadiol; 1,1-heptadiol; 2,2-heptadiol; 3,3-heptadiol; 4,4-heptadiol; 1,2-dihydroxybenzene; 1,3-dihydroxybenzene; 1,4-dihydroxybenzene; 1,4-di-(betahydroxyethyl)-hydroxyquinone; 2,5-di-(hydroxyethyl)-hydroxyquinone; 2,3-di-(hydroxyethyl)-hydroxyquinone; 3,5-di-(hydroxyethyl)-hydroxyquinone; 2,5-di-(hydroxyethyl)-hydroxyquinone; 2,3-di-(hydroxymethyl)-hydroxyquinone; 3,5-di-(hydroxymethyl)-hydroxyquinone; 1,4-di-(betahydroxyethyl)-bisphenol A; 1,3-di-(betahydroxyethyl)-bisphenol A; 1,2-di-(betahydroxyethyl)-bisphenol A; 1,5-di-(betahydroxyethyl)-bisphenol A; 2,3-di-(betahydroxyethyl)-bisphenol A; 2,4-di-(betahydroxyethyl)-bisphenol A; 2,5-di-(betahydroxyethyl)-bisphenol A; 2,6-di-(betahydroxyethyl)-bisphenol A; 3,4-di-(betahydroxyethyl)-bisphenol A; 3,5-di-(betahydroxyethyl)-bisphenol A; or a mixture thereof; (vi) the one or more chain extender includes or is one or more (e.g., 1, 2, 3, 4, 5, or more) diamine chain extender that includes or is at least one of 2,2′-diaminodiphenylmethane; 2,3′-diaminodiphenylmethane; 2,4′-diaminodiphenylmethane; 2,5′-diaminodiphenylmethane; 2,6′-diaminodiphenylmethane; 3,4′-diaminodiphenylmethane; 3,5′-diaminodiphenylmethane; 3,6′-diaminodiphenylmethane; 4,4′-diaminodiphenylmethane; 4,5′-diaminodiphenylmethane; 4,6′-diaminodiphenylmethane; 5,6′-diaminodiphenylmethane; 2,2′-dichloro-3,3′-diaminodiphenylmethane; 2,2′-dichloro-4,4′-diaminodiphenylmethane; 5,5′-dichloro-3,3′-diaminodiphenylmethane; 2,2′-dichloro-6,6′-diaminodiphenylmethane; 2,2′-dichloro-3,4′-diaminodiphenylmethane; 2,2′-dichloro-3,5′-diaminodiphenylmethane; 2,2′-dichloro-3,6′-diaminodiphenylmethane; 2,2′-dichloro-4,5′-diaminodiphenylmethane; 2,2′-dichloro-4,6′-diaminodiphenylmethane; 2,2′-dichloro-5,6′-diaminodiphenylmethane; 3,3′-dichloro-2,2′-diaminodiphenylmethane; 3,3′-dichloro-4,4′-diaminodiphenylmethane; 3,3′-dichloro-5,5′-diaminodiphenylmethane; 3,3′-dichloro-6,6′-diaminodiphenylmethane; 3,3′-dichloro-2,5′-diaminodiphenylmethane; 3,3′-dichloro-4,5′-diaminodiphenylmethane; 3,3′-dichloro-6,5′-diaminodiphenylmethane; 3,3′-dichloro-4,2′-diaminodiphenylmethane; 3,3′-dichloro-4,6′-diaminodiphenylmethane; 4,4′-dichloro-2,2′-diaminodiphenylmethane; 4,4′-dichloro-3,3′-diaminodiphenylmethane; 4,4′-dichloro-5,5′-diaminodiphenylmethane; 4,4′-dichloro-6,6′-diaminodiphenylmethane; 4,4′-dichloro-2,3′-diaminodiphenylmethane; 4,4′-dichloro-2,5′-diaminodiphenylmethane; 4,4′-dichloro-2,6′-diaminodiphenylmethane; 4,4′-dichloro-3,5′-diaminodiphenylmethane; 4,4′-dichloro-3,6′-diaminodiphenylmethane; 4,4′-dichloro-5,6′-diaminodiphenylmethane; 5,5′-dichloro-2,2′-diaminodiphenylmethane; 5,5′-dichloro-3,3′-diaminodiphenylmethane; 5,5′-dichloro-4,4′-diaminodiphenylmethane; 5,5′-dichloro-6,6′-diaminodiphenylmethane; 5,5′-dichloro-2,3′-diaminodiphenylmethane; 5,5′-dichloro-2,4′-diaminodiphenylmethane; 5,5′-dichloro-2,6′-diaminodiphenylmethane; 5,5′-dichloro-3,4′-diaminodiphenylmethane; 5,5′-dichloro-3,6′-diaminodiphenylmethane; 5,5′-dichloro-4,6′-diaminodiphenylmethane; 6,6′-dichloro-2,2′-diaminodiphenylmethane; 6,6′-dichloro-3,3′-diaminodiphenylmethane; 6,6′-dichloro-4,4′-diaminodiphenylmethane; 6,6′-dichloro-5,5′-diaminodiphenylmethane; 6,6′-dichloro-2,3′-diaminodiphenylmethane; 6,6′-dichloro-2,4′-diaminodiphenylmethane; 6,6′-dichloro-2,5′-diaminodiphenylmethane; 6,6′-dichloro-3,4′-diaminodiphenylmethane; 6,6′-dichloro-3,5′-diaminodiphenylmethane; 6,6′-dichloro-4,5′-diaminodiphenylmethane; 1,4-diaminobenzene; 1,2-diaminobenzene; 1,3-diaminobenzene; 2,2′-dimethoxy-3,3′-diamino biphenyl; 2,2′-dimethoxy-4,4′-diamino biphenyl; 5,5′-dimethoxy-3,3′-diamino biphenyl; 2,2′-dimethoxy-6,6′-diamino biphenyl; 2,2′-dimethoxy-3,4′-diamino biphenyl; 2,2′-dimethoxy-3,5′-diamino biphenyl; 2,2′-dimethoxy-3,6′-diamino biphenyl; 2,2′-dimethoxy-4,5′-diamino biphenyl; 2,2′-dimethoxy-4,6′-diamino biphenyl; 2,2′-dimethoxy-5,6′-diamino biphenyl; 3,3′-dimethoxy-2,2′-diamino biphenyl; 3,3′-dimethoxy-4,4-diamino biphenyl; 3,3′-dimethoxy-5,5′-diamino biphenyl; 3,3′-dimethoxy-6,6′-diamino biphenyl; 3,3′-dimethoxy-2,5′-diamino biphenyl; 3,3′-dimethoxy-4,5′-diamino biphenyl; 3,3′-dimethoxy-6,5′-diamino biphenyl; 3,3′-dimethoxy-4,2′-diamino biphenyl; 3,3′-dimethoxy-4,6′-diamino biphenyl; 4,4′-dimethoxy-2,2′-diamino biphenyl; 4,4′-dimethoxy-3,3′-diamino biphenyl; 4,4′-dimethoxy-5,5′-diamino biphenyl; 4,4′-dimethoxy-6,6′-diamino biphenyl; 4,4′-dimethoxy-2,3′-diamino biphenyl; 4,4′-dimethoxy-2,5′-diamino biphenyl; 4,4′-dimethoxy-2,6′-diamino biphenyl; 4,4′-dimethoxy-3,5′-diamino biphenyl; 4,4′-dimethoxy-3,6′-diamino biphenyl; 4,4′-dimethoxy-5,6′-diamino biphenyl; 5,5′-dimethoxy-2,2′-diamino biphenyl; 5,5′-dimethoxy-3,3′-diamino biphenyl; 5,5′-dimethoxy-4,4′-diamino biphenyl; 5,5′-dimethoxy-6,6′-diamino biphenyl; 5,5′-dimethoxy-2,3′-diamino biphenyl; 5,5′-dimethoxy-2,4′-diamino biphenyl; 5,5′-dimethoxy-2,6′-diamino biphenyl; 5,5′-dimethoxy-3,4′-diamino biphenyl; 5,5′-dimethoxy-3,6′-diamino biphenyl; 5,5′-dimethoxy-4,6′-diamino biphenyl; 6,6′-dimethoxy-2,2′-diamino biphenyl; 6,6′-dimethoxy-3,3′-diamino biphenyl; 6,6′-dimethoxy-4,4′-diamino biphenyl; 6,6′-dimethoxy-5,5′-diamino biphenyl; 6,6′-dimethoxy-2,3′-diamino biphenyl; 6,6′-dimethoxy-2,4′-diamino biphenyl; 6,6′-dimethoxy-2,5′-diamino biphenyl; 6,6′-dimethoxy-3,4′-diamino biphenyl; 6,6′-dimethoxy-3,5′-diamino biphenyl; 6,6′-dimethoxy-4,5′-diamino biphenyl; 2,2′-dimethyl-3,3′-diamino biphenyl; 2,2′-dimethyl-4,4′-diamino biphenyl; 5,5′-dimethyl-3,3′-diamino biphenyl; 2,2′-dimethyl-6,6′-diamino biphenyl; 2,2′-dimethyl-3,4′-diamino biphenyl; 2,2′-dimethyl-3,5′-diamino biphenyl; 2,2′-dimethyl-3,6′-diamino biphenyl; 2,2′-dimethyl-4,5′-diamino biphenyl; 2,2′-dimethyl-4,6′-diamino biphenyl; 2,2′-dimethyl-5,6′-diamino biphenyl; 3,3′-dimethyl-2,2′-diamino biphenyl; 3,3′-dimethyl-4,4-diamino biphenyl; 3,3′-dimethyl-5,5′-diamino biphenyl; 3,3′-dimethyl-6,6′-diamino biphenyl; 3,3′-dimethyl-2,5′-diamino biphenyl; 3,3′-dimethyl-4,5′-diamino biphenyl; 3,3′-dimethyl-6,5′-diamino biphenyl; 3,3′-dimethyl-4,2′-diamino biphenyl; 3,3′-dimethyl-4,6′-diamino biphenyl; 4,4′-dimethyl-2,2′-diamino biphenyl; 4,4′-dimethyl-3,3′-diamino biphenyl; 4,4′-dimethyl-5,5′-diamino biphenyl; 4,4′-dimethyl-6,6′-diamino biphenyl; 4,4′-dimethyl-2,3′-diamino biphenyl; 4,4′-dimethyl-2,5′-diamino biphenyl; 4,4′-dimethyl-2,6′-diamino biphenyl; 4,4′-dimethyl-3,5′-diamino biphenyl; 4,4′-dimethyl-3,6′-diamino biphenyl; 4,4′-dimethyl-5,6′-diamino biphenyl; 5,5′-dimethyl-2,2′-diamino biphenyl; 5,5′-dimethyl-3,3′-diamino biphenyl; 5,5′-dimethyl-4,4′-diamino biphenyl; 5,5′-dimethyl-6,6′-diamino biphenyl; 5,5′-dimethyl-2,3′-diamino biphenyl; 5,5′-dimethyl-2,4′-diamino biphenyl; 5,5′-dimethyl-2,6′-diamino biphenyl; 5,5′-dimethyl-3,4′-diamino biphenyl; 5,5′-dimethyl-3,6′-diamino biphenyl; 5,5′-dimethyl-4,6′-diamino biphenyl; 6,6′-dimethyl-2,2′-diamino biphenyl; 6,6′-dimethyl-3,3′-diamino biphenyl; 6,6′-dimethyl-4,4′-diamino biphenyl; 6,6′-dimethyl-5,5′-diamino biphenyl; 6,6′-dimethyl-2,3′-diamino biphenyl; 6,6′-dimethyl-2,4′-diamino biphenyl; 6,6′-dimethyl-2,5′-diamino biphenyl; 6,6′-dimethyl-3,4′-diamino biphenyl; 6,6′-dimethyl-3,5′-diamino biphenyl; 6,6′-dimethyl-4,5′-diamino biphenyl; 2,2′-diamino biphenyl; 2,3′-diamino biphenyl; 2,4′-diamino biphenyl; 2,5′-diamino biphenyl; 2,6′-diamino biphenyl; 3,4′-diamino biphenyl; 3,5′-diamino biphenyl; 3,6′-diamino biphenyl; 4,4′-diamino biphenyl; 4,5′-diamino biphenyl; 4,6′-diamino biphenyl; 5,6′-diamino biphenyl; 2,2′-dichloro-3,3′-diamino biphenyl; 2,2′-dichloro-4,4′-diamino biphenyl; 5,5′-dichloro-3,3′-diamino biphenyl; 2,2′-dichloro-6,6′-diamino biphenyl; 2,2′-dichloro-3,4′-diamino biphenyl; 2,2′-dichloro-3,5′-diamino biphenyl; 2,2′-dichloro-3,6′-diamino biphenyl; 2,2′-dichloro-4,5′-diamino biphenyl; 2,2′-dichloro-4,6′-diamino biphenyl; 2,2′-dichloro-5,6′-diamino biphenyl; 3,3′-dichloro-2,2′-diamino biphenyl; 3,3′-dichloro-4,4′-diamino biphenyl; 3,3′-dichloro-5,5′-diamino biphenyl; 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl; 4,4′-dichloro-2,2′-diamino biphenyl; 4,4′-dichloro-3,3′-diamino biphenyl; 4,4′-dichloro-5,5′-diamino biphenyl; 4,4′-dichloro-6,6′-diamino biphenyl; 4,4′-dichloro-2,3′-diamino biphenyl; 4,4′-dichloro-2,5′-diamino biphenyl; 4,4′-dichloro-2,6′-diamino biphenyl; 4,4′-dichloro-3,5′-diamino biphenyl; 4,4′-dichloro-3,6′-diamino biphenyl; 4,4′-dichloro-5,6′-diamino biphenyl; 5,5′-dichloro-2,2′-diamino biphenyl; 5,5′-dichloro-3,3′-diamino biphenyl; 5,5′-dichloro-4,4′-diamino biphenyl; 5,5′-dichloro-6,6′-diamino biphenyl; 5,5′-dichloro-2,3′-diamino biphenyl; 5,5′-dichloro-2,4′-diamino biphenyl; 5,5′-dichloro-2,6′-diamino biphenyl; 5,5′-dichloro-3,4′-diamino biphenyl; 5,5′-dichloro-3,6′-diamino biphenyl; 5,5′-dichloro-4,6′-diamino biphenyl; 6,6′-dichloro-2,2′-diamino biphenyl; 6,6′-dichloro-3,3′-diamino biphenyl; 6,6′-dichloro-4,4′-diamino biphenyl; 6,6′-dichloro-5,5′-diamino biphenyl; 6,6′-dichloro-2,3′-diamino biphenyl; 6,6′-dichloro-2,4′-diamino biphenyl; 6,6′-dichloro-2,5′-diamino biphenyl; 6,6′-dichloro-3,4′-diamino biphenyl; 6,6′-dichloro-3,5′-diamino biphenyl; 6,6′-dichloro-4,5′-diamino biphenyl; or a mixture thereof; or (viii) a combination thereof.

In any aspect or embodiment described herein, (i) the one or more additional polyol includes or is at least one of N-butanol; ethylene glycol; 1,2-propanediol; 1,3-butanediol; 1,4-butanediol; 2,3-butanediol; 1,5-pentanediol; 1,6-hexanediol; neopentyl glycol; 1,4-dihydroxycyclohexane; 1,4-dimethylolcyclohexane; 1,8-octanediol; 1,10-decanediol; 1,12-dodecanediol; 1,4-cyclohexanediol; 1,4-cyclohexanedimethanol; N-substituted ethanolamine; glycerol; trimethylolpropane; trimethylolethane; pentaerythritol; or a combination thereof; (ii) the one or more isocyanate is at least one of 4,4′-diphenylmethane diisocyanate, isophorone diisocyanate, 1,6-hexamethylene diisocyanate, toluene-2,4-diisocyanate, 1,5-naphthylene diisocyanate, 4,4′-dicyclohexylmethane diisocyanate, or a mixture thereof; (iii) the one or more chain extender includes or is at least one of diethylene triamine (DETA), ethylene diamine (EDA), meta-xylylenediamine (MXDA), aminoethyl ethanolamine (AEEA), 2-methyl pentane diamine, propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, hydrazine, substituted hydrazine, hydrazine reaction products, or a combination thereof; or (iv) a combination thereof.

In any aspect or embodiment described herein, at least one of: (i) the one or more additional polyol includes or is at least one of trimethylolpropane (TMP), glycerin, or a mixture thereof; (ii) the one or more isocyanate includes or is at least one of 4,4′-diisocyanate dicyclohexylmethane, isophorone diisocyanate, or a combination thereof; (iii) the one or more catalyst includes or is an organobismuth in at least one of a carboxylic acid, dibutyltin dilaurate, dibutyltin dioctanoate, or a combination thereof; (iv) the one or more cosolvent includes or is at least one of 1-butylpyrrolidin-2-one, dipropylene glycol dimethyl ether, or a combination thereof; (v) the one or more internal emulsifier includes or is at least one of dimethylol propionic acid (DMPA), dimethylethanolamine (DMEA), or a combination thereof); (vi) the one or more counterion or neutralizer includes or is at least one of triethylamine (TEA), dimethylethanolamine (DMEA), or a combination thereof; (vii) water sufficient for the mixture to have a total solids content of about 30% to about 50% (e.g., about 30% to about 45%, about 30% to about 40%, about 35% to about 50%, about 35% to about 45%, about 40% to about 50%, about 24.5% to about 47.5%, or about 45%); (viii) the one or more defoamer includes or is at least one of 2-methyl-3-isothiazolone, decamethylcyclopentasiloxane, octamethylcyclotetrasiloxane, or a combination thereof; (ix) the one or more chain extender includes or is at least one of water, hydrazine, hydrazine hydrate, adipic dihydrazide, aminoethyl ethanolamine (AEEA), ethylene diamine (EDA), or a combination thereof; or (x) a combination thereof.

In any aspect or embodiment described herein, the isocyanate comprises, consists essentially of, or consists of, dimethylmethane-4,4′-diisocyanate (MDI).

In any aspect or embodiment described herein, at least one of: (i) a viscosity of less than or equal to about 50 centipoise (cps) (e.g., less than or equal to about 30 cps); (ii) a total solids content of less than or equal to 40% (e.g., less than or equal to about 35%); (iii) a softening point of about 140° C. to about 210° C. (e.g., about 170° C. to about 210° C. or about 180° C. to about 210° C.); (iv) a tensile strength of about 4000 pounds per square inch (psi) to about 6500 psi (e.g., about 4500 psi to about 6000 psi or about 5000 psi to about 5500 psi); (v) an elongation percent of about 10% to about 40% (e.g., about 10% to about 35% or about 10% to about 30%); or (vi) a combination thereof.

### Methods of Using the Prepolymer Composition, Polyurethane Dispersion, or Waterborne Polyurethane of the Present Disclosure

An further aspect of the present disclosure relates to a film or coating comprising, or produced from, of one or more (e.g., 1, 2, 3, 4,5 or more) the prepolymer composition, polyurethane dispersion, or waterborne polyurethane, of the present disclosure, or one or more (e.g., 1, 2, 3, 4,5 or more) prepolymer composition, polyurethane dispersion, or waterborne polyurethane, produced by the method of the present disclosure.

Another aspect of the present disclosure relates to an article comprising the film or coating of the present disclosure.

### EXAMPLES

The details of the examples are contemplated as further embodiments of the described methods and compositions. Therefore, the details as set forth herein are hereby incorporated into the detailed description as alternative embodiments. It was surprising and unexpected discovered that the caprolactone polyols of the present disclosure provides polyurethane dispersions or waterborne polyurethanes that form films or coatings with improved mechanical properties and chemical resistance, as compared to standard, commercially available polyols.

Hydroxyl Value. Hydroxyl value was determined via American Society for Testing and Materials (ASTM) E222-23 (2023)—Standard Test Methods for Hydroxyl Groups Using Acetic Anhydride Acetylation. Briefly, the material examined was reacted with acetic anhydride and then acidified with water to provide an acidic mixture. The acidic mixture was then back titrated with KOH to provide the hydroxyl value in mgKOH/g.

Acid Number. Acid number was determined by dissolving the test sample in acetone or industrial methylated spirits (IMS), and then titrated against KOH to provide the acid number in mgKOH/g.

### Example 1. Polyol Synthesis

The 2000 MW polyol (Polyol Example 1 and Polyol Example 3) and 1000 MW polyols (Polyol Example 2 and Polyol Example 4) were synthesised via a one pot method, ring opening polymerization. For the 2000 MW polyol (Polyol Example 1 and Polyol Example 3), 84.8 wt % caprolactone monomers was mixed with 15.2 wt % pentaspiroglycol (PSG; Perstorp Holding AB, Malmö, Sweden) was used as the initiator and reacted to give a resulting polymer of 2000 MW with a hydroxyl value of 54-58 mgKOH/g. For the 1000 MW polyol (Polyol Example 2 and Polyol Example 4), 69.6 wt % caprolactone monomers was mixed with 30.4 wt % pentaspiroglycol (PSG; Perstorp Holding AB, Malmö, Sweden) as the initiator and reacted to give a resulting polymer of 1000 MW with a hydroxyl value of 108-116 mgKOH/g. For both the 1000 MW polyols (Polyol Example 2 and Polyol Example 4) and 2000 MW polyol (Polyol Example 1 and Polyol Example 3), the material was heated and held under vacuum at temperatures <100° C. to remove excess water.

Next, a stannous octanoate catalyst (DABCO® T-9 Catalyst; EVONIK CORPORATION, Parsippany, New Jersey) was added at 160° C. and then the reaction mixture was heated to 180° C. and incubated until the residual caprolactone monomer was <0.5%, as determined by gas chromatography. Monomeric carbodiimide (BASF, Ludwigshafen, Germany), an acid scavenger, was added to the resulting polymers to give a resulting acid number of <0.05 mgKOH/g.

### Example 2. Polymer Synthesis and Testing of Waterborne Polyurethane Materials

Example 2 examines the performance and processing advantages of waterborne polyurethane synthesis associated with the use of Polyol Example 1.

Waterborne Polyurethane Formulations and Synthesis. The formulations and processing parameters of Waterborne Polyurethane 1 (Polyol Example 1, 2000 MW), Comparative Waterborne Polyurethane 1 (RAVECARB 106, 2000 MW hexanediol initiated polycarbonate diol) and Comparative Waterborne Polyurethane 2 (CAPA® 2201, 2000 MW polycaprolactone diol initiated with neopentyl glycol) are shown in Table 1.

TABLE 1
Anionic Waterborne Polyurethanes Formulations - H12MDI/Test
Polyol/DMPA Hydrazine extended with DMEA Neutralization

| | | Comparative | Comparative |
|---|---|---|---|
| | Waterborne | Waterborne | Waterborne |
| | Polyure- | Polyure- | Polyure- |
| | thane 1 | thane 1 | thane 2 |
| | (% by | (% by | (% by |
| | weight) | weight) | weight) |
| VESTANAT ® | 12.89 | 13.156 | 13.103 |
| H12MDI (EVONIK | | | |
| CORPORATION, | | | |
| Parsippany, New | | | |
| Jersey) | | | |
| Polyol Example 1 | 20.406 | | |
| (2000 MW) | | | |
| RAVECARB 106 | | 20.084 | |
| (Caffaro Industrie, | | | |
| S.p.A, Torviscosa, | | | |
| Italy) | | | |
| CAPA ® 2201 (Ingevity | | | 20.149 |
| UK Ltd, Warrington, | | | |
| United Kingdom) | | | |
| Dimethylolpropionic | 1.979 | 2.019 | 2.011 |
| Acid (DMPA) | | | |
| TAMISOLVE ™ NxG | 3.920 | 3.919 | 3.919 |
| (Eastman Chemical | | | |
| Company, Kingsport, | | | |
| Tennessee) | | | |
| COSCAT ™ 83 | 0.007 | 0.007 | 0.007 |
| Catalyst (Vertellus | | | |
| Performance | | | |
| Materials Inc., | | | |
| Zeeland, Michigan) | | | |
| TAMISOLVE ™ NxG; | — | 2.305 | — |
| (Eastman Chemical | | | |
| Company, Kingsport, | | | |
| Tennessee) | | | |
| Dimethylethanolamine | 1.382 | 1.410 | 1.405 |
| (DMEA) | | | |
| Water | 52.113 | 49.774 | 52.051 |
| 35% Hydrazine | 2.022 | 2.063 | 2.055 |
| Hydrate | | | |
| Defoamer - DEE FO ® | 0.019 | 0.019 | 0.019 |
| PI-40 (Munzing - | | | |
| Ultra Additives LLC, | | | |
| Bloomfield, New | | | |
| Jersey) | | | |
| Water (to 36%) | 5.263 | 5.243 | 5.282 |
| Theoretical Solids % | 36.00 | 36.00 | 36.00 |
| Lb/gallon @25 C. | 8.763 | 8.799 | 8.738 |
| Reasonably Available | 1.212 | 1.657 | 1.207 |
| Control Technology | | | |
| (RACT) for Volatile | | | |
| Organic Compounds | | | |
| (VOC) (lb/gal) | | | |
| Reasonably Available | 145.3 | 198.6 | 144.7 |
| Control Technology | | | |
| (RACT) for Volatile | | | |
| Organic Compounds | | | |
| (VOC) g/l | | | |

H12MDI and the listed polyol were mixed and heated to 85° C. CosCat™ 83 Catalyst was added with mixing, with each mixture having an exotherm—118° C. at 5 minutes for Waterborne Polyurethane 1, 127° C. at 3 minutes for Comparative Waterborne Polyurethane 1, 116° C. at 5 minutes for Comparative Waterborne Polyurethane 2. Next, NCO % was examined after peak exotherm to be 9.56% (theory 9.92%), 9.73% (theory 10.14%), and 9.94% (theory 10.09%), respectively. TamiSolve™ NxG was then added and the mixture was cooled to 90-95° C. Dimethylolpropionic Acid (DMPA) was added to the mixture and the temperature maintained at 90-95° C. for 67 minutes, 90 minutes, and 67 minutes, respectively, to achieve NCO percent of 5.11% (theory 5.27%), 4.72% (theory 5.08%), and 5.34% (theory 5.35%). The prepolymer viscosity of the mixture for Waterborne Polyurethane 1 and Comparative Waterborne Polyurethane 2 at 90° C. was 3,000 cps. TamiSolve™ NxG was added to Comparative Waterborne Polyurethane 1 to reduce the viscosity to 90% prepolymer solids (13,500 cps) and 85% prepolymer solids (11.500 cps). The mixture was cooled to 82-87° C. under dry nitrogen and viscosity determined—7,000 cps at 83° C. for the prepolymer of Waterborne Polyurethane 1, 12,000 cps at 87° C. for the prepolymer of Comparative Waterborne Polyurethane 1, and 4,500 cps at 87° C. for the prepolymer of Comparative Waterborne Polyurethane 2.

Water at a temperature of 26-27° C. was added to the prepolymer of Waterborne Polyurethane 1 at 87° C. (6,500 cps), Comparative Waterborne Polyurethane 1 at 85° C. (12,000 cps), and prepolymer of Comparative Waterborne Polyurethane 2 at 87° C. (4,500 cps) to achieve 38% solids, as well as the dimethylethanolamine (DMEA) and DEE FO® PI-40, and the temperature to 25-28° C. An easy dispersion was achieved for each prepolymer with semi-translucent, translucent, and translucent appearances, respectively, and normal feed rates observed. The mixture was mixed for 10-15 minutes and the mixtures examined-viscosity of 360 cps at 29.7° C., pH 8.60 and semi-translucent; viscosity of 110 cps at 34.4° C., pH 8.52 and semi-translucent; and viscosity of 130 cps at 29.3° C., pH 8.45 and opaque/semi-translucent; respectively.

Hydrazine (35%) was added slowly with mixing. Resulting mixtures had viscosity of 800 cps at 31.4° C. and pH 8.59; viscosity of 1400 cps at 30.2° C. and pH 8.52; and viscosity of 550 cps ay 30.6° C. and pH 8.61. Next day, the mixtures had a viscosity of 3,000 cps at 25° C., pH 8.59, semi-translucent appearance, and a total solids content of 39.11%; a viscosity of 1,140 cps at 25° C., pH 8.52, semi-translucent appearance, and a total solids content of 38.86%; and a viscosity of 840 cps at 25° C., pH 8.60, opaque/semi-translucent appearance, and a total solids content of 39.16%; respectively. The mixtures were diluted with water to 36% total solids content to obtain the Waterborne Polyurethane 1 (viscosity of 300 cps at 25° C., pH 8.46, semi-translucent appearance, and 8.763 Lb/gal at 25° C.), Comparative Waterborne Polyurethane 1 (viscosity of 160 cps at 25° C., pH 8.66, semi-translucent appearance, and 8.799 Lb/gal at 25° C.), and Comparative Waterborne Polyurethane 2 (viscosity of 150 cps at 25° C., pH 8.60, opaque/semi-translucent appearance, and 8.738 Lg/gal at 25° C.).

Results. Three waterborne anionic waterborne polyurethane systems have been prepared using the Polyol Example 1 (2000 MW), hexanediol initiated polycarbonate (RAVECARB 106 (2000 MW)), and CAPA® 2201 (2000 MW polycaprolactone polyol diol initiated with neopentyl glycol); Ingevity UK Ltd, Warrington, United Kingdom) as the sole polyol in each respective system. Processing and resulting dispersion quality appears acceptable for further comparative testing of performance and physical film properties as initially outlined. The polyurethane backbone utilized is a very basic anionic waterborne stoichiometry with equivalent weight ratios of 2.00/0.40/0.60 4,4′-diisocyanato dicyclohexylmethane (H12MDI)/Test Polyol/dimethylolpropionic acid (DMPA), dispersed in water using dimethylethanolamine (DMEA) neutralizing amine and chain extended with hydrazine.

Discussion. The pentaspiroglycol (PSG) polyol identified as Polyol Example 1 (2000 MW) has excellent processing capabilities when used as the sole polyol in conjunction with common DMPA anionic dispersible linkage in a standard dicyclic aliphatic waterborne polyurethane product.

Polyol Example 1 (2000 MW) appears to process in anionic waterborne polyurethane synthesis in a very similar manner to normal caprolactone polyester products. The polyol yields good dispersion characteristics when used in a standard waterborne polyurethane formulation in conjunction with a dicyclic aliphatic polyisocyanate and normal anionic component ingredients. Polyol Example 1 (2000 MW) appears to offer the same benefits of standard CAPA® products in processing, such as reduced/low resulting prepolymer viscosities, smooth, steady cook cycles, clean reaction with isocyanate to expected reaction levels, and easy dispersion into water. Despite the unique composition, the polyol appears to yield excellent compatibility with dicyclic polyisocyanate and DMPA. Based upon the excellent processing results obtain, Polyol Example 1 (2000 MW) is expected to have excellent compatibility with mono-cyclic polyisocyanate, aromatic polyisocyanates, and TMXDI aromatic/aliphatic polyisocyanate.

### Example 3. Evaluation of Pentaspiroglycol (PSG) Polyols in Waterborne Polyurethane

Example 3 further examines the performance and processing advantages of waterborne polyurethane synthesis associated with the use of Polyol Example 1.

Waterborne Polyurethane Formulations and Synthesis. The formulations, processing parameters, and characteristics of Waterborne Polyurethane 2 (Polyol Example 1, 2000 MW), Comparative Waterborne Polyurethane 3 (RAVECARB 106, 2000 MW hexanediol initiated polycarbonate diol), and Comparative Waterborne Polyurethane 4 (CAPA® 2201, 2000 MW polycaprolactone diol initiated with neopentyl glycol) are shown in Table 2.

TABLE 2
Waterborne polyurethane formulations of Example 3

| | | | Compar- | Compar- |
|---|---|---|---|---|
| | Equiv- | | ative | ative |
| | alent | Water- | Water- | Water- |
| | Weight | borne | borne | borne |
| | (Equiv- | Polyure- | Polyure- | Polyure- |
| | alent) | thane 2 | thane 3 | thane 4 |
| H12MDI | 131.15 | 262.30 | 262.30 | 262.30 |
| (DESMODUR ® W, | (2.00) | | | |
| Cavestro AG, | | | | |
| Leverkusen, | | | | |
| Germany) | | | | |
| Polyol Example 1 | 1038.04 | 415.22 | | |
| | (0.40) | | | |
| RAVECARB 106 | 1001.07 | | 400.43 | |
| (Caffaro Industrie, | (0.40) | | | |
| S.p.A, Torviscosa, | | | | |
| Italy) | | | | |
| CAPA ® 2201 | 1008.41 | | | 403.36 |
| (Ingevity UK | (0.40) | | | |
| Ltd, Warrington, | | | | |
| United Kingdom) | | | | |
| Dimethylolpropionic | 67.10 | 40.26 | 40.26 | 40.26 |
| acid (DMPA) | (0.60) | | | |
| 35% Hydrazine | 16.00 | 14.40 | 14.40 | 14.40 |
| | (0.90) | | | |
| CosCat ™ 83 Catalyst | 200 ppm on | 0.14 | 0.14 | 0.14 |
| (Vertellus | Prepolymer | | | |
| Performance | reactants | | | |
| Materials Inc., | | | | |
| Zeeland, Michigan) | | | | |
| TamiSolve ™ NxG | To 90% | 79.77 | *124.09 | 78.45 |
| (Eastman Chemical | Prepolymer | | | |
| | solids | | | |
| Company, Kingsport, | *To 85% | | | |
| Tennessee) | Prepolymer | | | |
| | solids | | | |
| Dimethylethanolamine | 1.0 equiv. on | 28.12 | 28.12 | 28.12 |
| (DMEA) | DMPA | | | |
| Water | To 35% | 1194.25 | 1123.65 | 1174.49 |
| | Dispersion | | | |
| | solids | | | |
| Defoamer - DEE | 0.02% per | 0.35 | 0.35 | 0.35 |
| FO ® PI-40 | batch weight | | | |
| (Munzing - Ultra | | | | |
| Additives LLC, | | | | |
| Bloomfield, New | | | | |
| Jersey) | | | | |

| | | | |
|---|---|---|---|
| Total Batch Weight | 1757.494 | 1757.484 | 1834.873 |
| Total Solids Content (TSC) % | 36.00 | 36.00 | 36.00 |
| pH | 8.46 | 8.66 | 8.60 |
| Viscosity | | | |
| Appearance | | | |
| Wgt/Gal | | | |
| % Volatile Organic Content (VOC) | | | |
| VOC lb/gal (RACT) | | | |
| VOC g/l (RACT) | | | |
| Room Temperature Coalescence- 10 | Pass | Pass | Pass |
| wet mil films air dried on Lanetta | | | |
| Gloss Cards | | | |
| Flow Out (as produced) | | | |
| 6 wet mil film applied direct to | Good | Good | Good |
| Lanetta Cards. Air Dried | Flow | Flow | Flow |
| 6 Wet Mil Film applied over air | Good | Good | Good |
| dried film | Flow | Flow | Flow |

H12MDI and the listed polyol were mixed and heated to 85° C. CosCat™ 83 Catalyst was added with mixing, with each mixture having an exotherm. TamiSolve™ NxG was then added and the mixture was cooled to 90-95° C. Dimethylolpropionic Acid (DMPA) was added to the mixture and the temperature maintained at 90-95° C. for 67 minutes, 90 minutes, and 67 minutes, respectively. TamiSolve™ NxG was added to the prepolymer mixtures for Waterborne Polyurethane 2, Comparative Waterborne Polyurethane 3, and Comparative Waterborne Polyurethane 4 to achieve 90% prepolymer solids, 85% prepolymer solids, and 90% prepolymer solids, respectively. The mixture was cooled to 82-87° C. under dry nitrogen.

Water at a temperature of 26-27° C. was added to the prepolymer for Waterborne Polyurethane 2, the prepolymer for Comparative Waterborne Polyurethane 3, and the prepolymer for Comparative Waterborne Polyurethane 4 to achieve 38% solids, as well as the dimethylethanolamine (DMEA) and DEE FO® PI-40, and the temperature brought to 25-28° C. and mixed for 10-15 minutes.

Hydrazine (35%) was added slowly with mixing. The next day, the mixtures were diluted with to 35% total solids content to obtain the Waterborne Polyurethane 3, and Comparative Waterborne Polyurethane 4.

Results. Waterborne Polyol Example 1 (2000 MW) processed extremely well and in a very similar manner to standard CAPA® 2201 (2000 MW polycaprolactone diol initiated with neopentyl glycol) of equivalent weight and functionality when used in synthesis of anionic waterborne polyurethane products.

Compared to RAVECARB 106 (2000 MW hexanediol initiated polycarbonate diol), Polyol Example 1 (2000 MW) demonstrated easier handling characteristics and characteristically lower prepolymer viscosities that are generally associated with standard CAPA® polyols.

No significant performance differences were observed for these dry film characteristics between Comparative Waterborne Polyurethane 4 (CAPA® 2201, 2000 MW polycaprolactone diol initiated with neopentyl glycol) and the equivalent Waterborne Polyurethane 2 (Polyol Example 1, 2000 MW). In particular, similar dry film performance characteristics (film hardness, hardness development, most adhesion characteristics, resulting film gloss and impact resistance properties) were observed for Waterborne Polyurethane 2 (Polyol Example 1, 2000 MW) and Comparative Waterborne Polyurethane 4 (CAPA® 2201, 2000 MW polycaprolactone diol initiated with neopentyl glycol).

Comparative to Comparative Waterborne Polyurethane 3 (RAVECARB 106, 2000 MW hexanediol initiated polycarbonate diol), Waterborne Polyurethane 2 (Polyol Example 1, 2000 MW) yielded a significantly lower final film hardness resulting in less inherent scratch resistance, significantly lower cosolvent demand for coalescence, and lower cosolvent demand for prepolymer processing. These are equivalent properties to what is observed with the Comparative Waterborne Polyurethane 4 (CAPA® 2201, 2000 MW polycaprolactone diol initiated with neopentyl glycol).

However, the data does demonstrate that Waterborne Polyurethane 2 (Polyol Example 1, 2000 MW) yielded an improvement in resistance properties to dilute alcohols and ketone. For this evaluation of the comparative waterborne polyurethanes tested, the improvement in chemical resistance appears to be inherent in the polyol structure.

Based upon initial comparative observations Waterborne Polyurethane 2 (Polyol Example 1, 2000 MW) provides improved hydrolysis resistance compared to Comparative Waterborne Polyurethane 4 (CAPA® 2201, 2000 MW polycaprolactone diol initiated with neopentyl glycol) and a lower level of hydrolysis resistance compared to Comparative Waterborne Polyurethane 3 (RAVECARB 106, 2000 MW hexanediol initiated polycarbonate diol). on the improved hydrolysis resistance is based on the film blush observed in the films exposed to hydrolysis at 40° C./100% relative humidity (RH). The Comparative Waterborne Polyurethane 3 (RAVECARB 106, 2000 MW hexanediol initiated polycarbonate diol) film demonstrated zero blush after exposure. Waterborne Polyurethane 2 (Polyol Example 1, 2000 MW) demonstrated mild blush after exposure and the Comparative Waterborne Polyurethane 4 (CAPA® 2201, 2000 MW polycaprolactone diol initiated with neopentyl glycol) demonstrated strong blush after exposure. All three waterborne polyurethanes examined recovered for clear films upon drying and showed little signs of significant breakdown when re-dried for testing.

Table 3 shows König Hardness, examined via American Society for Testing and Materials (ASTM) D4366—Standard Test Methods for Hardness of Organic Coatings by Pendulum Damping Tests and/or International Organization for Standardization (ISO) 1522:2006 or 1522:2022-Paints and Varnishes Pendulum Damping Test, and Pencil Hardness, examined via American Society for Testing and Materials (ASTM) D3362-22—Standard Test Method for Film Hardness by Pencil Test, results for Waterborne Polyurethane 2 (Polyol Example 1, 2000 MW), Comparative Waterborne Polyurethane 3 (RAVECARB 106, 2000 MW hexanediol initiated polycarbonate diol), and Comparative Waterborne Polyurethane 4 (CAPA® 2201, 2000 MW polycaprolactone diol initiated with neopentyl glycol). Briefly, three coats #40 rod were applied to the Q-panels and examined via a BYK-Gardner Pendulum Hardness Tester (BYK-Gardner; Los Angeles, California). The Q-Panels were air dried for 8 hours between each coat. Each waterborne polyurethane tested was run in duplicate. The Pendulum Hardness Tester was calibrated to 251 seconds (specification 250+/−10 seconds). Testing was performed direct and reverse on each Q-Panel every 24 hours of air dry ambient conditions of 50% relative humidity (RH) at 20° C. for 7 days followed by a final heat cycle at 150° C. for 3 minutes, and allowed to cool down to room temperature.

For Pencil Hardness, a Gardco Pencil Hardness Tester (BYK-Gardner; Los Angeles, California) with stylist of 174 grams was used. Only surface scratch readings were recorded.

König Hardness and Pencil Hardness were rechecked with two coats with a #52 rod applied to steel Q-Panels. Briefly, the first coat was air dried for 30 minutes and the second coat was oven dried at 77° C. for 15 minutes. These results are also shown in Table 3.

König Hardness and Pencil Hardness of oven dried (150° C./5 minutes) Q-Panels were re-checked.

TABLE 3
König Hardness and Pencil Hardness results for Waterborne
Polyurethane 2, Comparative Waterborne Polyurethane 3,
and Comparative Waterborne Polyurethane 4

| | | | | Comparative | | Comparative | |
|---|---|---|---|---|---|---|---|
| | | Waterborne | | Waterborne | | Waterborne | |
| | | Polyurethane 2 | | Polyurethane 3 | | Polyurethane 4 | |
| | | Direct | Reverse | Direct | Reverse | Direct | Reverse |
| 1 Day | König | 52 | 55 | 52 | 50 | 56 | 56 |
| | Average | 53.5 | | 51 | | 56 | |
| | Pencil | 3-4B | | H-2H | | 2B | |
| 2 Day | König | 67 | 67 | 68 | 68 | 68 | 64 |
| | Average | 67 | | 68 | | 66 | |
| | Pencil | B | | 4H | | HB | |
| 3 Day | König | 76 | 79 | 83 | 86 | 80 | 79 |
| | Average | 77.5 | | 84.5 | | 79.5 | |
| | Pencil | H | | 4H | | HB-H | |
| 4 Day | König | 84 | 82 | 92 | 92 | 88 | 84 |
| | Average | 83 | | 92 | | 86 | |
| | Pencil | H | | 4H | | H | |
| 5 Day | König | 92 | 92 | 98 | 99 | 94 | 95 |
| | Average | 92 | | 98.5 | | 94.5 | |
| | Pencil | 2H | | 5H | | 2H | |
| Oven | König | 64 | 64 | 93 | 92 | 62 | 91 |
| Dry | | | | | | | |
| 150° C. | | | | | | | |
| for 3 | | | | | | | |
| minutes | | | | | | | |
| | Average | 64 | | 92.5 | | 61.5 | |
| | Pencil | 5H | | 3H | | 4H | |
| Oven | König | 64 | 64 | 93 | 93 | 63 | 61 |
| Dry, 1 | | | | | | | |
| day | | | | | | | |
| aged | | | | | | | |
| | Average | 64 | | 93 | | 62 | |
| | Pencil | 5H | | 5H | | 5H | |
| Oven | König | 65 | 65 | 101 | 99 | 64 | 61 |
| Dry 2, | | | | | | | |
| day | | | | | | | |
| aged | | | | | | | |
| | Average | 65 | | 100.5 | | 62.5 | |
| | Pencil | 5H | | 5H | | 5H | |

Re-Check- König Hardness and Pencil Hardness

| | | | |
|---|---|---|---|
| König | 68.5 | 91 | 64.5 |
| Pencil | 2H | 2H | B |

Oven dry Re-Check panels 150° C./5 minutes

| | | | |
|---|---|---|---|
| König | 54 | 91 | 51 |
| Pencil | HB | 2H | 2B |

Table 4 shows Gardner Gloss, examined via American Society for Testing and Materials (ASTM) D523—Standard Test Method for Specular Gloss and/or International Organization for Standardization (ISO) 2813:2017—Paints and Varnishes Determination of Gloss Value at 20°, 60°, and 85°, results for Waterborne Polyurethane 2 (Polyol Example 1, 2000 MW), Comparative Waterborne Polyurethane 3 (RAVECARB 106, 2000 MW hexanediol initiated polycarbonate diol), and Comparative Waterborne Polyurethane 4 (CAPA® 2201, 2000 MW polycaprolactone diol initiated with neopentyl glycol). Briefly, 6 wet mils applied to Lanetta gloss cards were air dried 7 days at ambient temperature. Two coats #52 rod applied to steel Q-Panels were air dried for 30 minutes, oven dried 15 minutes at 77° C., followed by oven dry 5 minutes at 150° C. The test was performed with a Macbeth Novo-Gloss 60/20 Gloss Meter calibrated to ‘black’ standard for both 20 degree and 60 degree readings.

TABLE 4
Gardner Gloss results for Waterborne Polyurethane 2,
Comparative Waterborne Polyurethane 3, and
Comparative Waterborne Polyurethane 4

| | | | Comparative | | Comparative | |
|---|---|---|---|---|---|---|
| | Waterborne | | Waterborne | | Waterborne | |
| | Polyurethane 2 | | Polyurethane 3 | | Polyurethane 4 | |
| | Card | Q-panel | Card | Q-panel | Card | Q-panel |
| 60 Degree | 935. | 105 | 93.8 | 101 | 94.6 | 106 |
| 20 Degree | 70.4 | 69 | 71.2 | 66 | 75.9 | 76 |

Table 5 shows Impact Resistance, examined via American Society for Testing and Materials (ASTM) D5420-21—Standard Test Method for Impact Resistance of Flat, Rigid Plastic Specimen by Means of a Striker Impacted by a Falling Weight (Gardner Impact), results for Waterborne Polyurethane 2 (Polyol Example 1, 2000 MW), Comparative Waterborne Polyurethane 3 (RAVECARB 106, 2000 MW hexanediol initiated polycarbonate diol), and Comparative Waterborne Polyurethane 4 (CAPA® 2201, 2000 MW polycaprolactone diol initiated with neopentyl glycol). Briefly, direct and reverse on un-primed steel Q-Panels coated three coats #52 rod, air dried for 7 days, followed by oven dry 3 minutes at 150° C. Variable drop height to failure was performed at ambient temperature with a 1980 gram mass, 0.5 inch punch, 0.55 inch die. The highest force to pass is reported in inch-pounds (in-lb).

TABLE 5
Impact Resistance results for Waterborne Polyurethane
2, Comparative Waterborne Polyurethane 3, and
Comparative Waterborne Polyurethane 4

| | | Comparative | Comparative |
|---|---|---|---|
| | Waterborne | Waterborne | Waterborne |
| | Polyurethane 2 | Polyurethane 3 | Polyurethane 4 |
| Direct Impact | 726 | 704 | 836 |
| Reverse Impact | 506 | 176 | 594 |
| Deposition | 2.1 dry mil | 2.15 dry mil | 2.00 dry mil |

Table 6 shows Chemical Resistance results for Waterborne Polyurethane 2 (Polyol Example 1, 2000 MW), Comparative Waterborne Polyurethane 3 (RAVECARB 106, 2000 MW hexanediol initiated polycarbonate diol), and Comparative Waterborne Polyurethane 4 (CAPA® 2201, 2000 MW polycaprolactone diol initiated with neopentyl glycol), which was examined using the American Society for Testing and Materials (ASTM) C1378-20—Standard Test Method for Determination of Resistance to Staining). Briefly, two coats, each a 10 wet mill deposition, were applied to Lanetta gloss cards. Each coat was dried for 5 minutes at 60° C., followed by 3 minutes at 150° C. Each test chemical spot was applied for a duration of 1 hour at ambient temperature. Coatings were rated for “BLUSHING” and “SOFTENING” immediately upon removal of test chemicals and after 1 hour room temperature recovery time. The rating system is from 0 to 10 with 0=destruction and 10=no affect.

TABLE 6
Chemical Resistance results for Waterborne Polyurethane 2,
Comparative Waterborne Polyurethane 3, and
Comparative Waterborne Polyurethane 4

| | | Comparative | | Comparative | |
|---|---|---|---|---|---|
| Waterborne | | Waterborne | | Waterborne | |
| Polyurethane 2 | | Polyurethane 3 | | Polyurethane 4 | |
| Blush | Soften | Blush | Soften | Blush | Soften |

Intermediate Rating

| | | | | | | |
|---|---|---|---|---|---|---|
| Water | 10 | 10 | 10 | 10 | 10 | 10 |
| 99% | 10 | 5 | 10 | 5 | 10 | 0 |
| Isopropyl | | softens | | softens | | |
| Alcohol | | | | | | |
| Hot Coffee | 10 | 10 | 10 | 10 | 10 | 10 |
| Hot Tea | 10 | 10 | 10 | 10 | 10 | 10 |
| French's | 5 | 10 | 5 | 10 | 5 | 10 |
| Mustard | stain | | stain | | stain | |
| (McCormick | | | | | | |
| & Company, | | | | | | |
| Hun Valley, | | | | | | |
| Maryland) | | | | | | |
| Germ-X | 10 | 9 | 10 | 3 | 10 | 8 |
| Hand | | slight | | softens | | mark/ |
| Sanitizer | | soften | | | | ring |
| (Germ-X, | | | | | | |
| Saint Louis, | | | | | | |
| Missouri) | | | | | | |
| Lysol | 10 | 10 | 10 | 9 | 10 | 9 |
| Disinfectant | | | | slight | | slight |
| Spray | | | | mark | | mark |
| (Reckitt | | | | | | |
| Benckiser | | | | | | |
| LLC, | | | | | | |
| Parsippany, | | | | | | |
| New Jersey) | | | | | | |
| Chlorine | 8 | 5 | 10 | 8 | 10 | 8 |
| Bleach | slight | softens | | slight | | slight |
| | blush | | | soften | | soften |
| Vodka | 10 | 10 | 10 | 5 | 10 | 8 |
| | | | | softens/ | | softens/ |
| | | | | mark | | slight |
| | | | | | | mark |
| Methyl Ethyl | 10 | 3 | 10 | 0 | 10 | 0 |
| Ketone | | softens | | destroyed | | destroyed |
| (MEK) | | | | | | |
| 5% Ammonia | 5 | 3 | 5 | 3 | 5 | 3 |
| | blush | softens | blush | softens | blush | softens |
| Aviation | 0 | 5 | 5 | 5 | 0 | 5 |
| Hydraulic | stain | softens | slight | softens | stain | softens |
| Fluid | | | stain | | | |
| (SKYDROL ® | | | | | | |
| LD-4, | | | | | | |
| Eastman | | | | | | |
| Chemical | | | | | | |
| Company, | | | | | | |
| Kingsport, | | | | | | |
| Tennessee) | | | | | | |
| DEET (from | 10 | 2 | 10 | 0 | 10 | 0 |
| REPEL Bug | | softens | | destroyed | | destroyed |
| Spray) | | | | | | |

Recovered Rating

| | | | | | | |
|---|---|---|---|---|---|---|
| Water | 10 | 10 | 10 | 10 | 10 | 10 |
| 99% | 10 | 8 | 10 | 8 | 10 | 7 |
| Isopropyl | | | | | | |
| Alcohol | | | | | | |
| Hot Coffee | 10 | 10 | 10 | 10 | 10 | 10 |
| Hot Tea | 10 | 10 | 10 | 10 | 10 | 10 |
| French's | 5 | 10 | 8 | 10 | 5 | 10 |
| Mustard | stain | | stain | | stain | |
| (McCormick | | | | | | |
| & Company, | | | | | | |
| Hun Valley, | | | | | | |
| Maryland) | | | | | | |
| Germ-X | 10 | 10 | 10 | 3 | 10 | 9 |
| Hand | | | | soften | | slight |
| Sanitizer | | | | | | mark |
| (Germ-X, | | | | | | |
| Saint Louis, | | | | | | |
| Missouri) | | | | | | |
| Lysol | 10 | 10 | 10 | 9 | 10 | 10 |
| Disinfectant | | | | slight | | |
| Spray | | | | mark | | |
| (Reckitt | | | | | | |
| Benckiser | | | | | | |
| LLC, | | | | | | |
| Parsippany, | | | | | | |
| New Jersey) | | | | | | |
| Chlorine | 10 | 7 | 10 | 9 | 10 | 7 |
| Bleach | | slight | | slight | | slight |
| | | mark | | mark | | mark |
| Vodka | 10 | 10 | 10 | 6 | 10 | 8 |
| | | | | softens | | softens |
| Methyl Ethyl | 10 | 5 | 10 | 0 | 10 | 0 |
| Ketone | | softened | | destroyed | | destroyed |
| (MEK) | | | | | | |
| 5% Ammonia | 10 | 3 | 10 | 3 | 10 | 3 |
| | | mark | | mark | | mark |
| Aviation | 0 | 5 | 0 | 5 | 0 | 5 |
| Hydraulic | stain | softened | stain | softened | stain | softened |
| Fluid | | | | | | |
| (SKYDROL ® | | | | | | |
| LD-4, | | | | | | |
| Eastman | | | | | | |
| Chemical | | | | | | |
| Company, | | | | | | |
| Kingsport, | | | | | | |
| Tennessee) | | | | | | |
| DEET (from | 10 | 2 | 10 | 0 | 10 | 0 |
| REPEL Bug | | softened | | destroyed | | destroyed |
| Spray) | | | | | | |

Table 7 shows Adhesion Testing, examined via American Society for Testing and Materials (ASTM) D3359-23—Standard Test Methods for Rating Adhesion by Tape Test, results for Waterborne Polyurethane 2 (Polyol Example 1, 2000 MW), Comparative Waterborne Polyurethane 3 (RAVECARB 106, 2000 MW hexanediol initiated polycarbonate diol), and Comparative Waterborne Polyurethane 4 (CAPA® 2201, 2000 MW polycaprolactone diol initiated with neopentyl glycol). Briefly, unformulated coating was applied to various substrates and tested for crosshatch adhesion via 3M™ SCOTCH® Cellophane Film Tape 610 (St. Paul, Minnesota). Testing performed as 100 square hatch marks reported as % PASS or as a “Pass”/“Fail”. The results, and the associated deposition and curing conditions, are shown in Table 7.

TABLE 7
Adhesion Testing results for Waterborne Polyurethane 2, Comparative
Waterborne Polyurethane 3, and Comparative Waterborne Polyurethane 4

| | | Comparative | Comparative |
|---|---|---|---|
| | Waterborne | Waterborne | Waterborne |
| | Polyurethane 2 | Polyurethane 3 | Polyurethane 4 |
| Substrate | Deposition and Cure Conditions | | |
| Extruded | #22 rod applied direct and oven dried for 5 minutes at 80° C. | | |
| Polyester Film | | | |
| | Fail | Fail | Pass |
| Extruded | #22 rod applied direct and oven dried for 5 minutes at 80° C. | | |
| Polyether Film | | | |
| | Fail | Fail | Slight Edge Lift |
| Nylon (Heavy | 2 coats #34 rod applied direct and oven dried for 5 minutes | | |
| Denier) | at 80° C. after all coats | | |
| | Pass | Pass | Pass |
| Polyester Fabric | 2 coats #34 rod applied direct and oven dried for 5 minutes | | |
| (Heavy Denier) | at 80° C. after all coats | | |
| | Pass | Pass | Pass |
| Kevlar Fabric | 2 coats #34 rod applied direct and oven dried for 5 minutes | | |
| (Heavy Denier) | at 80° C. after all coats | | |
| | Pass | Pass | Pass |
| Q-Panel (Steel) | 3 coats #40 rod and air dried 7 days, followed by oven dried | | |
| | for 3 minutes at 150° C. | | |
| | 98% | 97% | 100% |
| Oak Wood | 2 brush coats were applied to 220 grit sanded oak wood and | | |
| | air dried 30 minutes between coats. First coat was tested to | | |
| | bare wood, and the second coat was tested as intercoat | | |
| | adhesion | | |
| To Bare Wood | 100% | 100% | 100% |
| Intercoat | 100% | 100% | 100% |
| Polished | #52 rod applied direct and oven dried for 5 minutes at 80° C. | | |
| Aluminum | | | |
| | 98% | 100% | 100% |
| Glass | 10 wet mils applied direct to acetone washed glass and oven | | |
| | dried 10 minutes at 80° C. | | |
| | 100% | 100% | 100% |
| MDI Polyurethane | 10 wet applied direct and oven dried for 10 minutes at 80° C. | | |
| Foam | | | |
| | Fail | Pass | Fail |
| PET Thin Film | #22 rod applied direct and oven dried for 5 minutes at 80° C. | | |
| (Untreated) | | | |
| | Fail | Fail | Fail |
| Metalized PET | #22 rod applied direct and oven dried for 5 minutes at 80° C. | | |
| Thin Film | | | |
| | Pass | Pass | Pass |
| Ridged Vinyl | 6 wet mils applied to IPA washed tile and oven dried for 10 | | |
| Floor Tile | minutes at 80° C. | | |
| | 100% | 100% | 100% |
| Ceramic Tile | 6 wet mils applied direct and oven dried for 10 minutes at | | |
| | 80° C. | | |
| | 53% | 68% | 28% |
| Ridged Extruded | 6 wet applied direct and oven dried for 10 minutes at 80° C. | | |
| Vinyl | | | |
| | 100% | 100% | 100% |
| Automotive ABS | #52 rod applied direct and oven dried for 5 minutes at 80° C. | | |
| Foam (without | | | |
| primer) | | | |
| | 100% | 100% | 82% |

| | Inventive | Comparative | Comparative |
|---|---|---|---|
| | Polyurethane 2 | Polyurethane 3 | Polyurethane 4 |
| Softening Point | 310-340° F. | 310-340° F. | 290-310° F. |
| (100 wet mil films | (154-171° C.) | (154-171° C.) | (143-154° C.) |
| over dried for 5 | | | |
| minutes at 150° C.) | | | |

Table 8 shows Ethanol Double Rubs results for Waterborne Polyurethane 2 (Polyol Example 1, 2000 MW), Comparative Waterborne Polyurethane 3 (RAVECARB 106, 2000 MW hexanediol initiated polycarbonate diol), and Comparative Waterborne Polyurethane 4 (CAPA® 2201, 2000 MW polycaprolactone diol initiated with neopentyl glycol), which was examined using the International Standard ISO 105-X12. Briefly, two coats #52 rod coated to steel Q-Panels. The first coat was air dry 30 minutes and the second coat was oven dried for 15 minutes at 77° C. The samples were redried for 5 minutes at 150° C. Denatured Ethanol Double Rubs was applied with an ethanol soaked cloth to film break through. Results are shown in Table 8.

TABLE 8
Ethanol Double Rubs results for Waterborne Polyurethane
2, Waterborne Comparative Waterborne Polyurethane
3, and Comparative Waterborne Polyurethane 4

| | | Comparative | Comparative |
|---|---|---|---|
| | Waterborne | Waterborne | Waterborne |
| | Polyurethane 2 | Polyurethane 3 | Polyurethane 4 |
| Dry Film | 1.5 mil | 1.5 mil | 1.5 mil |
| Thickness | | | |
| Ethanol Double | 176 | 249 | 56 |
| Rubs to | | | |
| Breakthrough | | | |

Discussion. Simplistic waterborne polyurethane systems were prepared in Example 3 for the purpose of direct comparison of inherent properties obtained from each of the chosen polyols—namely, Waterborne Polyurethane 2, Comparative Waterborne Polyurethane 3, and Comparative Waterborne Polyurethane 4. The evaluation appears to show Polyol Example 1 (2000 MW) enhanced specific properties as compared to the Comparative Waterborne Polyurethane 4 (CAPA® 2201, 2000 MW polycaprolactone diol initiated with neopentyl glycol). The enhancements include an improvement in resistance properties and an improvement in hydrolysis resistance properties. These results are particularly encouraging because of the simplistic nature of the systems prepared and the pentaspiroglycol instantiated caprolactone polymers provide enhancements to waterborne polyurethane formulations relative to the standard CAPA®. The enhancements are expected to be more pronounced when the pentaspiroglycol initiated polyol is used in the preparation of systems that are specifically tailored for specific end use properties. In most cases, waterborne polyurethane systems are purposely designed to meet the needs of specific end uses. Caprolactone polyols are generally used in applications where improved hydrolysis, high flexibility, medium to low modulus (soft hand), low cosolvent (or no cosolvent) is required, and good adhesion is necessary. The pentaspiroglycol initiated polyol would appear to meet these requirements and offer some improvements.

Based upon this evaluation the pentaspiroglycol initiated polyol of the preset disclosure appear to offer all the advantages of a standard CAPA® polyols, which include good hydrolysis resistance, excellent processability with clean, uniform cooks, low cosolvent demand for processing, low cosolvent demand for coalescence, good flexibility and impact resistance, ability to obtain low modulus to medium modulus films, good formulation flexibility (due to lower viscosities), and generally good universal adhesion.

In addition, the pentaspiroglycol initiated polyols of the present disclosure appear to offer the follow advantages over a standard CAPA® polyol: improved chemical resistance and improved hydrolysis resistance is expected.

When compared to an equivalent molecular weight polycarbonate polyol, the pentaspiroglycol initiated polyols of the present disclosure appear to yield significantly lower modulus films at equal stoichiometry, significantly lower film surface hardness, improved impact resistance (result of softer films), and improved resistance to dilute alcohols and ketones.

### Example 4. Evaluated Pentaspiroglycol Initiated (PSG) Polyols in Waterborne Polyurethane Manufacture in Polyurethane Dispersion Systems Utilizing Internal Crosslink and Comparative Chemical Resistance Properties

Example 4 incorporates internal crosslink mechanism(s) into the polyurethane dispersion backbone, and compares the chemical resistance between Polyol Example 2 (1000 MW) and a standard, CAPA® 2100 Polyol (1000 MW polycaprolactone diol initiated with neopentyl glycol).

Waterborne Polyurethane Formulations and Synthesis. The formulations, processing parameters, and characteristics of Waterborne Polyurethane 3 (Polyol Example 2, 1000 MW) and Comparative Waterborne Polyurethane 5 (CAPA® 2100 Polyol, 1000 MW polycaprolactone diol initiated with neopentyl glycol) are shown in Table 9.

TABLE 9
Formulations for Waterborne Polyurethane 3
and Comparative Waterborne Polyurethane 5

| | | | Comparative |
|---|---|---|---|
| | Equiv. Weight | Waterborne | Waterborne |
| | (Equiv.) | Polyurethane 3 | Polyurethane 5 |
| Isophorone | 111.2 | 200.16 | 200.16 |
| diisocyanate (IPDI) | (1.80) | | |
| Polyol Example 2 | 520.84 | 250.00 | |
| | (0.48) | | |
| CAPA ® 2100 | 500.89 | | 240.43 |
| (Ingevity UK Ltd, | (0.48) | | |
| Warrington, United | | | |
| Kingdom) | | | |
| Trimethylolpropane | 44.67 | 4.47 | 4.47 |
| (TMP) | (0.10) | | |
| Dimethylolpropionic | 67.10 | 28.28 | 28.28 |
| acid (DMPA) | (0.42) | | |
| Ethylenediamine | 30.00 | 10.80 | 10.80 |
| | (0.36) | | |
| Aminoethylethanol | 52.00 | 12.48 | 12.48 |
| amine | (0.24) | | |
| Adipic dihydrazide | 87.00 | 10.44 | 10.44 |
| | (0.12) | | |
| 37% Formalin | 81.08 | 4.86 | 4.86 |
| | (0.06) | | |
| DABCO ® T-12 | 200 ppm on Prepolymer | 0.097 | 0.095 |
| Catalyst (EVONIK | solids | | |
| CORPORATION, | | | |
| Parsippany, New | | | |
| Jersey) | | | |
| PROGLYDE ™ | To 85% Prepolymer | 85.22 | 83.53 |
| DMM (DOW ®, | solids | | |
| PROGLYDE ™ | | | |
| DMM (DOW ®, | | | |
| Midland, | | | |
| Michigan)) | | | |
| Triethylamine | 1.0 equiv. on DMPA | 21.35 | 21.35 |
| Neutralizer | | | |
| Water | To 30% Dispersion solids | 1100.26 | 1078.33 |
| Defoamer - DEE | 0.02% per batch weight | 0.34 | 0.34 |
| FO ® PI-40 | | | |
| (Munzing - Ultra | | | |
| Additives LLC, | | | |
| Bloomfield, New | | | |
| Jersey) | | | |

| | | |
|---|---|---|
| Total Batch Weight | 1728.757 | 1695.565 |
| Total Solids Content (TSC) % | 30.00 | 30.00 |
| pH | 7.82 | 8.28 |
| Viscosity | 50 centipoise (cps) | >7,000 cps |
| Appearance | Clear/Semi-Trans | Clear/Semi-trans |
| Room Temperature Coalescence- 10 wet mil | Pass | Pass |
| films air dried on Lanetta Gloss Cards | | |
| Flow Out (as produced) | | |
| 6 wet mil film applied direct to Lanetta | Good Flow | Good Flow |
| Cards and air dried | | |
| 6 wet mil film applied over air dried film | Good Flow | Good Flow |

Briefly, IPDI, TMP, and the caprolactone polyol were combined with mixing (mixer set to medium) and the temperature increased to 75° C. The DABCO T-12 catalyst was then added to the mixture. An exotherm was observed and the mixtures allowed to begin cooling. The NCO % was examined and the mixture cooled to 105-110° C. Cosolvent PROGLYDE™ DMM was added and the temperature adjusted to 98-95° C. Next, dimethylolpropionic acid (DMPA) was added, and the mixture incubated at 93-98° C. for 113 minutes for Waterborne Polyurethane 3 and 71 minutes for Comparative Waterborne Polyurethane 5. The mixture was cooled to 82-87° C. under dry nitrogen and characteristics examined. Next, dimethylolpropionic acid (DMPA) was added, and the mixture incubated at 93-98° C. for 113 minutes for Waterborne Polyurethane 3 and 71 minutes for Comparative Waterborne Polyurethane 5. The mixtures were cooled to 82-87° C. under dry nitrogen and the viscosity and pH determined.

Briefly, triethylamine (TEA) was added to the prepolymer. To the dispersion tank, water was added to 30% solids and DEE FO® PI-40. The temperature was adjusted to 25-28° C. The prepolymer-triethylamine mixture was added. Aminoethylethanolamine (AEEA), water, and adipic dihydrazide were premixed. Formalin was added and mixed until clear. Ethylenediamine (EDA) was added and mixed to produce a premixed amine mixture. The prepolymer was mixed for 10-15 minutes, and the viscosity, pH, appearance, and temperature examined. The premixed amines mixture was slowly added to the prepolymer with both showing easy acceptance and an exotherm observed.

Results. Polyol Example 2 (1000 MW) demonstrated significant improvement in chemical resistance properties in waterborne polyurethane formulations as compared to the standard CAPA® 2100 Polyol (1000 MW). Such improvement is manifested in a thoroughly dried coating and demonstrates the previously observed and reported improvements towards alcohols and ketones. When the waterborne polyurethanes are thoroughly dried, the pentaspiroglycol (PSG) initiated polyol-containing waterborne polyurethane with the crosslink mechanisms enhanced the chemical resistance properties enough to demonstrate significant improvement as compared to the waterborne polyurethanes containing the standard CAPA® 2100 Polyol (1000 MW polycaprolactone diol initiated with neopentyl glycol; Ingevity UK Ltd, Warrington, United Kingdom), which has equal molecular weight. Since these comparative systems are equal in stoichiometry and crosslink mechanisms, the comparative improvements in chemical resistance properties are predominantly due to the presence of the pentaspiroglycol (PSG) initiated polyol.

Previous comparative evaluations compared Polyol Example 1 (pentaspiroglycol polyol 2000 MW) to standard CAPA® 2201 (2000 MW polycaprolactone diol initiated with neopentyl glycol) and found a lower degree of inherent chemical resistance resulting from the pentaspiroglycol (PSG) polyol system. Based upon this data, the pentaspiroglycol (PSG) content of the polyol is likely a controlling factor in attainment of the significantly improved chemical resistance properties of waterborne polyurethane prepared with the 1000 MW pentaspiroglycol initiated (PSG) initiated polyol.

Under low heat cure conditions, the chemical resistance improvements observed in the waterborne polyurethane containing the pentaspiroglycol (PSG) initiated polyol are greatly negated. However, the systems should be thoroughly dried for comparative purposes and under such conditions the pentaspiroglycol (PSG) initiated polyol demonstrated significantly improved chemical resistance properties. In actual application, such thorough drying is not always obtained so it should be noted that in order to observe the full impact of the improved chemical resistance due to the pentaspiroglycol (PSG) initiated polyol, the system must be thoroughly dried.

Table 10 shows Chemical Resistance results for Waterborne Polyurethane 3 (Polyol Example 2, 1000 MW) and Comparative Waterborne Polyurethane 5 (CAPA® 2100 Polyol, 1000 MW polycaprolactone diol initiated with neopentyl glycol), which was examined using the American Society for Testing and Materials (ASTM) C1378-20—Standard Test Method for Determination of Resistance to Staining). Briefly, two coats, 14 wet mil deposition of each, were applied to Lanetta gloss cards. The coated Lanetta gloss cards were oven dried 30 minutes at 130° C. and then dried at room temperature for 8 days. Test chemicals spots were applied for a duration of 1 hour at ambient temperature. Coatings were rated for “BLUSHING” and “SOFTENING” immediately upon removal of test chemicals. The rating system is from 0 to 10 with 0=destruction and 10=no affect.

TABLE 10
Chemical Resistance Results for Waterborne Polyurethane
3 and Comparative Waterborne Polyurethane 5

| | Waterborne | | Comparative Waterborne | |
|---|---|---|---|---|
| | Polyurethane 3 | | Polyurethane 5 | |
| | Blush | Soften | Blush | Soften |
| Water | 10 | 10 | 10 | 10 |
| 99% Isopropyl | 10 | 7 | 10 | 3 |
| Alcohol | | slight mark | | softens |
| Hot Coffee | 10 | 10 | 10 | 10 |
| Hot Tea | 10 | 10 | 10 | 10 |
| French's Mustard | 3 | 10 | 3 | 10 |
| (McCormick & | stain | | stain | |
| Company, Inc.; Hunt | | | | |
| Valley, Maryland) | | | | |
| Germ-X Hand | 10 | 7 | 10 | 3 |
| Sanitizer (Germ-X; | | slight mark | | softens |
| Saint Louis, | | | | |
| Missouri) | | | | |
| Lysol Disinfectant | 10 | 9 | 10 | 5 |
| Spray (Reckitt | | very slight | | softens |
| Benckiser LLC; | | mark | | |
| Parsippany, New | | | | |
| Jersey) | | | | |
| Chlorine Bleach | 9 | 10 | 8 | 7 |
| | slight | | slight | softens |
| | blush | | blush | |
| Vodka | 10 | 9 | 10 | 5 |
| | | very slight | | softens |
| | | mark | | |
| MEK | 10 | 9 | 10 | 3 |
| | | very slight | | softens |
| | | mark | | |
| 5% Ammonia | 10 | 9 | 10 | 5 |
| | | very slight | | softens |
| | | mark | | |
| Aviation Hydraulic | 10 | 5 | 10 | 5 |
| Fluid (SKYDROL ® | | mark and | | softens |
| LD-4; Eastman | | gloss loss | | |
| Chemical Company, | | | | |
| Kingsport, | | | | |
| Tennessee) | | | | |
| Totals | 112 | 105 | 111 | 76 |

Table 11 shows Chemical Resistance results for Waterborne Polyurethane 3 (Polyol Example 2, 1000 MW) and Comparative Waterborne Polyurethane 5 (CAPA® 2100 Polyol, 1000 MW polycaprolactone diol initiated with neopentyl glycol), which was examined using the American Society for Testing and Materials (ASTM) C1378-20—Standard Test Method for Determination of Resistance to Staining). Briefly, one coat, 12 wet mil deposition, was applied to Lanetta gloss cards. The coated Lanetta gloss cards were oven dried 30 minutes at 70° C. and then dried at room temperature for 2 days. Test chemicals spot were applied for a duration of 1 hour at ambient temperature. Coatings rated for “BLUSHING” and “SOFTENING” immediately upon removal of test chemicals. The rating system is from 0 to 10 with 0=destruction and 10=no affect.

TABLE 11
Chemical Resistance Results for Waterborne Polyurethane
3 and Comparative Waterborne Polyurethane 5

| | Waterborne | | Comparative Waterborne | |
|---|---|---|---|---|
| | Polyurethane 3 | | Polyurethane 5 | |
| | Blush | Soften | Blush | Soften |
| Water | 10 | 9 | 10 | 9 |
| | | slight mark | | slight mark |
| 99% Isopropyl | 5 | 0 | 5 | 0 |
| Alcohol | blush | destroyed | blush | destroyed |
| Hot Coffee | 5 | 9 | 5 | 9 |
| | stain | sight mark | stain | slight mark |
| Hot Tea | 10 | 9 | 10 | 9 |
| | | slight mark | | slight mark |
| French's | 2 | 10 | 2 | 10 |
| Mustard | stain | | stain | |
| (McCormick & | | | | |
| Company, Inc.; | | | | |
| Hunt Valley, | | | | |
| Maryland) | | | | |
| Germ-X Hand | 10 | 0 | 10 | 0 |
| Sanitizer (Germ- | | destroyed | | destroyed |
| X; Saint Louis, Missouri) | | | | |
| Lysol | 10 | 9 | 10 | 9 |
| Disinfectant | | slight mark | | slight mark |
| Spray (Reckitt | | | | |
| Benckiser LLC; | | | | |
| Parsippany, New | | | | |
| Jersey) | | | | |
| Chlorine Bleach | 8 | 5 | 10 | 0 |
| | slight | softens | | (swells/ |
| | blush | | | destroyed) |
| Vodka | 5 | 0 | 5 | 0 |
| | blush | destroyed | blush | destroyed |
| MEK | 10 | 0 | 10 | 0 |
| | | destroyed | | destroyed |
| 5% Ammonia | 10 | 0 | 10 | 0 |
| | | destroyed | | destroyed |
| Aviation | 10 | 0 | 2 | 0 |
| Hydraulic Fluid | | destroyed | stain | destroyed |
| (SKYDROL ® | | | | |
| LD-4; Eastman | | | | |
| Chemical | | | | |
| Company, | | | | |
| Kingsport, | | | | |
| Tennessee) | | | | |
| Totals | 95 | 41 | 89 | 36 |

Discussion. This example compare the effects of internal crosslink mechanisms common to waterborne polyurethane dispersion synthesis' with respect to resulting chemical resistance differences between standard a CAPA® polyol at 1000 MW (CAPA® 2100 Polyol, polycaprolactone diol initiated with neopentyl glycol) and a the pentaspiroglycol (PSG) initiated polyol at 1000 MW. For this reason, equal stoichiometry was used for each system. However, the processing results indicate that such stoichiometry is not suitable to obtain commercial product when using the CAPA® 2100 Polyol (1000 MW polycaprolactone diol initiated with neopentyl glycol) due to the resulting high viscosity obtained during extension of the polyurethane dispersion. Although clean and usable dispersions for the stated purpose were obtained in both synthesis', the CAPA® 2100 Polyol containing product (Comparative Waterborne Polyurethane 5) would require stoichiometric adjustments to obtain a suitable commercial product.

The high viscosity issue associated with Comparative Waterborne Polyurethane 5 synthesis would appear to reflect a higher degree of hydrophilicity associated with the CAPA® 2100 Polyol (1000 MW polycaprolactone diol initiated with neopentyl glycol) as compared the pentaspiroglycol (PSG) initiated polyol (Polyol Example 2, 1000 MW), thereby requiring less ionic character in the polyurethane dispersion backbone to obtain dispersion with a suitable viscosity. Such adjustment was not made for this evaluation.

Polyol Example 2 (1000 MW) and CAPA® 2100 Polyol (1000 MW polycaprolactone diol initiated with neopentyl glycol) both demonstrated significant foaming during the prepolymer preparations with both resulting in an 8% to 12% decrease in the actual NCO % remaining after the cook cycle, as compared to the theoretical amount desired. This is a moderately large loss of NCO during prepolymer synthesis presumably due to moisture present in both polyols. Despite the moderately large loss of NCO during prepolymer preparation, both systems were able to be dispersed and extended. The CAPA® 2100 Polyol (1000 MW polycaprolactone diol initiated with neopentyl glycol) was easily dispersed with no issues until the extension phase when the viscosity increased to usable, but unacceptable levels. Waterborne Polyurethane 3 (Polyol Example 2, 1000 MW) was moderately difficult to disperse due to the higher inherent softening point of Polyol Example 2 (1000 MW), thereby resulting in a tendency for the prepolymer oligomer to solidify as small particles during initial dispersion into cold water. Such particles were ultimately dispersed with continued mixing prior to chain extension. Both systems were usable for the stated purpose.

### Example 5. Evaluation of Pentaspiroglycol (PSG) Initiated Polyols in Waterborne Polyurethane Manufacture in Polyurethane Dispersion Systems Utilizing Internal Crosslink and Comparative Chemical Resistance Properties

In Example 4, a significant improvement in chemical resistance properties associated with the 1000 Molecular Weight pentaspiroglycol (PSG) initiated polyol (Polyol Example 2) was observed when used in a crosslinked waterborne polyurethane dispersion, as compared to the standard CAPA® 2101 Polyol (1000 MW polycaprolactone diol initiated with neopentyl glycol). Example 5 examines polyurethane dispersions made with a second 1000 MW pentaspiroglycol (PSG) initiated polyol (Polyol Example 3) and CAPA® 2101 Polyol (1000 MW polycaprolactone diol initiated with neopentyl glycol).

Waterborne Polyurethane Formulations and Synthesis. The formulations and characteristics of Waterborne Polyurethane 4 (Polyol Example 3, 1000 MW) and Comparative Waterborne Polyurethane 6 (CAPA® 2101 Polyol, 1000 MW polycaprolactone diol initiated with neopentyl glycol) are shown in Table 12 for the prepolymer formulation and Table 13 for the dispersion formulation. Processing parameters for Waterborne Polyurethane 4 (Polyol Example 3, 1000 MW) and Comparative Waterborne Polyurethane 6 (CAPA® 2101 Polyol, 1000 MW polycaprolactone diol initiated with neopentyl glycol) are shown in Table 13.

TABLE 12
Prepolymer Formulations for Waterborne Polyurethane
4 and Comparative Waterborne Polyurethane 6

| Prepolymer calculations | | Waterborne | | Comparative Waterborne | |
|---|---|---|---|---|---|
| | Equiv. | Polyurethane 4 | | Polyurethane Example 6 | |
| | Weight | Equiv. | Batch | Equiv. | Batch |
| | (Equiv.) | Charge | Charge | Charge | Charge |
| Isophorone | 111.20 | 200.16 | 572.68 | 200.16 | 604.81 |
| diisocyanate (IPDI) | (1.80) | | | | |
| Polyol Example 3 | 522.81 | 250.95 | 718.00 | | |
| | (0.48) | | | | |
| CAPA ® 2101 | 497.30 | | | 238.70 | 721.26 |
| (Ingevity UK Ltd, | (0.48) | | | | |
| Warrington, United | | | | | |
| Kingdom) | | | | | |
| Dimethylolpropionic | 67.10 | 28.18 | 80.62 | 28.18 | 85.15 |
| acid (DMPA) | (0.42) | | | | |
| Trimethylolpropane | 44.67 | 4.47 | 12.78 | 4.47 | 13.51 |
| (TMP) | (0.10) | | | | |
| PROGLYDE ™ | To 90% | 53.76 | 153.82 | | |
| DMM (DOW ®, | Prepolymer | | | | |
| Midland, Michigan) | Solids | | | | |
| PROGLYDE ™ | To 95% | | | 24.82 | 75.00 |
| DMM (DOW ®, | Prepolymer | | | | |
| Midland, Michigan) | Solids | | | | |
| DABCO ® T-12 | DBTDL | 0.097 | 0.29 | 0.094 | 0.28 |
| Catalyst (EVONIK | Catalyst | | | | |
| CORPORATION, | 200 ppm on | | | | |
| Parsippany, New | reactants | | | | |
| Jersey) | | | | | |

| | | | | |
|---|---|---|---|---|
| Prepolymer Totals: | 537.617 | 1538.19 | 496.424 | 1500 |

| | | |
|---|---|---|
| Theoretical NCO % 1st Stage | 11.24% | 11.56% |
| Theoretical NCO % Final | 6.25% @ 90% solids | 6.77% @ 95% solids |
| Theoretical COOH % | 1.76% @ 90% solids | 1.906% @ 95% solids |

Briefly, IPDI, TMP, and the caprolactone polyol were combined with mixing (mixer set to medium) and the temperature increased to 75° C. The DABCO T-12 catalyst was then added to the mixture. An exotherm was observed and the mixture allowed to begin cooling. The NCO % was examined and the mixture cooled to 105-110° C. Cosolvent PROGLYDE™ DMM was added and the temperature adjust to 98-95° C.

Next, dimethylolpropionic acid (DMPA) was added, and the mixture incubated at 93-98° C. for 113 minutes for Waterborne Polyurethane 4 (NCO % 5.48%, theoretical 6.25%) and 71 minutes for Comparative Waterborne Polyurethane 6 (NCO % 6.44%, theoretical 6.77%). Prepolymer viscosity @ 83° C. at theoretical NCO % was determined to be 10,000 cps @ 83° C. for Waterborne Polyurethane 4 and 8,000 cps @ 83° C. for Comparative Waterborne Polyurethane 6. The mixture was cooled to 82-87° C. under dry nitrogen and the viscosity determined to be 10,000 cps @ 83° C. for Polyurethane 4 and 8,000 cps @ 87° C. for Comparative Waterborne Polyurethane 6. Finally, the NCO % was determined to be 5.48% for Waterborne Polyurethane 4 and 6.44% for Comparative Waterborne Polyurethane 6.

TABLE 13
Dispersion formulation for Waterborne Polyurethane
4 and Comparative Waterborne Polyurethane 6

| | | Comparative |
|---|---|---|
| | Waterborne | Waterborne |
| | Polyurethane 4 | Polyurethane 6 |
| Prepolymer Equiv. Wgt as NCO | 4200/5.48% | 4200/6.44% |
| | NCO = 766.42 | NCO = 652.17 |
| Prepolymer Equiv. Wgt as COOH | (4500/1.76% | (4500/1.906% |
| | COOH) = 2556.82 | COOH) = 2360.97 |
| Neutralizing Amine Calculation | (766.42/2556.82) | (652.17/2360.97) |
| (TEA @ 1.0 Equiv.) | (101.15)(1.0) = 30.32 | (101.15)(1.0) = 27.94 |

| | Equiv. Wgt | Equiv. | Batch | Equiv. | Batch |
|---|---|---|---|---|---|
| | (Equivalents) | Charge | Charge | Charge | Charge |
| Polyol Example 3 (1000 | 766.42 | 766.42 | 1391.74 | | |
| MW) Prepolymer @90% | (1.00) | | | | |
| CAPA ® 2101 Polyol (1000 | 652.17 | | | 652.17 | 1390.91 |
| MW polycaprolactone | (1.00) | | | | |
| diol initiated with | | | | | |
| neopentyl glycol) | | | | | |
| Prepolymer @95% | | | | | |
| Triethylamine (TEA) | 1.00 Eq. | 30.32 | 55.06 | 27.94 | 59.59 |
| | on acid | | | | |
| | added to | | | | |
| | Prepolymer | | | | |
| Water | To 30% | 1510.02 | 2709.06 | 1391.89 | 2881.23 |
| | Dispersion | | | | |
| | Solids | | | | |
| Ethylene Diamine (EDA) | 30.00 | 13.50 | 24.51 | 13.50 | 28.79 |
| | (0.45) | | | | |
| Aminoethylethanolamine(AEEA) | 52.0 | 15.60 | 28.33 | 15.60 | 33.27 |
| | (0.30) | | | | |
| Adipic Dihydrazide | 87.0 | 13.05 | 23.69 | 13.05 | 27.83 |
| | (0.15) | | | | |
| Formalin 37% | 81.06 | 6.08 | 11.04 | 6.08 | 12.97 |
| | (0.075) | | | | |
| Water (to 30% Amine) | | 92.27 | 167.56 | 92.97 | 198.28 |
| Defoamer - DEE FOR PI- | 0.02% per | 0.49 | 0.88 | 0.44 | 0.91 |
| 40 (Munzing - Ultra | total batch | | | | |
| Additives LLC, | weight | | | | |
| Bloomfield, New Jersey) | | | | | |
| Dispersion Total | | 2296.55 | 4411.87 | 2064.26 | 4633.78 |
| NOTE: Prepolymer | | | 30.23% Solids | | 30.57% Solids |
| Overcharge was not | | | Theory | | Theory |
| compensated with | | | | | |
| additional make-up water | | | | | |
| resulting in the listed | | | | | |
| theoretical solids contents | | | | | |

Briefly, triethylamine (TEA) was added to the prepolymer (10,000 cps for Waterborne Polyurethane 4 at 83° C. and 8,000 cps for Comparative Waterborne Polyurethane 6 at 83° C.). To the dispersion tank, water at 28° C. (Waterborne Polyurethane 4) or 25.5° C. (Comparative Waterborne Example 6) was added to 30% solids and DEE FO® PI-40. The temperature was adjusted to 25-28° C. The prepolymer-triethylamine mixture was added. For Waterborne Polyurethane 4, there was easy dispersed at a normal feed rate, providing a semi-translucent appearance with an increase in viscosity observed with the final 10% of the prepolymer addition and a final temperature was 37° C.

Aminoethylethanolamine (AEEA), water, and adipic dihydrazide were premixed. Formalin was added and mixed until clear. Ethylenediamine (EDA) was added and mixed to produce a premixed amine mixture. The prepolymer was mixed for 10-15 minutes, and the viscosity, pH, appearance, and temperature examined. Prepolymer for Waterborne Polyurethane 4 had a semi-translucent appearance with a viscosity of 20 cps at 36° C. and a pH of 7.62, while the prepolymer for Comparative Waterborne Polyurethane 6 had a translucent appearance with a viscosity of 20 cps at 34.4° C. and a pH of 7.60.

The premixed amines mixture was slowly added to the prepolymer with both showing easy acceptance and an exotherm observed. NCO (via Fourier Transform Infrared (FTIR) Spectroscopy), viscosity, and pH were reexamined after 30 minutes of mixing.

Waterborne Polyurethane 4 had trace amounts of NCO with a viscosity of 20 cps at 33° C. and a pH of 7.68, while the Comparative Waterborne Polyurethane 6 had trace amounts of NCHO with a viscosity of 30 cps at 30.6° C., and a pH of 7.72. The next day solids content, viscosity, pH, and the appearance of the waterborne polyurethanes was examined. Waterborne Polyurethane 4 had a semi-translucent appearance with a viscosity of 20 cps at 25° C., a pH of 7.54, and a total solids content of 31.67%, while the Comparative Waterborne Polyurethane 6 had a semi-translucent appearance with a viscosity of 60 cps at 25° C., a pH of 7.59, and a total solids content of 31.46%.

Results. Waterborne Polyurethane 4 (Polyol Example 3, 1000 MW) and Comparative Waterborne Polyurethane 6 (CAPA® 2100 Polyol, 1000 MW polycaprolactone diol initiated with neopentyl glycol) were prepared as a replicate for Example 4 (Waterborne Polyurethane 3 (Polyol Example 2, 1000 MW) and Comparative Waterborne Polyurethane 5 (CAPA® 2100 Polyol, 1000 MW polycaprolactone diol initiated with neopentyl glycol)). Waterborne Polyurethane 4 (Polyol Example 3, 1000 MW) and Comparative Waterborne Polyurethane 6 (CAPA® 2100 Polyol, 1000 MW polycaprolactone diol initiated with neopentyl glycol) were examined as described in the other Examples and the results are shown in Table 14 and Table 15.

For example, chemical spot resistance screening was examined using the American Society for Testing and Materials (ASTM) C1378-20—Standard Test Method for Determination of Resistance to Staining). Briefly, 14 wet mil films on Lanetta cards that were oven dried for 30 minutes at 70° C., followed by 10 minutes at 130° C. Spot tests were performed for 1 hour with the recited chemical under a cotton ball. The rating system is from 0 to 10 with 0=destruction and 10=no affect. These results are shown in Table 15.

TABLE 14
Final Test Results for Waterborne Polyurethane
4 and Comparative Waterborne Polyurethane 6

| | Comparative |
|---|---|
| Waterborne | Waterborne |
| Polyurethane 4 | Polyurethane 6 |

| | | | | |
|---|---|---|---|---|
| Viscosity | 20 | cps | 20 | cps |

| | | |
|---|---|---|
| (BKFLD | | |
| RVT @25 C.) | | |
| pH | 7.47 | 7.59 |
| Total Solids | 31.67% | 31.46% |
| Content | | |
| Appearance | Semi- | Semi- |
| | translucent | translucent |

| | | | | |
|---|---|---|---|---|
| König | 86 | seconds | 55 | seconds |

| | | |
|---|---|---|
| Hardness | | |
| (on steel) | | |
| Gardner | 91.8 | 91.7 |
| Gloss 60 | | |
| degree | | |
| Gardner | 74.8 | 68.2 |
| Gloss 20 | | |
| degree | | |
| Weight/Gal | 8.720 | 8.706 |
| @ 25 C. | | |

| | | | | |
|---|---|---|---|---|
| Softening | 188-199° | C. | 154-166° | C. |

| | | |
|---|---|---|
| Point | | |
| (Par Bar) | | |
| Estimated | NA | 3000-3500 |
| Modulus | | pounds per |
| 100% | | square inch |
| | | (psi) |

| | | | | |
|---|---|---|---|---|
| Estimated | 5000-5500 | psi | 4500-5500 | psi |

| | | |
|---|---|---|
| Tensile at | | |
| Break | | |
| Elongation % | 15-25% | 125-150% |

TABLE 15
Chemical Resistance Results for Waterborne Polyurethane
4 and Comparative Waterborne Polyurethane 6

| | | Comparative |
|---|---|---|
| | Waterborne | Waterborne |
| | Polyurethane 4 | Polyurethane 6 |
| Water | 10 | 10 |
| | No Affect | No Affect |
| Denatured Ethanol | 8 | 5 |
| | Slight Ring | Significant Softening |
| 70% Ethanol in | 10 | 8 |
| Water | No Affect | Slight Ring/Softening |
| Acetone | 9 | 9 |
| | Very Slight Mark | Very Slight Mark |
| Aviation Hydraulic | 3 | 3 |
| Fluid (SKYDROL ® | Softens/Destroyed | Softens/Destroyed |
| SD-1, Eastman | | |
| Chemical Company, | | |
| Kingsport, | | |
| Tennessee) | | |
| Hand Sanitizer | 8 | 9 |
| | Ring/Mark | Slight Mark |

The evaluation of the replicate systems yielded slightly different results compared to results from the evaluation of the primary systems with regards to spot chemical resistance properties. Example 4 identified a significant difference between Waterborne Polyurethane 3 (Polyol Example 2, 1000 MW) and Comparative Waterborne Polyurethane 5 (CAPA® 2100 Polyol, 1000 MW polycaprolactone diol initiated with neopentyl glycol), especially with regards to alcohol(s) and ketone resistance properties. An abridged version of spot chemical resistance testing was run on the replicate systems of Example 5 and the results demonstrate that the Comparative Waterborne Polyurethane 6 (CAPA® 2101 Polyol, 1000 MW polycaprolactone diol initiated with neopentyl glycol) yielded far superior chemical resistance results as compared to the Comparative Waterborne Polyurethane 5 (CAPA® 2100 Polyol, 1000 MW polycaprolactone diol initiated with neopentyl glycol) in Example 4 despite the stoichiometry and backbones of the two systems being identical. Waterborne Polyurethane 4 (Polyol Example 3, 1000 MW) had slightly lower chemical resistance properties, but within observation error, than Waterborne Polyurethane 3 (Polyol Example 2, 1000 MW) in Example 4. The replicate data demonstrates that the pentaspiroglycol (PSG) initiated polyol of the present disclosure can yield a polyurethane backbone that delivers excellent and unusual chemical resistance properties.

In addition to the chemical resistance properties, several other significant properties were identified for the pentaspiroglycol (PSG) initiated polyol, as compared to standard CAPA® 2101 Polyol (1000 MW polycaprolactone diol initiated with neopentyl glycol). The most obvious property identified was an unusual surface hardness and short elongation in the film properties of waterborne polyurethane containing pentaspiroglycol (PSG) initiated polyol (Waterborne Polyurethane 4 (Polyol Example 3, 1000 MW)), as compared to Comparative Waterborne Polyurethane 6 (CAPA® 2101 Polyol, 1000 MW polycaprolactone diol initiated with neopentyl glycol). Such elongation reduction and surface hardness was present despite what appears to be excellent flexibility and equal or better tensile properties. In simpler terms, Waterborne Polyurethane 4 (Polyol Example 3, 1000 MW) yielded hard, tight but not brittle films. In addition to the shorter elongation Waterborne Polyurethane 4 (Polyol Example 3, 1000 MW) also yielded a moderately large increase in softening point of dried films. Such an increase in softening point can be a major benefit in some applications but it can also be a hinderance for processing purposes as the “prepolymer” produced using pentaspiroglycol (PSG) initiated polyol has the tendency to “harden/solidify” quickly and immediately upon being exposed to cool/cold conditions, such as the addition of the “prepolymer” to cool/cold water for dispersion. The replicate samples demonstrate that such dispersions can be made but waterborne polyurethane systems produced with 1000 MW pentaspiroglycol (PSG) initiated polyol may benefit from either a neutralizing amine preneutralization or a cosolvent dilution in order to “cleanly” introduce a prepolymer containing a moderately high level of 1000 MW pentaspiroglycol (PSG) initiated polyol into cool water.

Discussion. The 1000 MW pentaspiroglycol (PSG) initiated polyol demonstrated greater property performance improvements than the 2000 MW pentaspiroglycol (PSG) initiated polyol. While not being tethered or limited thereto, it is believed that the increase in performance properties is directly related to the content of pentaspiroglycol (PSG) in the polyol backbone. The performance improvements relate to improved alcohol resistance properties, significantly harder film surfaces, and higher inherent softening point as compared to standard CAPA® polyols at equal molecular weight. The 1000 molecular weight pentaspiroglycol (PSG) initiated polyol is capable of being used for synthesis of waterborne polyurethane resins and can result in the mentioned performance enhancements. Some possible restrictions in processing may arise due to the inherently higher softening point of the ester resin causing resin hardness upon incorporation into cold water but such restrictions are readily managed by pre-neutralization techniques and/or the use of cosolvent.

While several embodiments of the invention of the present disclosure have been shown and described herein, it will be understood that such embodiments are provided by way of example only. Numerous variations, changes and substitutions will occur to those skilled in the art without departing from the spirit of the invention. Rather, the present disclosure is to cover all modifications, equivalents, and alternatives falling within the scope of the present disclosure as defined by the following appended claims and their legal equivalents. Accordingly, it is intended that the description and appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients can be varied to optimize the desired effects, additional ingredients can be added, and/or similar ingredients can be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

What is claimed is:

1. A caprolactone polyol made by a process comprising:
admixing caprolactone monomers and pentaspiroglycol (PSG) to form an initiator-caprolactone mixture or reaction mixture;
adding one or more catalyst to the initiator-caprolactone mixture to form a reaction mixture; and
polymerizing the caprolactone monomers in the reaction mixture, thereby forming the caprolactone polyol.

2. The caprolactone polyol of claim 1, wherein the process further comprises at least one of: (i) sparing the initiator-caprolactone mixture prior to adding the one or more catalyst; (ii) incubating the initiator-caprolactone mixture prior to adding the one or more catalyst; (iii) heating the initiator-caprolactone mixture to about 70° C. to about 100° C.; (iv) removing excess water from the initiator-caprolactone mixture; or (v) a combination thereof.

3. The caprolactone polyol of claim 1, wherein polymerizing comprises at least one of: (i) performing with refluxing; (ii) performing at about 150° C. to about 190° C.; (iii) performing until the caprolactone monomer concentration is below 0.5%; (iv) performing for about 4 to about 6 hours; or (v) a combination thereof.

4. The caprolactone polyol of claim 1, the process further comprises at least one of: (i) adding one or more acid scavengers; (ii) adding additional catalyst to the reaction mixture, thereby forming the caprolactone polyol; or (iii) a combination thereof.

5. The caprolactone polyol of claim 1, wherein the initiator-caprolactone mixture further comprises at least one of: one or more antioxidant, one or more stabilizer, or a combination thereof.

6. The caprolactone polyol of claim 5, wherein the one or more antioxidant, the one or more stabilizer, or a combination thereof, includes at least one of: a phenolic antioxidant and/or stabilizer, a sterically hindered phenolic antioxidant and/or stabilizer, pentaerythritol tetrakis(3-(3,5-di-tert-butyl-4-hydroxyphenyl)propionate), a phosphite antioxidant and/or stabilizer, bis(2,4-di-tert-butylphenol)pentaerythritol diphosphate, an antihydrolysis agent, carbodiimide, monomeric carbodiimide, or a combination thereof.

7. The caprolactone polyol of claim 1, wherein at least one of:
the caprolactone monomers is present in an amount of about 65 wt % to about 95 wt % of the initiator-caprolactone mixture;
the pentaspiroglycol (PSG) is present in an amount of about 5 wt % to about 35 wt % of the initiator-caprolactone mixture;
the caprolactone monomers is present in an amount of about 65 wt % to about 95 wt % of the reaction mixture;
the pentaspiroglycol (PSG) is present in an amount of about 5 wt % to about 35 wt % of the reaction mixture;
the one or more catalyst is present in an amount of about 0.001 wt % to about 5 wt % of the reaction mixture;
the one or more antioxidants or stabilizer is present in an amount of up to about 2 wt % of the reaction mixture;
the molecular weight of the caprolactone polyol is about 1,000 g/mol (MW) to about 4500 MW;
the caprolactone polyol comprises less than about 5% caprolactone monomer;
the caprolactone polyol has an acid number of <0.4 KOH/g;
the one or more catalysts is one or more catalyst for ring-opening polymerization; or
a combination thereof.

8. A prepolymer composition, polyurethane dispersion, or waterborne polyurethane, comprising one or more caprolactone polyol of claim 1.

9. The prepolymer composition, polyurethane dispersion, or waterborne polyurethane, of claim 8 made by a process comprising reacting:
the one or more caprolactone polyol,
optionally one or more additional polyol,
one or more isocyanate comprising two or more isocyanate groups, and
one or more catalyst,
thereby forming a polyurethane material.

10. The prepolymer composition, polyurethane dispersion, or waterborne polyurethane, of claim 9, wherein at least one of:
the process further comprises heating the one or more caprolactone polyol, optionally the one or more additional polyol, and the one or more isocyanate prior to reacting;
reacting is performed for about 1.0 hour to about 2.0 hours;
the process further comprises sparging the caprolactone polyol prior to reacting; or
a combination thereof.

11. The prepolymer composition, polyurethane dispersion, or waterborne polyurethane, of claim 8, the process further comprising adding to, and/or mixing with, the polyurethane material:
optionally, one or more cosolvent; and
one or more internal emulsifier,
thereby forming a polyurethane material.

12. The prepolymer composition, polyurethane dispersion, or waterborne polyurethane, of claim 11, the process further comprises at least one of:
adding the one or more internal emulsifier after the cosolvent;
adjusting the temperature of (a) the polyurethane material, or (b) the polyurethane material and the cosolvent mixture to about 85° C. to about 105° C.;
incubating or mixing the one or more internal emulsifier with (a) the polyurethane material, or (b) the polyurethane material and the cosolvent mixture, for about 45 minutes to about 180 minutes;
incubating or mixing the one or more internal emulsifier with (a) the polyurethane material, or (b) the polyurethane material and the cosolvent mixture, at a temperature of about 85° C. to about 105° C.; or
a combination thereof.

13. The prepolymer composition, polyurethane dispersion, or waterborne polyurethane, of claim 9, the process further comprising:
adding, combining and/or mixing one or more counterion or neutralizer (e.g., an amine, such as at least one of triethylamine (TEA), dimethylethanolamine (DMEA), or a combination thereof) with the polyurethane material (e.g., prepolymer composition) to produce a counterion-polyurethane materials mixture; and
adding, combining, and/or mixing water, and optionally one or more defoamer, optionally one or more chain extender, or a combination thereof, with the counterion-polyurethane materials mixture to produce a dispersion.

14. The prepolymer composition, polyurethane dispersion, or waterborne polyurethane, of claim 13, wherein at least one of:
adding, combining, and/or mixing the one or more counterion or neutralizer with the polyurethane material is at a temperature of about 75° C. to about 95° C.;
adding, combining, and/or mixing the water, and optionally the one or more defoamer, optionally the one or more chain extender, or a combination thereof, with the counterion-polyurethane materials mixture is at a temperature of about 20° C. to about 35° C.; or
a combination thereof.

15. The prepolymer composition, polyurethane dispersion, or waterborne polyurethane, of claim 13, the process further comprising reacting the dispersion with one or more chain extender.

16. The prepolymer composition, polyurethane dispersion, or waterborne polyurethane, of claim 15, wherein at least one of:
reacting the dispersion with the one or more chain extender includes slowly adding the one or more chain extender to the dispersion;
the one or more chain extender is a composition comprising formalin and one or more chain extender; or
a combination thereof.

17. The prepolymer composition, polyurethane dispersion, or waterborne polyurethane, of claim 9, wherein at least one of:
the one or more additional polyol includes or is a low-molecular-weight polyol having a number average molecular weight of 400 or less;
the one or more additional polyol has three or more hydroxyl groups;
the one or more internal emulsifier includes or is at least one of: one or more nonionic emulsifier, one or more cationic emulsifier, one or more anionic emulsifier, or a combination thereof;
the one or more isocyanate includes or is at least one of: monomeric, oligomeric, polymeric, or a mixture thereof;
the one or more isocyanate includes or is at least one of: an aliphatic polyisocyanate, mono-cyclic polyisocyanate, aromatic polyisocyanates, aromatic/aliphatic polyisocyanate, or a combination thereof;
the one or more catalyst includes or is one or more urethane catalyst;
the one or more cosolvent includes or is one or more (e.g., 1, 2, 3, 4, 5, or more) aprotic solvent;
the one or more counterion or neutralizer includes or is one or more amine;
the one or more defoamer includes or is water-based defoamer;
the one or more chain extender has a molecular weight from about 60 to about 600;
the one or more chain extender includes or is at least one of: one or more diol chain extender, one or more diamine chain extender, or a combination thereof; or
a combination thereof.

18. The prepolymer composition, polyurethane dispersion, or waterborne polyurethane, of claim 9, wherein:
the one or more additional polyol includes or is at least one of: one or more trihydric alcohol; one or more tetrahydric alcohol; one or more pentahydric alcohol; one or more hexahydric alcohol; one or more heptahydric alcohol; one or more octahydric alcohol; one or more polyalkylene oxide having three or more hydroxyl groups; or a combination thereof;
the one or more internal emulsifier includes or is carboxylated diol;
the one or more isocyanate includes or is at least one of diphenylmethane diisocyanate, isophorone diisocyanate, bimethylene diisocyanate, trimethylene diisocyanate, tetramethylene diisocyanate, pentamethylene diisocyanate, hexamethylene diisocyanate, heptamethylene diisocyanate, toluene diisocyanate, naphthylene diisocyanate, cyclohexylmethane diisocyanate, dicyclohexylmethane diisocyanate, or a mixture thereof;
the one or more catalyst includes or is at least one of an organometallic compound, a organobismuth catalyst, or a combination thereof;
the one or more cosolvent includes or is at least one of a dipolar aprotic solvent, an aprotic propylene oxide solvent, or a combination thereof;
the one or more counterion or neutralizer includes or is triethylamine (TEA);
the one or more defoamer includes or is water-based defoamer;
the one or more chain extender includes or is a diol chain extender that includes or is an aliphatic diol or an aromatic diol;
the one or more diol chain extender includes or is at least one of an alkylene oxide or glycol, ethylene glycol, propanediol, butanediol, pentadiol, hexanediol, heptadiol, dihydroxybenzene, di(hydroxyethyl)-hydroxyquinone, di(hydroxymethyl)-hydroxyquinone, di-(hydroxyethyl)-bisphenol A, or a mixture thereof;
the one or more diamine chain extender includes or is at least one of diaminodiphenylmethane, dichloro-diaminodiphenylmethane, diaminobenzene, dimethoxy-diamino biphenyl, dimethyl-diamino biphenyl, diamino biphenyl, dichloro-diamino biphenyl, or a mixture thereof; or
a combination thereof.

19. The prepolymer composition, polyurethane dispersion, or waterborne polyurethane, of claim 9, wherein at least one of:
the one or more additional polyol includes or is at least one of glycerin; 2-methyl-2-hydroxymethyl-1,3-propanediol; 2,4-dihydroxy-3-hydroxymethylpentane; 1,2,6-hexanetriol; trimethylolpropane; 2,2-bis(hydroxymethyl)-3-butanol; tetramethylolmethane (pentaerythritol); diglycerol; xylitol; sorbitol; mannitol; iditol; dulcitol; altritol; inositol; dipentaerythritol; perseitol; sucrose; polyethylenepolyol, polypropylenepolyol, polyethylenepolypropylenepolyol; or a combination thereof;
the one or more internal emulsifier includes or is at least one of dimethylolpropionic acid (DMPA);
the one or more isocyanate includes or is at least one of 1,3-trimethylene diisocyanate; 2,3-trimethylene diisocyanate; 1,2-trimethylene diisocyanate; 2,2-trimethylene diisocyanate; 1,4-tetramethylene diisocyanate; 1,3-tetramethylene diisocyanate; 1,2-tetramethylene diisocyanate; 2,3-tetramethylene diisocyanate; 1,1-tetramethylene diisocyanate; 2,2-tetramethylene diisocyanate; 1,5-pentamethylene diisocyanate; 1,4-pentamethylene diisocyanate; 1,3-pentamethylene diisocyanate; 1,2-pentamethylene diisocyanate; 2,3-pentamethylene diisocyanate; 2,4-pentamethylene diisocyanate; 3,4-pentamethylene diisocyanate; 3,5-pentamethylene diisocyanate; 1,1-pentamethylene diisocyanate; 2,2-pentamethylene diisocyanate; 3,3-pentamethylene diisocyanate; 1,6-hexamethylene diisocyanate; 1,5-hexamethylene diisocyanate; 1,4-hexamethylene diisocyanate; 1,3-hexamethylene diisocyanate; 1,2-hexamethylene diisocyanate; 2,3-hexamethylene diisocyanate; 2,4-hexamethylene diisocyanate; 2,5-hexamethylene diisocyanate; 3,4-hexamethylene diisocyanate; 3,5-hexamethylene diisocyanate; 4,5-hexamethylene diisocyanate; 1,1-hexamethylene diisocyanate; 2,2-hexamethylene diisocyanate; 3,3-hexamethylene diisocyanate; 1,7-heptamethylene diisocyanate; 1,6-heptamethylene diisocyanate; 1,5-heptamethylene diisocyanate; 1,4-heptamethylene diisocyanate; 1,3-heptamethylene diisocyanate; 1,2-heptamethylene diisocyanate; 2,3-heptamethylene diisocyanate; 2,4-heptamethylene diisocyanate; 2,5-heptamethylene diisocyanate; 2,6-heptamethylene diisocyanate; 3,3-heptamethylene diisocyanate; 3,4-heptamethylene diisocyanate; 1,1-heptamethylene diisocyanate; 2,2-heptamethylene diisocyanate; 3,3-heptamethylene diisocyanate; 4,4-heptamethylene diisocyanate; toluene-2,4-diisocyanate; toluene-2,6-diisocyanate; 1,2-naphthylene diisocyanate; 1,3-naphthylene diisocyanate; 1,4-naphthylene diisocyanate; 1,5-naphthylene diisocyanate; 1,6-naphthylene diisocyanate; 1,7-naphthylene diisocyanate; 1,8-naphthylene diisocyanate; 1,4-cyclohexylmethane diisocyanate; 2,4-cyclohexylmethane diisocyanate; 3,4-cyclohexylmethane diisocyanate; 4,4-cyclohexylmethane diisocyanate; 4,4′-dicyclohexylmethane diisocyanate; 1,4-dicyclohexylmethane diisocyanate; or a mixture thereof;
the one or more isocyanate includes or is at least one of 2,2′-diphenylmethane diisocyanate; 2,4′-diphenylmethane diisocyanate; 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“H12 MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; cyclobutane-1,3-diisocyanate; 1,2-cyclohexane diisocyanate; 1,3-cyclohexane diisocyanate; 1,4-cyclohexane diisocyanate; 2,4-methylcyclohexane diisocyanate; 2,6-methylcyclohexane diisocyanate; 4,4′-dicyclohexyldiisocyanate; 2,4′-dicyclohexyldiisocyanate; 1,3,5-cyclohexane triisocyanate; a isocyanate-methylcyclohexane isocyanate; a isocyanatoethylcyclohexane isocyanate; a bis(isocyanatomethyl)-cyclohexane diisocyanate; 4,4′-bis(isocyanatomethyl) dicyclohexane; 2,4′-bis(isocyanatomethyl) dicyclohexane; 2,4-hexahydrotoluenediisocyanate; 2,6-hexahydrotoluenediisocyanate; 1,2-phenylene diisocyanate; 1,3-phenylene diisocyanate; 1,4-phenylene diisocyanate; triphenyl methane-4,4′,4″-triisocyanate; naphthylene-1,5-diisocyanate; 2,4′-biphenyl diisocyanate; 4,4′-biphenyl diisocyanate; 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof;
the one or more catalyst includes or is at least one of:
(i) one or more tertiary amine catalyst comprising at least one of triethylenediamine, N-methylmorpholine, N, N-dimethylcyclohexylamine, pentamethyldiethylenetriamine, tetramethylethylenediamine, bis (dimethylaminoethyl) ether, 1-methyl-4-dimethylaminoethyl-piperazine, 3-methoxy-N-dimethylpropylamine, N-ethylmorpholine; dimethylethanolamine, N-cocomorpholine, N, N-dimethyl-N′, N′-dimethyl isopropylpropylenediamine, N, N-diethyl-3-diethyl amino-propylamine, dimethylbenzylamine, or a mixture thereof;
(ii) one or more organometallic catalyst comprising at least one of organobismuth, organo mercury, organolead, organoferric, organotin catalysts, or a combination thereof;
(iii) one or more tin catalysts comprising at least one of stannous chloride, tin salts of carboxylic acids, stannous octoate, or a combination thereof;
(iv) one or more catalyst for the trimerization of polyisocyanates comprising an alkali metal alkoxide; or
(v) a combination thereof;
the one or more cosolvent includes or is dipropylene glycol diether;
the one or more counterion or neutralizer includes or is triethyl amine (TEA);
the one or more chain extender includes or is one or more diol chain extender that includes or is at least one of 1,3-propanediol; 1,2-propanediol; 1,1-propanediol; 2,2-propanediol; 1,4-butanediol; 1,3-butanediol; 1,2-butanediol; 2,3-butanediol; 1,1-butanediol; 2,2-butanediol; 1,5-pentadiol; 1,4-pentadiol; 1,3-pentadiol; 1,2-pentadiol; 2,3-pentadiol; 2,4-pentadiol; 3,4-pentadiol; 3,5-hexanediol; 1,1-pentadiol; 2,2-pentadiol; 3,3-pentadiol; 1,6-hexanediol; 1,5-hexanediol; 1,4-hexanediol; 1,3-hexanediol; 1,2-hexanediol; 2,3-hexanediol; 2,4-hexanediol; 2,5-hexanediol; 3,4-hexanediol; 3,5-hexanediol; 4,5-hexanediol; 1,1-hexanediol; 2,2-hexanediol; 3,3-hexanediol; 1,7-heptadiol; 1,6-heptadiol; 1,5-heptadiol; 1,4-heptadiol; 1,3-heptadiol; 1,2-heptadiol; 2,3-heptadiol; 2,4-heptadiol; 2,5-heptadiol; 2, 6-heptadiol; 3,3-heptadiol; 3,4-heptadiol; 1,1-heptadiol; 2,2-heptadiol; 3,3-heptadiol; 4,4-heptadiol; 1,2-dihydroxybenzene; 1,3-dihydroxybenzene; 1,4-dihydroxybenzene; 1,4-di-(betahydroxyethyl)-hydroxyquinone; 2,5-di-(hydroxyethyl)-hydroxyquinone; 2,3-di-(hydroxyethyl)-hydroxyquinone; 3,5-di-(hydroxyethyl)-hydroxyquinone; 2,5-di-(hydroxyethyl)-hydroxyquinone; 2,3-di-(hydroxymethyl)-hydroxyquinone; 3,5-di-(hydroxymethyl)-hydroxyquinone; 1,4-di-(betahydroxyethyl)-bisphenol A; 1,3-di-(betahydroxyethyl)-bisphenol A; 1,2-di-(betahydroxyethyl)-bisphenol A; 1,5-di-(betahydroxyethyl)-bisphenol A; 2,3-di-(betahydroxyethyl)-bisphenol A; 2,4-di-(betahydroxyethyl)-bisphenol A; 2,5-di-(betahydroxyethyl)-bisphenol A; 2,6-di-(betahydroxyethyl)-bisphenol A; 3,4-di-(betahydroxyethyl)-bisphenol A; 3,5-di-(betahydroxyethyl)-bisphenol A; or a mixture thereof;
the one or more chain extender includes or is one or more diamine chain extender that includes or is at least one of 2,2′-diaminodiphenylmethane; 2,3′-diaminodiphenylmethane; 2,4′-diaminodiphenylmethane; 2,5′-diaminodiphenylmethane; 2,6′-diaminodiphenylmethane; 3,4′-diaminodiphenylmethane; 3,5′-diaminodiphenylmethane; 3,6′-diaminodiphenylmethane; 4,4′-diaminodiphenylmethane; 4,5′-diaminodiphenylmethane; 4,6′-diaminodiphenylmethane; 5,6′-diaminodiphenylmethane; 2,2′-dichloro-3,3′-diaminodiphenylmethane; 2,2′-dichloro-4,4′-diaminodiphenylmethane; 5,5′-dichloro-3,3′-diaminodiphenylmethane; 2,2′-dichloro-6,6′-diaminodiphenylmethane; 2,2′-dichloro-3,4′-diaminodiphenylmethane; 2,2′-dichloro-3,5′-diaminodiphenylmethane; 2,2′-dichloro-3,6′-diaminodiphenylmethane; 2,2′-dichloro-4,5′-diaminodiphenylmethane; 2,2′-dichloro-4,6′-diaminodiphenylmethane; 2,2′-dichloro-5,6′-diaminodiphenylmethane; 3,3′-dichloro-2,2′-diaminodiphenylmethane; 3,3′-dichloro-4,4′-diaminodiphenylmethane; 3,3′-dichloro-5,5′-diaminodiphenylmethane; 3,3′-dichloro-6,6′-diaminodiphenylmethane; 3,3′-dichloro-2,5′-diaminodiphenylmethane; 3,3′-dichloro-4,5′-diaminodiphenylmethane; 3,3′-dichloro-6,5′-diaminodiphenylmethane; 3,3′-dichloro-4,2′-diaminodiphenylmethane; 3,3′-dichloro-4,6′-diaminodiphenylmethane; 4,4′-dichloro-2,2′-diaminodiphenylmethane; 4,4′-dichloro-3,3′-diaminodiphenylmethane; 4,4′-dichloro-5,5′-diaminodiphenylmethane; 4,4′-dichloro-6,6′-diaminodiphenylmethane; 4,4′-dichloro-2,3′-diaminodiphenylmethane; 4,4′-dichloro-2,5′-diaminodiphenylmethane; 4,4′-dichloro-2,6′-diaminodiphenylmethane; 4,4′-dichloro-3,5′-diaminodiphenylmethane; 4,4′-dichloro-3,6′-diaminodiphenylmethane; 4,4′-dichloro-5,6′-diaminodiphenylmethane; 5,5′-dichloro-2,2′-diaminodiphenylmethane; 5,5′-dichloro-3,3′-diaminodiphenylmethane; 5,5′-dichloro-4,4′-diaminodiphenylmethane; 5,5′-dichloro-6,6′-diaminodiphenylmethane; 5,5′-dichloro-2,3′-diaminodiphenylmethane; 5,5′-dichloro-2,4′-diaminodiphenylmethane; 5,5′-dichloro-2,6′-diaminodiphenylmethane; 5,5′-dichloro-3,4′-diaminodiphenylmethane; 5,5′-dichloro-3,6′-diaminodiphenylmethane; 5,5′-dichloro-4,6′-diaminodiphenylmethane; 6,6′-dichloro-2,2′-diaminodiphenylmethane; 6,6′-dichloro-3,3′-diaminodiphenylmethane; 6,6′-dichloro-4,4′-diaminodiphenylmethane; 6,6′-dichloro-5,5′-diaminodiphenylmethane; 6,6′-dichloro-2,3′-diaminodiphenylmethane; 6,6′-dichloro-2,4′-diaminodiphenylmethane; 6,6′-dichloro-2,5′-diaminodiphenylmethane; 6,6′-dichloro-3,4′-diaminodiphenylmethane; 6,6′-dichloro-3,5′-diaminodiphenylmethane; 6,6′-dichloro-4,5′-diaminodiphenylmethane; 1,4-diaminobenzene; 1,2-diaminobenzene; 1,3-diaminobenzene; 2,2′-dimethoxy-3,3′-diamino biphenyl; 2,2′-dimethoxy-4,4′-diamino biphenyl; 5,5′-dimethoxy-3,3′-diamino biphenyl; 2,2′-dimethoxy-6,6′-diamino biphenyl; 2,2′-dimethoxy-3,4′-diamino biphenyl; 2,2′-dimethoxy-3,5′-diamino biphenyl; 2,2′-dimethoxy-3,6′-diamino biphenyl; 2,2′-dimethoxy-4,5′-diamino biphenyl; 2,2′-dimethoxy-4,6′-diamino biphenyl; 2,2′-dimethoxy-5,6′-diamino biphenyl; 3,3′-dimethoxy-2,2′-diamino biphenyl; 3,3′-dimethoxy-4,4-diamino biphenyl; 3,3′-dimethoxy-5,5′-diamino biphenyl; 3,3′-dimethoxy-6,6′-diamino biphenyl; 3,3′-dimethoxy-2,5′-diamino biphenyl; 3,3′-dimethoxy-4,5′-diamino biphenyl; 3,3′-dimethoxy-6,5′-diamino biphenyl; 3,3′-dimethoxy-4,2′-diamino biphenyl; 3,3′-dimethoxy-4,6′-diamino biphenyl; 4,4′-dimethoxy-2,2′-diamino biphenyl; 4,4′-dimethoxy-3,3′-diamino biphenyl; 4,4′-dimethoxy-5,5′-diamino biphenyl; 4,4′-dimethoxy-6,6′-diamino biphenyl; 4,4′-dimethoxy-2,3′-diamino biphenyl; 4,4′-dimethoxy-2,5′-diamino biphenyl; 4,4′-dimethoxy-2,6′-diamino biphenyl; 4,4′-dimethoxy-3,5′-diamino biphenyl; 4,4′-dimethoxy-3,6′-diamino biphenyl; 4,4′-dimethoxy-5,6′-diamino biphenyl; 5,5′-dimethoxy-2,2′-diamino biphenyl; 5,5′-dimethoxy-3,3′-diamino biphenyl; 5,5′-dimethoxy-4,4′-diamino biphenyl; 5,5′-dimethoxy-6,6′-diamino biphenyl; 5,5′-dimethoxy-2,3′-diamino biphenyl; 5,5′-dimethoxy-2,4′-diamino biphenyl; 5,5′-dimethoxy-2,6′-diamino biphenyl; 5,5′-dimethoxy-3,4′-diamino biphenyl; 5,5′-dimethoxy-3,6′-diamino biphenyl; 5,5′-dimethoxy-4,6′-diamino biphenyl; 6,6′-dimethoxy-2,2′-diamino biphenyl; 6,6′-dimethoxy-3,3′-diamino biphenyl; 6,6′-dimethoxy-4,4′-diamino biphenyl; 6,6′-dimethoxy-5,5′-diamino biphenyl; 6,6′-dimethoxy-2,3′-diamino biphenyl; 6,6′-dimethoxy-2,4′-diamino biphenyl; 6,6′-dimethoxy-2,5′-diamino biphenyl; 6,6′-dimethoxy-3,4′-diamino biphenyl; 6,6′-dimethoxy-3,5′-diamino biphenyl; 6,6′-dimethoxy-4,5′-diamino biphenyl; 2,2′-dimethyl-3,3′-diamino biphenyl; 2,2′-dimethyl-4,4′-diamino biphenyl; 5,5′-dimethyl-3,3′-diamino biphenyl; 2,2′-dimethyl-6,6′-diamino biphenyl; 2,2′-dimethyl-3,4′-diamino biphenyl; 2,2′-dimethyl-3,5′-diamino biphenyl; 2,2′-dimethyl-3,6′-diamino biphenyl; 2,2′-dimethyl-4,5′-diamino biphenyl; 2,2′-dimethyl-4,6′-diamino biphenyl; 2,2′-dimethyl-5,6′-diamino biphenyl; 3,3′-dimethyl-2,2′-diamino biphenyl; 3,3′-dimethyl-4,4-diamino biphenyl; 3,3′-dimethyl-5,5′-diamino biphenyl; 3,3′-dimethyl-6,6′-diamino biphenyl; 3,3′-dimethyl-2,5′-diamino biphenyl; 3,3′-dimethyl-4,5′-diamino biphenyl; 3,3′-dimethyl-6,5′-diamino biphenyl; 3,3′-dimethyl-4,2′-diamino biphenyl; 3,3′-dimethyl-4,6′-diamino biphenyl; 4,4′-dimethyl-2,2′-diamino biphenyl; 4,4′-dimethyl-3,3′-diamino biphenyl; 4,4′-dimethyl-5,5′-diamino biphenyl; 4,4′-dimethyl-6,6′-diamino biphenyl; 4,4′-dimethyl-2,3′-diamino biphenyl; 4,4′-dimethyl-2,5′-diamino biphenyl; 4,4′-dimethyl-2,6′-diamino biphenyl; 4,4′-dimethyl-3,5′-diamino biphenyl; 4,4′-dimethyl-3,6′-diamino biphenyl; 4,4′-dimethyl-5,6′-diamino biphenyl; 5,5′-dimethyl-2,2′-diamino biphenyl; 5,5′-dimethyl-3,3′-diamino biphenyl; 5,5′-dimethyl-4,4′-diamino biphenyl; 5,5′-dimethyl-6,6′-diamino biphenyl; 5,5′-dimethyl-2,3′-diamino biphenyl; 5,5′-dimethyl-2,4′-diamino biphenyl; 5,5′-dimethyl-2,6′-diamino biphenyl; 5,5′-dimethyl-3,4′-diamino biphenyl; 5,5′-dimethyl-3,6′-diamino biphenyl; 5,5′-dimethyl-4,6′-diamino biphenyl; 6,6′-dimethyl-2,2′-diamino biphenyl; 6,6′-dimethyl-3,3′-diamino biphenyl; 6,6′-dimethyl-4,4′-diamino biphenyl; 6,6′-dimethyl-5,5′-diamino biphenyl; 6,6′-dimethyl-2,3′-diamino biphenyl; 6,6′-dimethyl-2,4′-diamino biphenyl; 6,6′-dimethyl-2,5′-diamino biphenyl; 6,6′-dimethyl-3,4′-diamino biphenyl; 6,6′-dimethyl-3,5′-diamino biphenyl; 6,6′-dimethyl-4,5′-diamino biphenyl; 2,2′-diamino biphenyl; 2,3′-diamino biphenyl; 2,4′-diamino biphenyl; 2,5′-diamino biphenyl; 2,6′-diamino biphenyl; 3,4′-diamino biphenyl; 3,5′-diamino biphenyl; 3,6′-diamino biphenyl; 4,4′-diamino biphenyl; 4,5′-diamino biphenyl; 4,6′-diamino biphenyl; 5,6′-diamino biphenyl; 2,2′-dichloro-3,3′-diamino biphenyl; 2,2′-dichloro-4,4′-diamino biphenyl; 5,5′-dichloro-3,3′-diamino biphenyl; 2,2′-dichloro-6,6′-diamino biphenyl; 2,2′-dichloro-3,4′-diamino biphenyl; 2,2′-dichloro-3,5′-diamino biphenyl; 2,2′-dichloro-3,6′-diamino biphenyl; 2,2′-dichloro-4,5′-diamino biphenyl; 2,2′-dichloro-4,6′-diamino biphenyl; 2,2′-dichloro-5,6′-diamino biphenyl; 3,3′-dichloro-2,2′-diamino biphenyl; 3,3′-dichloro-4,4′-diamino biphenyl; 3,3′-dichloro-5,5′-diamino biphenyl; 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl; 4,4′-dichloro-2,2′-diamino biphenyl; 4,4′-dichloro-3,3′-diamino biphenyl; 4,4′-dichloro-5,5′-diamino biphenyl; 4,4′-dichloro-6,6′-diamino biphenyl; 4,4′-dichloro-2,3′-diamino biphenyl; 4,4′-dichloro-2,5′-diamino biphenyl; 4,4′-dichloro-2,6′-diamino biphenyl; 4,4′-dichloro-3,5′-diamino biphenyl; 4,4′-dichloro-3,6′-diamino biphenyl; 4,4′-dichloro-5,6′-diamino biphenyl; 5,5′-dichloro-2,2′-diamino biphenyl; 5,5′-dichloro-3,3′-diamino biphenyl; 5,5′-dichloro-4,4′-diamino biphenyl; 5,5′-dichloro-6,6′-diamino biphenyl; 5,5′-dichloro-2,3′-diamino biphenyl; 5,5′-dichloro-2,4′-diamino biphenyl; 5,5′-dichloro-2,6′-diamino biphenyl; 5,5′-dichloro-3,4′-diamino biphenyl; 5,5′-dichloro-3,6′-diamino biphenyl; 5,5′-dichloro-4,6′-diamino biphenyl; 6,6′-dichloro-2,2′-diamino biphenyl; 6,6′-dichloro-3,3′-diamino biphenyl; 6,6′-dichloro-4,4′-diamino biphenyl; 6,6′-dichloro-5,5′-diamino biphenyl; 6,6′-dichloro-2,3′-diamino biphenyl; 6,6′-dichloro-2,4′-diamino biphenyl; 6,6′-dichloro-2,5′-diamino biphenyl; 6,6′-dichloro-3,4′-diamino biphenyl; 6,6′-dichloro-3,5′-diamino biphenyl; 6,6′-dichloro-4,5′-diamino biphenyl; or a mixture thereof; or
a combination thereof.

20. The prepolymer composition, polyurethane dispersion, or waterborne polyurethane, of claim 9, wherein at least one of:
the one or more additional polyol includes or is at least one of N-butanol; ethylene glycol; 1,2-propanediol; 1,3-butanediol; 1,4-butanediol; 2,3-butanediol; 1,5-pentanediol; 1,6-hexanediol; neopentyl glycol; 1,4-dihydroxycyclohexane; 1,4-dimethylolcyclohexane; 1,8-octanediol; 1,10-decanediol; 1,12-dodecanediol; 1,4-cyclohexanediol; 1,4-cyclohexanedimethanol; N-substituted ethanolamine; glycerol; trimethylolpropane; trimethylolethane; pentaerythritol; or a combination thereof;
the one or more isocyanate includes or is at least one of 4,4′-diphenylmethane diisocyanate, isophorone diisocyanate, 1,6-hexamethylene diisocyanate, toluene-2,4-diisocyanate, 1,5-naphthylene diisocyanate, 4,4′-dicyclohexylmethane diisocyanate, or a mixture thereof;
the one or more chain extender includes or is at least one of diethylene triamine (DETA), ethylene diamine (EDA), meta-xylylenediamine (MXDA), aminoethyl ethanolamine (AEEA), 2-methyl pentane diamine, propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, hydrazine, substituted hydrazine, hydrazine reaction products, or a combination thereof; or
a combination thereof.

21. The prepolymer composition, polyurethane dispersion, or waterborne polyurethane, of claim 9, wherein at least one of:
the one or more additional polyol includes or is at least one of trimethylolpropane (TMP), glycerin, or a mixture thereof;
the one or more isocyanate includes or is at least one of 4,4′-diisocyanate dicyclohexylmethane, isophorone diisocyanate, or a combination thereof;
the one or more catalyst includes or is an organobismuth in at least one of a carboxylic acid, dibutyltin dilaurate, dibutyltin dioctanoate, or a combination thereof;
the one or more cosolvent includes or is at least one of 1-butylpyrrolidin-2-one, dipropylene glycol dimethyl ether, or a combination thereof;
the one or more internal emulsifier includes or is at least one of dimethylol propionic acid (DMPA), dimethylethanolamine (DMEA), or a combination thereof;
the one or more counterion or neutralizer includes or is at least one of triethylamine (TEA), dimethylethanolamine (DMEA), or a combination thereof;
water sufficient for the mixture to have a total solids content of about 30% to about 50%;
the one or more defoamer includes or is at least one of 2-methyl-3-isothiazolone, decamethylcyclopentasiloxane, octamethylcyclotetrasiloxane, or a combination thereof;
the one or more chain extender includes or is at least one of water, hydrazine, hydrazine hydrate, adipic dihydrazide, aminoethyl ethanolamine (AEEA), ethylene diamine (EDA), or a combination thereof; or
a combination thereof.

22. The polyurethane dispersion or waterborne polyurethane of claim 8, wherein at least one of:
a viscosity of less than or equal to about 50 centipoise (cps);
a total solids content of less than or equal to 40%;
a softening point of about 140° C. to about 210° C.;
a tensile strength of about 4000 pounds per square inch (psi) to about 6500 psi;
an elongation percent of about 10% to about 40%; or
a combination thereof.

23. A method of method of making the caprolactone polyol of claim 1, the method comprising:
admixing caprolactone monomers and pentaspiroglycol (PSG) to form an initiator-caprolactone mixture or reaction mixture;
adding one or more catalyst to the initiator-caprolactone mixture to form a reaction mixture; and
polymerizing the caprolactone monomers in the reaction mixture, thereby forming the caprolactone polyol.

24. A method of making the prepolymer composition, polyurethane dispersion, or waterborne polyurethane, of claim 8, the method comprising reacting one or more caprolactone polyol, optionally one or more additional polyol, one or more isocyanate comprising two or more isocyanate groups, and one or more catalyst, thereby forming a polyurethane material.

25. A film or coating comprising, or produced from, the polyurethane dispersion or waterborne polyurethane, of claim 8.

26. An article comprising the film or coating of claim 25.
